(19) United States
(12) Patent Application Publication
(10) Pub. No.: US 2019/0176081 A1
(43) Pub. Date: Jun. 13, 2019

(54) GAS SEPARATION MEMBRANE, GAS SEPARATION MODULE, GAS SEPARATION DEVICE, GAS SEPARATION METHOD, AND POLYIMIDE COMPOUND

(71) Applicant: FUJIFILM Corporation, Tokyo (JP)

(72) Inventors: Masato SENOO, Kanagawa (JP); Tetsu KITAMURA, Kanagawa (JP); Masatoshi YUMOTO, Kanagawa (JP); Motoi HARADA, Kanagawa (JP)

(73) Assignee: FUJIFILM Corporation, Tokyo (JP)

(21) Appl. No.: 16/281,127

(22) Filed: Feb. 21, 2019

Related U.S. Application Data
(63) Continuation of application No. PCT/JP2017/029540, filed on Aug. 17, 2017.

(30) Foreign Application Priority Data
Aug. 31, 2016 (JP) 2016-168768

(51) Int. Cl. B01D 53/22; B01D 71/56

(52) U.S. Cl. CPC B01D 53/22; B01D 67/00; B01D 71/56

(57) ABSTRACT

A gas separation membrane includes a gas separation layer containing a polyimide compound, and the polyimide compound has a repeating unit represented by Formula (I). The gas separation module, the gas separation device, and the gas separation method are obtained by using the gas separation membrane,

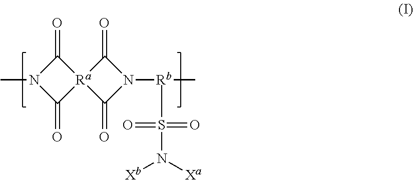

R^{a} represents a specific tetravalent group, R^{b} represents a trivalent group having a specific ring, X^{a} represents a specific substituent, and X^{b} represents a hydrogen atom or a substituent. A polyimide compound represented by Formula (I-b) or (I-c),

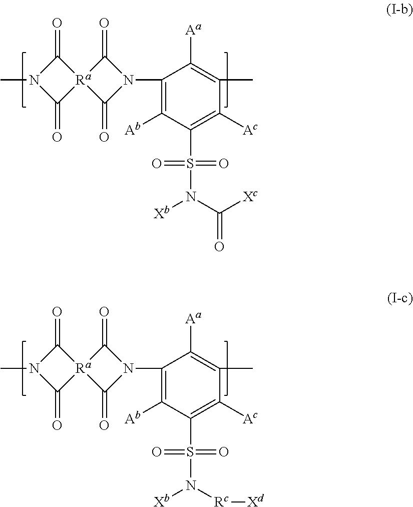

R^{a} represents a specific tetravalent group, R^{c} represents a specific divalent group, A^{a}, A^{b}, A^{c}, and X^{b} represent a hydrogen atom or a substituent, and X^{c} and X^{d} represent a specific substituent.

### CROSS-REFERENCE TO RELATED APPLICATIONS

This application is a Continuation of PCT International Application No. PCT/JP2017/029540 filed on Aug. 17, 2017, which claims priority under 35 U.S.C § 119(a) to Japanese Patent Application No. 2016-168768 filed on Aug. 31, 2016. Each of the above application(s) is hereby expressly incorporated by reference, in its entirety, into the present application.

### BACKGROUND OF THE INVENTION

### 1. Field of the Invention

The present invention relates to relates to a gas separation membrane, a gas separation module, a gas separation device, a gas separation method, and a polyimide compound.

### 2. Description of the Related Art

A material formed of a polymer compound has a gas permeability specific to the material. Based on this property, a gas separation membrane is capable of causing a desired gas component to selectively permeate and separating the gas component using a membrane formed of a specific polymer compound. As an industrial application for the gas separation membrane related to the problem of global warming, separation and recovery of carbon dioxide from large-scale carbon dioxide sources has been examined in thermal power plants, cement plants, or ironworks blast furnaces. In addition, natural gas or biogas (gas generated due to fermentation or anaerobic digestion, for example, biological excrement, organic fertilizers, biodegradable substances, sewage, garbage, or energy crops) is mixed gas mainly containing methane and carbon dioxide, and use of the gas separation membrane has been examined as means for removing carbon dioxide and the like, which are impurities, from this mixed gas (JP2007-297605A).

In purification of natural gas using a membrane separation method, excellent gas permeability and gas separation selectivity are required in order to more efficiently separate gas. However, the gas permeability and the gas separation selectivity are usually in a so-called trade-off relationship. Therefore, any of the gas permeability and the gas separation selectivity of a gas separation layer can be improved by adjusting the molecular structure of a polymer compound used for the gas separation layer, but it is considered to be difficult to achieve these characteristics at high levels. Various membrane materials have been examined to deal with this problem and a gas separation membrane obtained by using a polyimide compound has been examined as part of examination of membrane materials. For example, CN1760236A describes that gas permeability and gas separation selectivity are improved by using a polyimide compound formed of a diamine having a specific structure.

In an actual plant, a membrane is plasticized due to high-pressure conditions or impurities (for example, benzene, toluene, and xylene) present in natural gas and this leads to degradation of gas separation selectivity, which is problematic. Therefore, it is required for a gas separation membrane to have not only improved gas permeability and gas separation selectivity but also plasticization resistance so that excellent gas permeability and gas separation selectivity can be continuously exhibited even under high-pressure conditions or in the presence of the impurities described above. JP2015-083296A describes that, by employing a 1,3-phenylenediamine component having substituents at the 2-position and at least one of the 4-, 5-, or 6-position as a diamine component of a polyimide compound and using a specific polar group as at least one substituent from among the substituent at the 2-position and the substituent at the 4- to 6-positions of the diamine component, a gas separation membrane obtained by using the polyimide compound for a gas separation layer has excellent gas permeability and gas separation selectivity even under high-pressure conditions and exhibits high resistance to impurities such as toluene.

In order to obtain a practical gas separation membrane, it is necessary to ensure sufficient gas permeability by making a gas separation layer thinner, and then to realize improved gas separation selectivity. As a method for thinning a gas separation layer, a method of making a portion contributing to separation into a thin layer referred to as a compact layer or a skin layer by forming a polymer compound such as a polyimide compound into an asymmetric membrane using a phase separation method may be exemplified. In this asymmetric membrane, a portion other than a compact layer is allowed to function as a support layer responsible for the mechanical strength of a membrane.

Further, in addition to the asymmetric membrane, the form of a composite membrane obtained by forming a gas separation layer responsible for a gas separation function and a support layer responsible for mechanical strength with different materials and forming the gas separation layer having gas separation capability into a thin layer on the gas permeating support layer is known.

### SUMMARY OF THE INVENTION

The present invention relates to a gas separation membrane that enables gas separation with high selectivity at a high speed by achieving both of gas permeability and gas separation selectivity at high levels even at the time of use under high-pressure conditions. Further, the present invention relates to a gas separation membrane that is capable of satisfactorily maintaining gas separation performance even at the time of being brought into contact with toluene which is an impurity component. Further, the present invention relates to a gas separation module, a gas separation device, and a gas separation method obtained by using the gas separation membrane. Further, the present invention relates to a polyimide compound suitable as a constituent material of a gas separation layer of the gas separation membrane.

As the result of intensive examination conducted by the presents inventors in view of the above-described problems, it was found that, in the gas separation membrane having a gas separation layer obtained by using a polyimide compound, gas separation with high selectivity at a high speed can be realized, the gas separation layer is unlikely to be plasticized even in a case where the gas separation membrane is exposed to toluene or the like which is an impurity component, and excellent gas separation performance can be continuously exhibited by allowing a diamine component of the polyimide compound to have a ring containing a substituted sulfamoyl group having a specific structure. The present invention has been completed after further examination conducted based on these findings.

The above-described objects are achieved by the following means.

[1] A gas separation membrane comprising: a gas separation layer which contains a polyimide compound as a constituent material, in which the polyimide compound has a repeating unit represented by Formula (I),

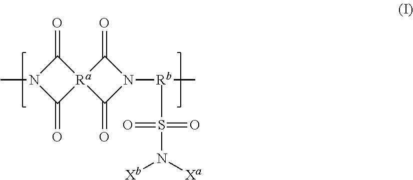

in Formula (I), X^{a} represents a group having an oxygen atom, a nitrogen atom, and/or a sulfur atom or an aryl group including a substituent having a fluorine atom, X^{b} represents a hydrogen atom or a substituent, and in a case where a structure represented by —N(X^{b})— in Formula (I) does not have a structural portion selected from the group consisting of OH, NH, and SH, X^{a} has at least one structural portion selected from the group consisting of OH, NH, and SH, and

R^{a} represents a group represented by any of Formulae (I-1) to (I-28), where X¹ to X³ represent a single bond or a divalent group, L's each independently represent —CH═CH— or —CH₂—, R¹ and R² represent a hydrogen atom or a substituent, and the symbol “*” represents a binding site with respect to a carbonyl group represented in Formula (I),

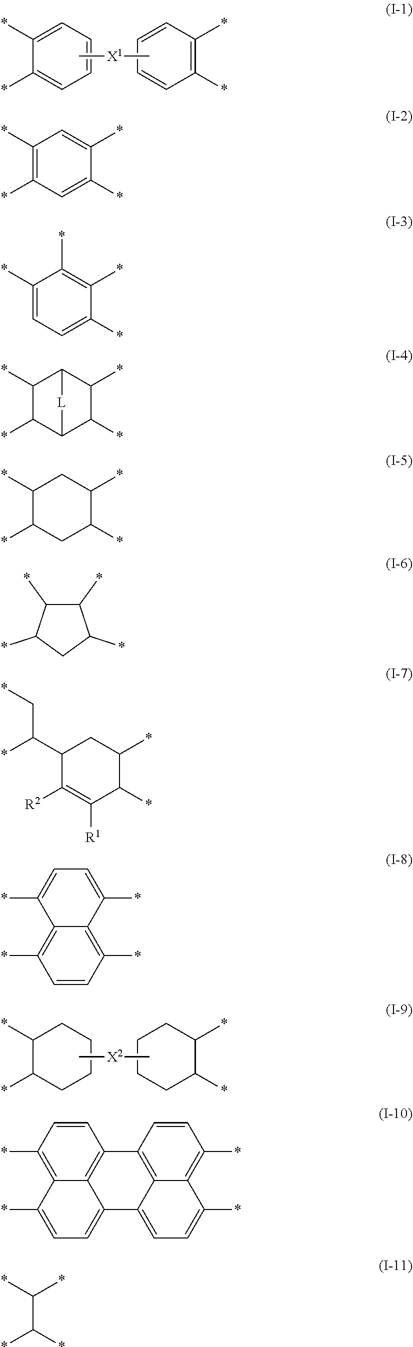

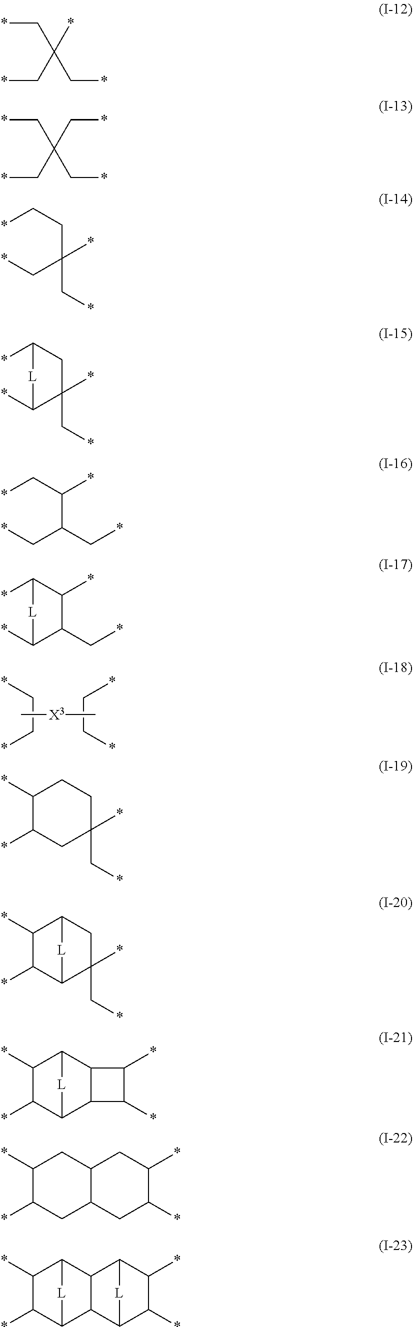

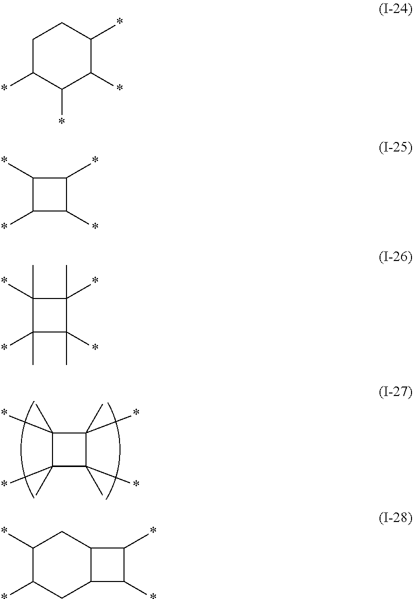

R^{b} represents a group represented by any of Formulae (I-29) to (I-42), where X⁴ to X⁸ represent a single bond or a divalent group, L represents —CH═CH— or —CH₂—, R^{Z}'s each independently represent a substituent, the symbol “*” represents a binding site with respect to an imide group represented in Formula (I), the symbol “#” represents a binding site with respect to a sulfamoyl group represented in Formula (I), d's each independently represent an integer of 0 to 3, e's each independently represent an integer of 0 to 4, f's each independently represent an integer of 0 to 5, g represents an integer of 0 to 6, h's each independently represent an integer of 0 to 7, j's each independently represent an integer of 0 to 9, k represents an integer of 0 to 10, and q's each independently represent 0 or 1.

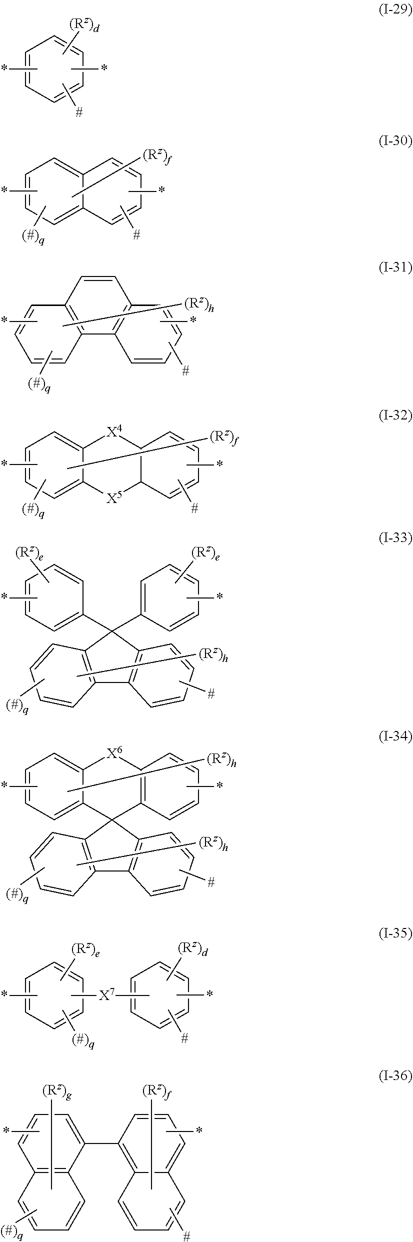

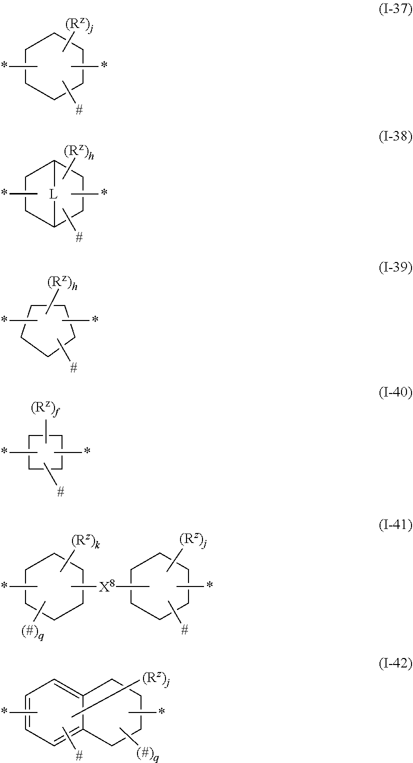

[2] The gas separation membrane according to [1], in which R^{b} represents a group represented by Formula (I-29) or (I-34).

[3] The gas separation membrane according to [1] or [2], in which the repeating unit represented by Formula (I) is a repeating unit represented by Formula (I-a),

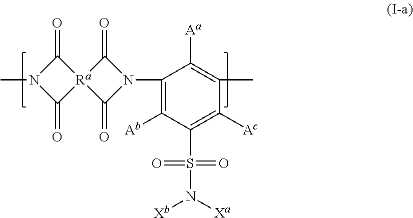

in Formula (I-a), R^{a}, X^{a}, and X^{b} each have the same definition as that for R^{a}, X^{a}, and X^{b} in Formula (I), and A^{a}, A^{b}, and A^{c} represent a hydrogen atom or a substituent.

[4] The gas separation membrane according to [3], in which the repeating unit represented by Formula (I-a) is a repeating unit represented by Formula (I-b),

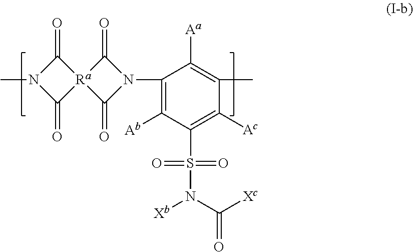

in Formula (I-b), R^{a}, X^{b}, A^{a}, A^{b}, and A^{c} each have the same definition as that for R^{a}, X^{b}, A^{a}, A^{b}, and A^{c} in Formula (I-a), X^{c} represents a substituent, and in a case where a structure represented by —N(X^{b})— in Formula (I-b) does not have a structural portion selected from the group consisting of OH, NH, and SH, X^{c} has at least one structural portion selected from the group consisting of OH, NH, and SH.

[5] The gas separation membrane according to [4], in which X^{c} represents a substituent having at least one fluorine atom.

[6] The gas separation membrane according to [3], in which the repeating unit represented by Formula (I-a) is a repeating unit represented by Formula (I-c),

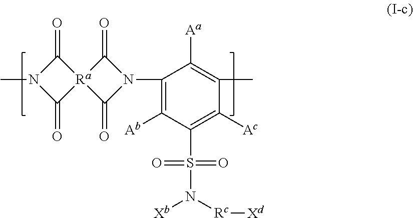

in Formula (I-c), R^{a}, X^{b}, A^{a}, A^{b}, and A^{c} each have the same definition as that for R^{a}, X^{b}, A^{a}, A^{b}, and A^{c} in Formula (I-a), R^{c} represents an alkylene group, a cycloalkylene group, or an arylene group, and X^{d} represents a group having 0 to 2 carbon atoms and having a structural portion selected from the group consisting of OH, NH, and SH.

[7] The gas separation membrane according to [6], in which the repeating unit represented by Formula (I-c) is a repeating unit represented by Formula (I-d),

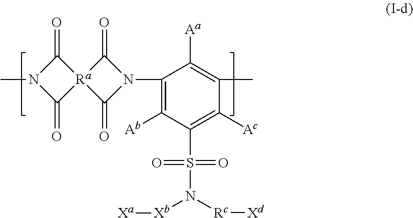

in Formula (I-d), R^{a}, R^{c}, X^{d}, A^{a}, A^{b}, and A^{c} each have the same definition as that for R^{a}, R^{c}, X^{d}, A^{a}, A^{b}, and A^{c} in Formula (I-c), R^{d} represents an alkylene group, a cycloalkylene group, or an arylene group, and X^{e} represents a group having 0 to 2 carbon atoms and having a structural portion selected from the group consisting of OH, NH, and SH.

[8] The gas separation membrane according to any one of [3] to [7], in which at least one of A^{a}, A^{b}, or A^{c} represents an alkyl group.

[9] The gas separation membrane according to any one of [1] to [8], in which the content of the repeating unit represented by Formula (I) in the polyimide compound is in a range of 30% to 100% by mole.

[10] The gas separation membrane according to any one of [1] to [9], further comprising: a gas permeating support layer, in which the gas separation membrane is a gas separation composite membrane in which the gas separation layer is provided on the gas permeating support layer.

[11] The gas separation membrane according to [10], in which the support layer is formed of a porous layer and a non-woven fabric layer, and the non-woven fabric layer, the porous layer, and the gas separation layer are provided in this order.

[12] The gas separation membrane according to any one of [1] to [11], in which, in a case where gas to be subjected to a separation treatment is mixed gas of carbon dioxide and methane, a permeation rate of carbon dioxide at 40° C. and 5 MPa is 20 GPU or greater and a ratio R_{CO2}/R_{CH4} of a permeation rate of carbon dioxide with respect to a permeation rate of methane is 15 or greater.

[13] The gas separation membrane according to any one of [1] to [12], which is used for selective permeation of carbon dioxide from gas containing the carbon dioxide and methane.

[14] A gas separation module comprising: the gas separation membrane according to any one of [1] to [13].

[15] A gas separation device comprising: the gas separation module according to [14].

[16] A gas separation method comprising: causing carbon dioxide to selectively permeate from gas containing the carbon dioxide and methane using the gas separation membrane according to any one of [1] to [13].

[17] A polyimide compound having a repeating unit represented by Formula (I-b),

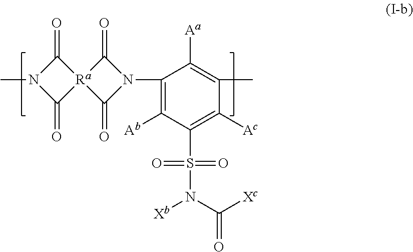

in Formula (I-b), R^{a} represents a group represented by any of Formulae (I-1) to (I-28), where X¹ to X³ represent a single bond or a divalent group, L's each independently represent —CH═CH— or —CH₂—, R¹ and R² represent a hydrogen atom or a substituent, and the symbol “*” represents a binding site with respect to a carbonyl group represented in Formula (I-b),

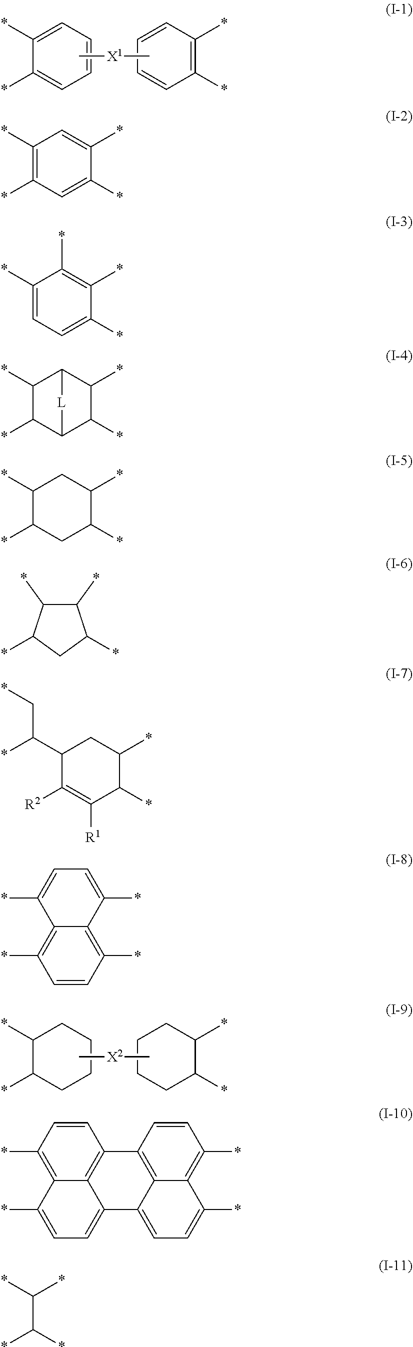

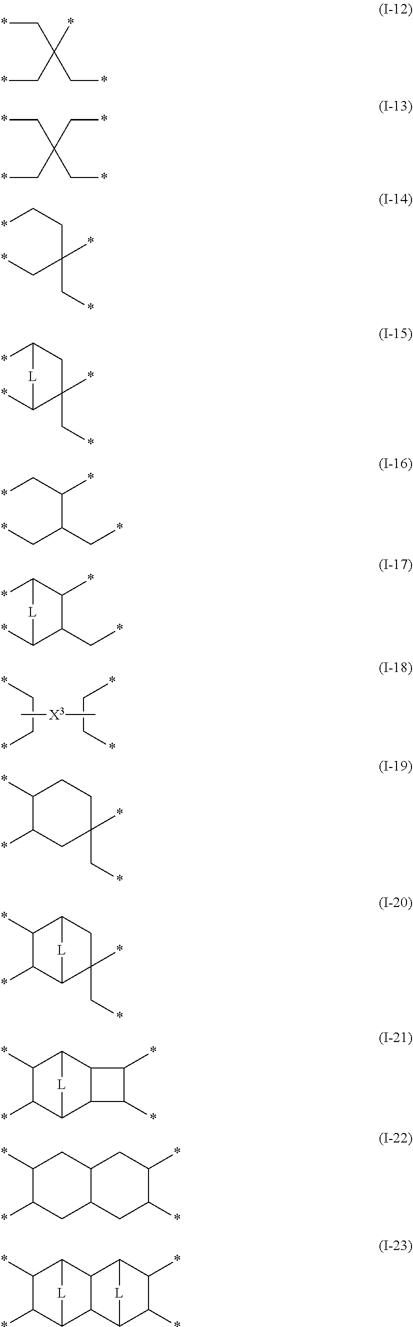

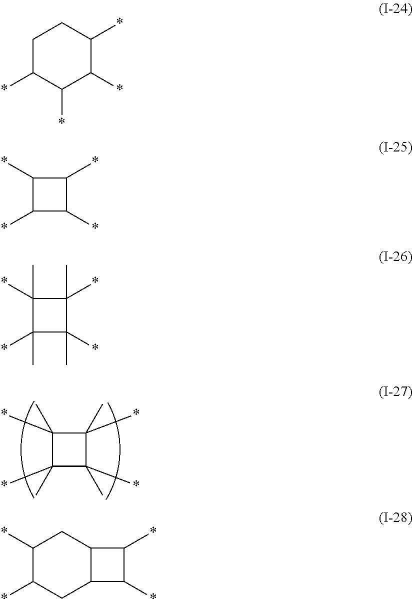

A^{a}, A^{b}, and A^{c} represent a hydrogen atom or a substituent, X^{b} represents a hydrogen atom or a substituent, X^{c} represents a substituent, and in a case where a structure represented by —N(X^{b})— in Formula (I-b) does not have a structural portion selected from the group consisting of OH, NH, and SH, X^{c} has at least one structural portion selected from the group consisting of OH, NH, and SH.

[18] A polyimide compound having a repeating unit represented by Formula (I-c),

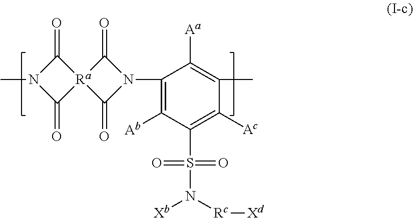

in Formula (I-c), R^{a} represents a group represented by any of Formulae (I-1) to (I-28), where X¹ to X³ represent a single bond or a divalent group, L's each independently represent —CH═CH— or —CH₂—, R¹ and R² represent a hydrogen atom or a substituent, and the symbol “*” represents a binding site with respect to a carbonyl group represented in Formula (I-c),

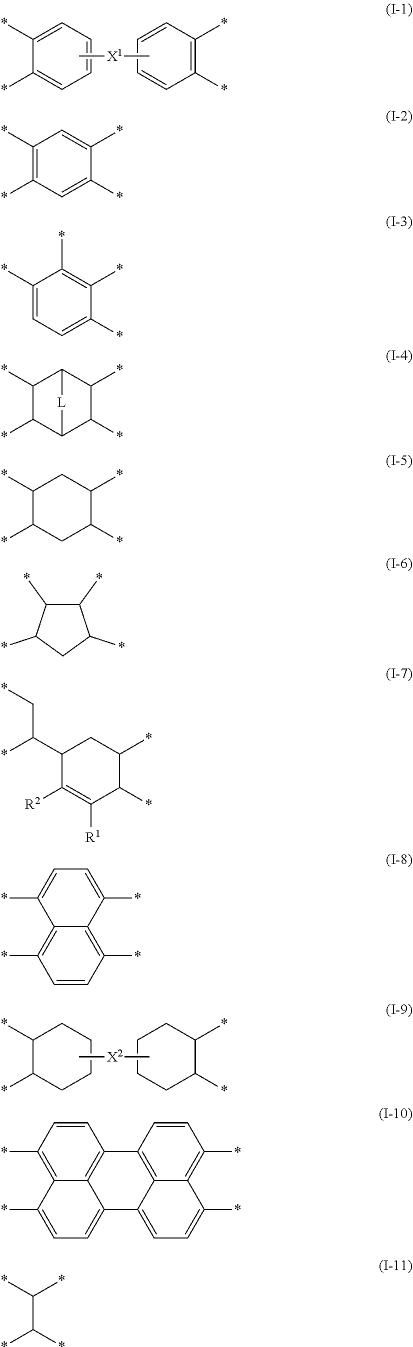

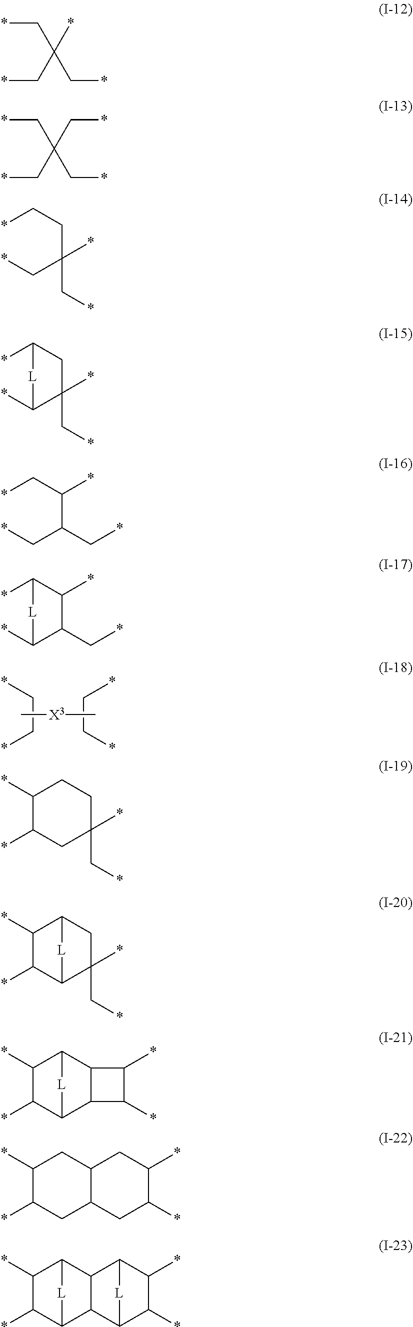

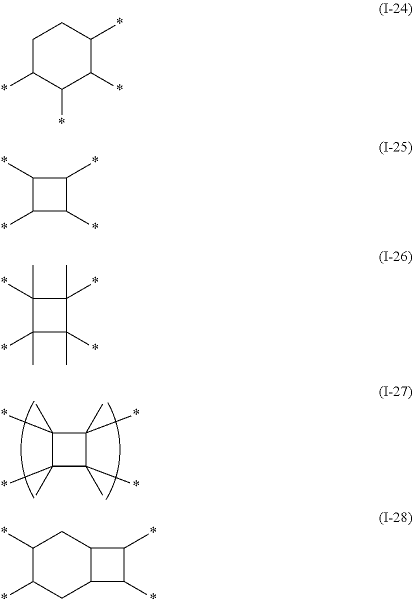

A^{a}, A^{b}, and A^{c} represent a hydrogen atom or a substituent, X^{b} represents a hydrogen atom or a substituent, R^{c} represents an alkylene group, a cycloalkylene group, or an arylene group, and X^{d} represents a group having 0 to 2 carbon atoms and having a structural portion selected from the group consisting of OH, NH, and SH.

In the present specification, in a case where a plurality of substituents or linking groups (hereinafter, referred to as substituents or the like) shown by specific symbols are present or a plurality of substituents are defined simultaneously or alternatively, this means that the respective substituents may be the same as or different from each other. The same applies to the definition of the number of substituents or the like. Moreover, in a case where there is a repetition of a plurality of partial structures shown by means of the same display in the formula, the respective partial structures or repeating units may be the same as or different from each other. In addition, even in a case where it is not specifically stated and a plurality of substituents or the like are adjacent to each other, this means that they may be condensed or linked to each other and form a ring.

In regard to compounds or groups described in the present specification, the description includes salts thereof and ions thereof in addition to the compounds or the groups. Further, the description includes derivatives obtained by changing a part of the structure thereof within the range in which the effects of the purpose are exhibited.

A substituent (the same applies to a linking group) in which substitution or unsubstitution is not specified in the present specification may include an arbitrary substituent of the group within a range in which desired effects are exhibited. The same applies to a compound in which substitution or unsubstitution is not specified.

A preferable range of a group Z of substituents described below is set as a preferable range of a substituent in the present specification unless otherwise specified. Further, in a case where only substituents having a specific range are described (for example, in a case where only an “alkyl group” is mentioned), a preferable range and specific examples of a group (an alkyl group in the above-described case) corresponding to the group Z of substituents described below are applied.

In the present specification, in a case where the number of carbon atoms of a certain group is specified, this number of carbon atoms indicates the number of carbon atoms of the entire group. In other words, in a case where this group further includes substituents, the number of carbon atoms thereof indicates the number of carbon atoms of all groups including the substituents.

The gas separation membrane, the gas separation module, the gas separation device, and the gas separation method according to the embodiment of the present invention enable gas separation with high selectivity at a high speed by achieving both of gas permeability and gas separation selectivity at high levels even at the time of use under high-pressure conditions. Further, the gas separation membrane, the gas separation module, the gas separation device, and the gas separation method according to the embodiment of the present invention enable the gas separation performance to be satisfactorily maintained even in a case where the gas separation membrane is exposed to toluene or the like which is an impurity component. Further, the polyimide compound according to the embodiment of the present invention can be suitably used as a constituent material of a gas separation layer of the gas separation membrane.

### BRIEF DESCRIPTION OF THE DRAWINGS

FIG. 1 is a cross-sectional view schematically illustrating an embodiment of a gas separation composite membrane according to the present invention.

FIG. 2 is a cross-sectional view schematically illustrating another embodiment of the gas separation composite membrane according to the present invention.

### DESCRIPTION OF THE PREFERRED EMBODIMENTS

Hereinafter, the present invention will be described in detail.

A gas separation membrane according to the embodiment of the present invention contains a polyimide compound having a structure specific to a gas separation layer as the constituent material.

[Polyimide Compound]

The polyimide compound used in the present invention has at least a repeating unit represented by Formula (I).

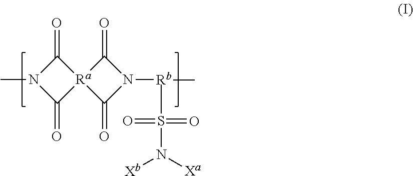

In Formula (I), R^{a} represents a group represented by any of Formulae (I-1) to (I-28). In Formulae (I-1) to (I-28), the symbol “*” represents a binding site with respect to a carbonyl group represented by Formula (I). R^{a} represents preferably a group represented by Formula (I-1), (I-2), or (I-4), more preferably a group represented by Formula (I-1) or (I-4), and particularly preferably a group represented by Formula (I-1).

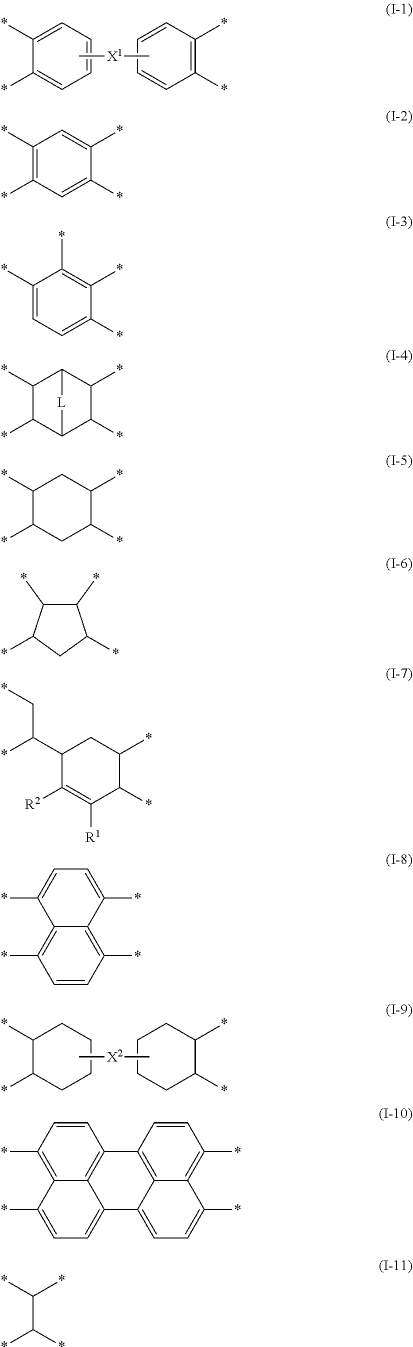

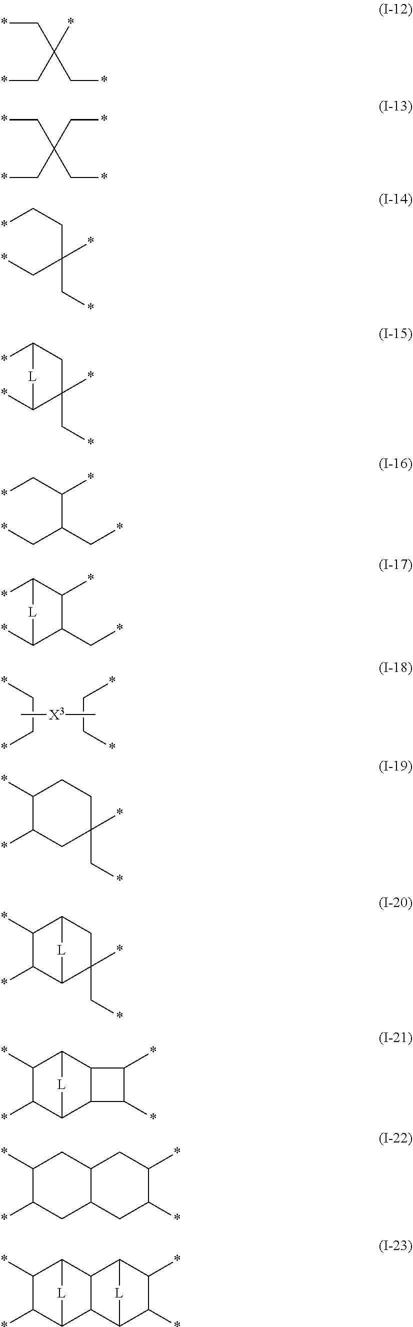

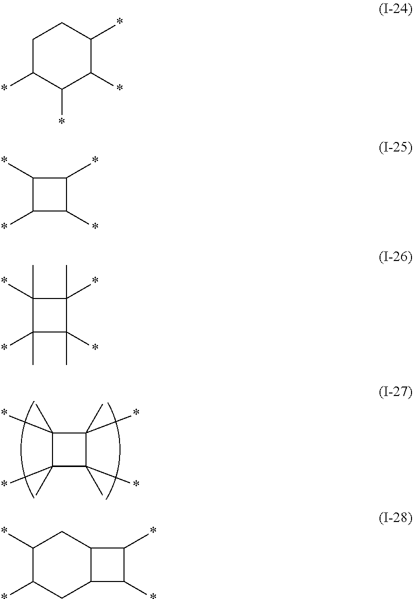

In Formulae (I-1), (I-9), and (I-18), X¹ to X³ represent a single bond or a divalent group. As the divalent group, —C(R^{x})₂— (R^{x} represents a hydrogen atom or a substituent, and in a case where R^{x} represents a substituent, R^{x}'s may be linked to each other to form a ring), —O—, —SO₂—, —C(═O)—, —S—, —NR^{Y}—, —Si(R^{Y})₂— (R^{Y} represents a hydrogen atom, an alkyl group (preferably methyl or ethyl), an aryl group (preferably a phenyl group)), —C₆H₄— (phenylene), a heterocyclic group, or a combination of these is preferable. It is more preferable that X¹ to X³ represent a single bond or —C(R^{X})₂—. In a case where R^{x} represents a substituent, specific examples thereof include groups selected from a group Z of substituents described below. Among these, an alkyl group (the preferable range is the same as that of the alkyl group in the group Z of substituents described below) is preferable, an alkyl group having a halogen atom as a substituent is more preferable, and trifluoromethyl is particularly preferable. Moreover, in Formula (I-18), X³ is linked to any one of two carbon atoms shown on the left side thereof and any one of two carbon atoms shown on the right side thereof.

X¹ to X³ have a molecular weight of preferably 500 or less, more preferably 350 or less, and still more preferably in a range of 10 to 200.

In Formulae (I-4), (I-15), (I-17), (I-20), (I-21), and (I-23), L's each independently represent —CH═CH— or —CH₂—.

In Formula (I-7), R¹ and R² represent a hydrogen atom or a substituent. Examples of the substituent include groups selected from the group Z of substituents described below. R¹ and R² may be bonded to each other to form a ring.

R¹ and R² represent preferably a hydrogen atom or an alkyl group, more preferably a hydrogen atom, a methyl group, or an ethyl group, and still more preferably a hydrogen atom.

The carbon atom represented in any of Formulae (I-1) to (I-28) may further have a substituent. In other words, in the present invention, the form in which the carbon atom represented in any of Formulae (I-1) to (I-28) further has a substituent is included in the repeating unit represented by Formula (I). Specific examples of the substituent include groups selected from the group Z of substituents described below. Among these, an alkyl group or an aryl group is preferable.

R^{b} represents a group represented by any of Formulae (I-29) to (I-42). In Formulae (I-29) to (I-42), the symbol “*” represents a binding site with respect to an imide group represented in Formula (I), and the symbol “#” represents a binding site with respect to a sulfamoyl group (—S(═O)₂N(X^{b})X^{a}) represented in Formula (I). R^{b} represents preferably a group represented by Formula (I-29), (I-33), (I-34) or (I-35) and more preferably a group represented by Formula (I-29) or (I-34).

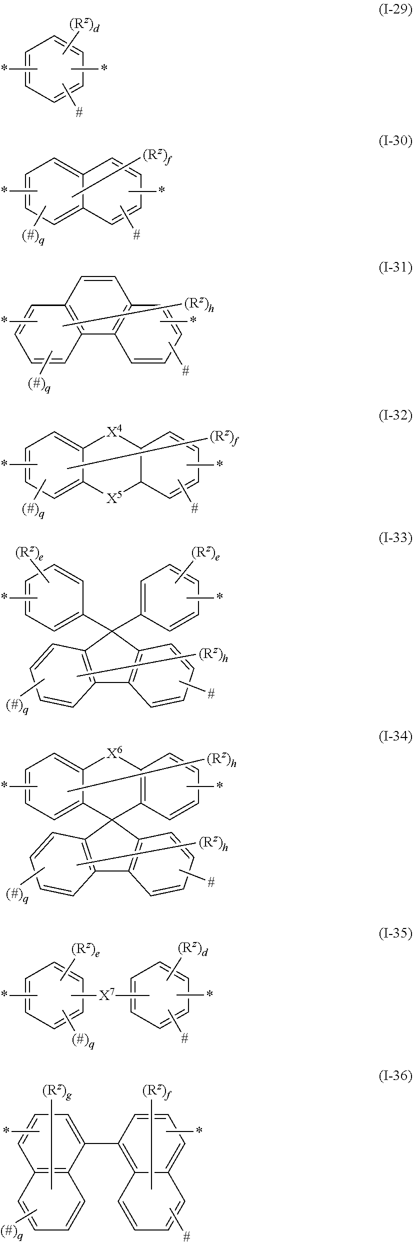

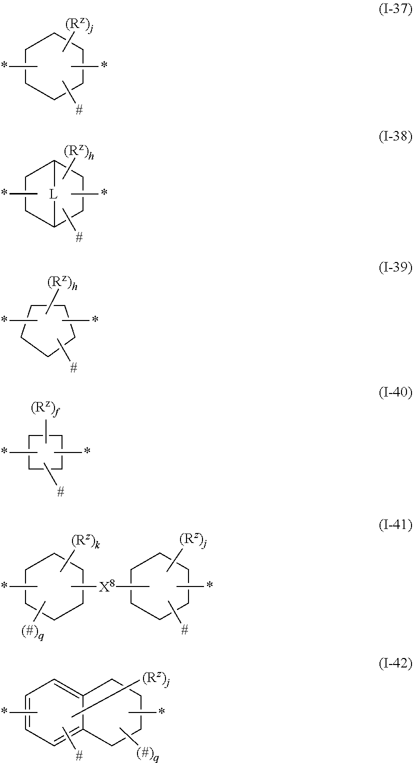

X⁴ to X⁸ represent a single bond or a divalent group. As the divalent group which can be employed as X⁴, X⁵, and X⁶, —O—, —S—, —NR^{N}— (R^{N} represents a hydrogen atom, an alkyl group, or an aryl group), —S(═O)₂—, —C(═O)—, or —C(R^{X})₂— (R^{X} represents a hydrogen atom or a substituent, and in a case where R^{X} represents a substituent, R^{X}'s may be linked to each other to form a ring) is preferable, and —O—, —C(═O)—, or —C(R^{X})₂— is more preferable.

The preferable forms of the divalent group which can be employed as X⁷ and X⁸ are the same as the preferable forms of the divalent group which can be employed as X¹ described above.

L in Formula (I-38) has the same definition as that for L in Formula (I-4).

R^{Z}'s each independently represent a substituent. R^{Z} represents preferably a group selected from an alkyl group (the number of carbon atoms of the alkyl group is preferably in a range of 1 to 10, more preferably in a range of 1 to 6, and still more preferably in a range of 1 to 3, specific preferred examples thereof include methyl, ethyl, and isopropyl, and it is also preferable that this alkyl group has a fluorine atom as a substituent), an aryl group (the number of carbon atoms of the aryl group is preferably in a range of 6 to 20, more preferably in a range of 6 to 15, and still more preferably in a range of 6 to 10, and specific preferred examples thereof include phenyl and naphthyl), an alkoxy group (the number of carbon atoms of the alkoxy group is preferably in a range of 1 to 10, more preferably in a range of 1 to 6, and still more preferably in a range of 1 to 3, and specific preferred examples thereof include methoxy and ethoxy), a heterocyclic group (it is preferable that the heterocyclic group has an oxygen atom, a nitrogen atom, and/or a sulfur atom as a heteroatom constituting the ring, and a 3- to 8-membered ring is preferable, and a 5- or 6-membered ring is more preferable), a halogen atom (specific examples thereof include a fluorine atom, a chlorine atom, a bromine atom, and an iodine atom), a hydroxy group, and a carboxy group, and more preferably a group selected from an alkyl group, an aryl group, and a halogen atom.

d represents an integer of 0 to 3 and preferably an integer of 0 to 2. e represents an integer of 0 to 4, preferably an integer of 0 to 3, and more preferably an integer of 0 to 2. f represents an integer of 0 to 5, preferably an integer of 0 to 4, more preferably an integer of 0 to 3, and still more preferably an integer of 0 to 2. g represents an integer of 0 to 6, preferably an integer of 0 to 5, more preferably an integer of 0 to 4, and still more preferably an integer of 0 to 3. h represents an integer of 0 to 7, preferably an integer of 0 to 6, still more preferably an integer of 0 to 5, and particularly preferably an integer of 0 to 4. j represents an integer of 0 to 9, preferably an integer of 0 to 8, more preferably an integer of 0 to 7, still more preferably an integer of 0 to 6, and particularly preferably an integer of 0 to 4. k represents an integer of 0 to 10, preferably an integer of 0 to 8, more preferably an integer of 0 to 6, and still more preferably an integer of 0 to 4. q represents 0 or 1. Further, in the present invention, a case where q represents 1 means that two sulfamoyl groups represented in Formula (1) are present in the repeating unit in Formula (1), and such a form in the present invention is set to be included in the repeating unit represented by Formula (1).

X^{a} represents a group having an oxygen atom, a nitrogen atom, and/or a sulfur atom or an aryl group having a fluorine atom in a substituent. Here, in the present invention, the “aryl group having a fluorine atom in a substituent” which can be employed as X^{a} does not have any of an oxygen atom, a nitrogen atom, and a sulfur atom. X^{b} represents a hydrogen atom or a substituent. Here, in a case where a structure represented by —N(X^{b})— in Formula (I) does not have a structural portion selected from OH, NH, and SH, X^{a} has at least one structural portion selected from OH, NH, and SH.

By using a polyimide compound having a repeating unit represented by Formula (I) in the gas separation layer of the gas separation membrane, mutually contradictory characteristics which are the gas permeability and the gas separation selectivity can be achieved at high levels and the plasticization resistance can also be improved. The reason for this is not clear, but the following is considered as a factor.

The polyimide compound represented by Formula (I) contains a sulfamoyl group which is a group having a high polarity in a diamine component, and this sulfamoyl group has a structural portion selected from OH, NH, and SH in the structure thereof. It is considered that, due to such a structure, an electronic interaction between polymer chains, a hydrogen bonding interaction, and the like act in a complex manner so that polymers are appropriately densified, and the permeability with respect to molecules having a large dynamic molecular diameter while having a moderate free volume fraction can be effectively suppressed. Further, it is considered that the interaction with toluene or the like which is an impurity component is effectively suppressed because of the densification and the presence of the polar group and thus the plasticization resistance is also improved. Further, it is assumed that, in a case where X^{a} represents an aryl group having fluorine atoms in a substituent, the gas permeability is increased due to gaps generated by the repulsion between fluorine atoms, and high gas separation selectivity can be satisfactorily maintained due to π-π stacking or the like of aryl groups.

X^{a} has a molecular weight of preferably 10 to 400 and more preferably 30 to 250.

The group having an oxygen atom, a nitrogen atom, and/or a sulfur atom which can be employed as X^{a} is not particularly limited as long as the group has an oxygen atom, a nitrogen atom, and/or a sulfur atom. The oxygen atom, the nitrogen atom, and/or the sulfur atom function as an acceptor of a hydrogen atom in the hydrogen bonding interaction. It is preferable that the group having an oxygen atom, a nitrogen atom, and/or a sulfur atom which can be employed as X^{a} contains a group selected from an acyl group, a carbamoyl group, a thiocarbamoyl group, a sulfamoyl group, a carboxy group, a sulfo group, a phosphoric acid group (—P(═O)(OH)₂), a boric acid group (—B(OH)₂), and a hydroxy group.

As the group having an oxygen atom, a nitrogen atom, and/or a sulfur atom which can be employed as X^{a}, an alkyl group (the number of carbon atoms of the alkyl group is preferably in a range of 1 to 12, more preferably in a range of 1 to 8, and still more preferably in a range of 1 to 4), a cycloalkyl group (the number of carbon atoms of the cycloalkyl group is preferably in a range of 3 to 10 and more preferably in a range of 3 to 8), an aryl group (the number of carbon atoms of the aryl group is preferably in a range of 6 to 20, more preferably in a range of 6 to 15, and still more preferably in a range of 6 to 12), an acyl group (the number of carbon atoms of the acyl group is preferably in a range of 2 to 20, more preferably in a range of 2 to 15, and still more preferably in a range of 2 to 10), an arylaminocarbonyl group (the number of carbon atoms of the arylaminocarbonyl group is preferably in a range of 7 to 20, more preferably in a range of 7 to 16, and still more preferably in a range of 7 to 13), or an arylaminothiocarbonyl group (the number of carbon atoms of the arylaminothiocarbonyl group is preferably in a range of 7 to 20, more preferably in a range of 7 to 15, and still more preferably in a range of 7 to 12) is preferable, an alkyl group, a cycloalkyl group, an aryl group, or an acyl group is more preferable, and an alkyl group, an aryl group, or an acyl group is particularly preferable.

As these groups, the form in which these groups contain a group selected from a fluorine atom, an amino group, an acylamino group, a hydroxy group, a carboxy group, a carbamoyl group, a boric acid group, and a sulfamoyl group as a substituent is preferable, the form in which these groups contain a group selected from a fluorine atom, an acylamino group, a hydroxy group, a carboxy group, a carbamoyl group, a boric acid group, and a sulfamoyl group as a substituent is more preferable, the form in which these groups contain a group selected from a fluorine atom, an acylamino group, a hydroxy group, a carboxy group, a carbamoyl group, and a sulfamoyl group as a substituent is particularly preferable. The preferable forms of the amino group, the acylamino group, the carbamoyl group, and the sulfamoyl group are the same as the preferable forms of the groups corresponding to the group Z of substituents described below.

The number of carbon atoms of the aryl group including a substituent having a fluorine atom which can be employed as X^{a} is preferably in a range of 6 to 18, more preferably in a range of 6 to 14, and still more preferably in a range of 6 to 10.

As the aryl group including a substituent having a fluorine atom which can be employed as X^{a}, an aryl group having a fluorine atom as a substituent or an aryl group containing a fluorinated alkyl group as a substituent is preferable, a perfluoroaryl group or an aryl group containing a perfluoroalkyl group as a substituent is more preferable, and an aryl group containing a perfluoroalkyl group as a substituent is particularly preferable.

In a case where X^{b} represents a substituent, the molecular weight of this substituent is preferably in a range of 10 to 400 and more preferably in a range of 30 to 250. The substituent which can be employed as X^{b} is not particularly limited, and examples thereof include an alkyl group, an alkenyl group, an alkynyl group, an acyl group, a cycloalkyl group, and an aryl group. Further, in the case where X^{b} represents a substituent, it is also preferable that the substituent contains a group selected from a fluorine atom, an amino group (preferably a monoalkylamino group), an acylamino group, a hydroxy group, a carboxy group, a carbamoyl group, a mercapto group, a boric acid group, a phosphoric acid group, a sulfo group, a sulfino group, a sulfamoyl group, an ureido group, a hydroxamic acid group, and a hydrazino group. The preferable forms of the alkyl group, the alkenyl group, the alkynyl group, the acyl group, the cycloalkyl group, the aryl group, the amino group, the acylamino group, the carbamoyl group, the sulfamoyl group, and the ureido group are the same as the preferable forms of the groups corresponding to the group Z of substituents described below.

X^{b} represents more preferably a hydrogen atom, an alkyl group, an aryl group, or an acyl group, more preferably a hydrogen atom, an alkyl group, or an aryl group, and particularly preferably a hydrogen atom.

It is preferable that the repeating unit represented by Formula (I) is a repeating unit represented by Formula (I-a).

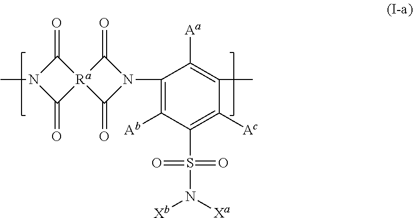

In Formula (I-a), R^{a}, X^{a}, and X^{b} each have the same definition as that for R^{a}, X^{a}, and X^{b} in Formula (I), and the preferable forms thereof are the same as described above.

A^{a}, A^{b}, and A^{c} represent a hydrogen atom or a substituent. The substituent which can be employed as A^{a}, A^{b}, and A^{c} is not particularly limited, and examples thereof include groups selected from the group Z of substituents described below. Among these, a group selected from an alkyl group (the number of carbon atoms of the alkyl group is preferably in a range of 1 to 12, more preferably in a range of 1 to 6, and still more preferably in a range of 1 to 3, it is preferable that the alkyl group is unsubstituted, and specific preferred examples thereof include methyl, ethyl, isopropyl, and t-butyl), an aryl group (the number of carbon atoms of the aryl group is preferably in a range of 6 to 20, more preferably in a range of 6 to 15, and still more preferably in a range of 6 to 10, and specific preferred examples thereof include phenyl and naphthyl), an alkoxy group (the number of carbon atoms of the alkoxy group is preferably in a range of 1 to 10, more preferably in a range of 1 to 6, and still more preferably in a range of 1 to 3), a halogen atom (examples thereof include a fluorine atom, a chlorine atom, a bromine atom, and an iodine atom), a carboxy group, a hydroxy group, and an acylamino group (the number of carbon atoms of the acylamino group is preferably in a range of 2 to 10, more preferably in a range of 2 to 6, and still more preferably 2 or 3) is preferable, and an alkyl group or a halogen atom is more preferable.

It is preferable that at least one of A^{a}, A^{b}, or A^{c} represents a substituent and more preferable that at least one of A^{a}, A^{b}, or A^{c} represents an alkyl group. In this case, it is preferable that A^{a}, A^{b}, or A^{c} which does not represent an alkyl group represents a hydrogen atom.

In the repeating unit represented by Formula (I-a), two linking sites for incorporating a diamine component into the main chain of the polyimide compound are at the meta-position. Therefore, it is assumed that a structure in which the sulfamoyl group protrudes from the main chain of the polyimide is obtained so that the above-described action of the sulfamoyl group can be effectively exhibited. Further, it is considered that, in a case where at least one of A^{a}, A^{b}, or A^{c} has a substituent, suitable pores are generated while a dense packing state of the polyimide compound is maintained, and the gas permeability can be further increased.

It is preferable that the repeating unit represented by Formula (I-a) is a repeating unit represented by Formula (I-b).

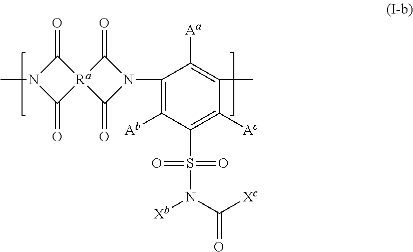

In Formula (I-b), R^{a}, X^{b}, A^{a}, A^{b}, and A^{c} each have the same definition as that for R^{a}, X^{b}, A^{a}, A^{b}, and A^{c} in Formula (I-a), and the preferable forms thereof are the same as described above.

X^{c} represents a substituent. Here, in a case where a structure represented by —N(X^{b})— in Formula (I-b) does not have a structural portion selected from OH, NH, and SH, X^{c} has at least one structural portion selected from OH, NH, and SH.

The substituent which can be employed as X^{c} is not particularly limited, and examples thereof include groups selected from the group Z of substituents described below. Among these, it is preferable that X^{c} represents an alkyl group, an alkenyl group, an alkynyl group, a cycloalkyl group, an aryl group, or an amino group.

The number of carbon atoms of the alkyl group which can be employed as X^{c} is preferably in a range of 1 to 10, more preferably in a range of 1 to 6, and still more preferably in a range of 1 to 3, and specific preferred examples thereof include methyl, ethyl, isopropyl, and t-butyl.

The number of carbon atoms of the alkenyl group which can be employed as X^{c} is preferably in a range of 2 to 10, more preferably in a range of 2 to 6, and still more preferably 2 or 3.

The number of carbon atoms of the alkynyl group which can be employed as X^{c} is preferably in a range of 2 to 10, more preferably in a range of 2 to 6, and still more preferably 2 or 3.

The number of carbon atoms of the cycloalkyl group which can be employed as X^{c} is preferably in a range of 3 to 10 and more preferably in a range of 3 to 8, and specific preferred examples thereof include cyclopentyl and cyclohexyl.

The number of carbon atoms of the aryl group which can be employed as X^{c} is preferably in a range of 6 to 20, more preferably in a range of 6 to 15, and still more preferably in a range of 6 to 10, and specific preferred examples thereof include phenyl and naphthyl.

As the amino group which can be employed as X^{c}, an alkylamino group (the number of carbon atoms of the alkylamino group is preferably in a range of 1 to 10, more preferably in a range of 1 to 6, and still more preferably in a range of 1 to 3), an alkenylamino group (the number of carbon atoms of the alkenylamino group is preferably in a range of 2 to 10, more preferably in a range of 2 to 6, and still more preferably 2 or 3), an alkynylamino group (the number of carbon atoms of the alkynylamino group is preferably in a range of 2 to 10, more preferably in a range of 2 to 6, and still more preferably 2 or 3), a cycloalkylamino group (the number of carbon atoms of the cycloalkylamino group is preferably in a range of 3 to 10 and more preferably in a range of 4 to 8), or an arylamino group (the number of carbon atoms of the arylamino group is preferably in a range of 6 to 20, more preferably in a range of 6 to 15, and still more preferably in a range of 6 to 10) is preferable.

It is more preferable that X^{c} represents an alkyl group, a cycloalkyl group, or an aryl group. Further, it is also preferable that X^{c} has at least one fluorine atom as a substituent. Further, it is also preferable that X^{c} contains a group selected from a carboxy group, a hydroxy group, a carbamoyl group, and a sulfamoyl group as a substituent.

Further, it is particularly preferable that X^{b} in Formula (I-b) represents a hydrogen atom. In this case, it is considered that the acyl group (—C(═O)X^{c}) in the repeating unit represented by Formula (I-b) becomes an acceptor (a site where an interaction with a hydrogen atom occurs) of a hydrogen bond, the donor property of hydrogen (X^{b}) in —N(X^{b})— can be increased due to the electron withdrawing property of the acyl group, the denseness of the polyimide compound is further increased, and this leads to the improvement of the gas separation selectivity and the plasticization resistance. Moreover, it is assumed that, in a case where X^{c} has fluorine atoms, the donor property of hydrogen in —N(X^{b})— is further increased due to the electron withdrawing property of the fluorine atoms, moderate pores are generated due to the repulsive force between the fluorine atoms, and the gas separation selectivity, the gas permeability, and the plasticization resistance can be achieved at higher levels. Further, it is considered that the fluorine atoms also contribute to suppression of hydrolysis of the polyimide compound due to the water-repellent property.

It is preferable that the repeating unit represented by Formula (I-a) is a repeating unit represented by Formula (I-c).

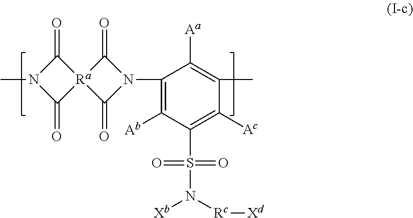

In Formula (I-c), R^{a}, X^{b}, A^{a}, A^{b}, and A^{c} each have the same definition as that for R^{a}, X^{b}, A^{a}, A^{b}, and A^{c} in Formula (I-a), and the preferable forms are the same as described above.

R^{c} represents an alkylene group, a cycloalkylene group, or an arylene group. The alkylene group which can be employed as R^{c} may be linear or branched. The number of carbon atoms of the alkylene group is preferably in a range of 1 to 12, more preferably in a range of 1 to 8, and still more preferably in a range of 1 to 4. The number of carbon atoms of the cycloalkylene group which can be employed as R^{c} is preferably in a range of 3 to 12, more preferably in a range of 3 to 9, and particularly preferably in a range of 3 to 6. The number of carbon atoms of the arylene group which can be employed as R^{c} is preferably in a range of 6 to 18, more preferably in a range of 6 to 14, and still more preferably in a range of 6 to 10. In addition, as the arylene group, phenylene is even still more preferable.

X^{d} represents a group having a structural portion selected from OH, NH, and SH, and the number of carbon atoms of X^{d} is in a range of 0 to 2. Preferred examples of X^{d} include an amino group, a monoalkylamino group, an acylamino group, a hydroxy group, a carboxy group, a carbamoyl group, a mercapto group, a boric acid group, a phosphoric acid group, a sulfo group, a sulfino group, a sulfamoyl group, an ureido group, a hydroxamic acid group, and a hydrazine group. Among these, an amino group, an acylamino group, a hydroxy group, a carboxy group, a carbamoyl group, a boric acid group, or a sulfamoyl group is more preferable, and an acylamino group, a hydroxy group, a carboxy group, a carbamoyl group, or a sulfamoyl group is particularly preferable.

It is assumed that the mobility of the repeating unit represented by Formula (I-c) can be increased due to the action of R^{c} serving as a linker site so that excellent gas permeability can be more reliably realized. In addition, it is assumed that the hydrogen bonding interaction between polyimide chains can also be increased since X^{d} has a structural portion selected from OH, NH, and SH. As the result, it is considered that excellent gas separation selectivity and the plasticization resistance can be realized by imparting denseness to the polyimide chains.

It is preferable that the repeating unit represented by Formula (I-c) is a repeating unit represented by Formula (I-d).

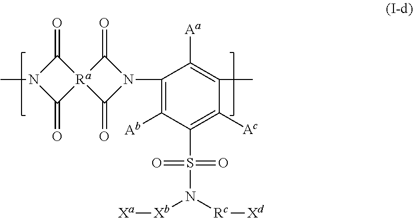

In Formula (I-d), R^{a}, R^{c}, X^{d}, A^{a}, A^{b}, and A^{c} each have the same definition as that for R^{a}, R^{c}, X^{d}, A^{a}, A^{b}, and A^{c} in Formula (I-c), and the preferable forms are the same as described above.

R^{d} represents an alkylene group, a cycloalkylene group, or an arylene group. The preferable forms of the alkylene group, the cycloalkylene group, and the arylene group which can be employed as R^{d} are the same as the preferable forms of the alkylene group, the cycloalkylene group, and the arylene group which can be employed as R^{c}.

X^{e} represents a group having a structural portion selected from OH, NH, and SH, and the number of carbon atoms of X^{e} is in a range of 0 to 2. The preferable forms of X^{e} are the same as the preferable forms of X^{d}.

It is assumed that, in a case where a polyimide compound having a repeating unit represented by Formula (I-d) is used for the gas separation layer, suitable pores can be generated while a dense packing state of the polyimide compound constituting the gas separation layer is maintained so that the gas separation selectivity and the gas permeability can be achieved at high levels.

The polyimide compound used in the present invention may have a repeating unit represented by Formula (II-a) and/or (II-b) in addition to the repeating unit represented by Formula (I).

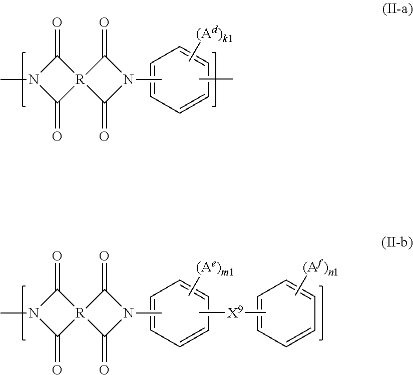

In Formulae (II-a) and (II-b), R has the same definition as that for R^{a} in Formula (I) and the preferable ranges are the same as each other. A^{d}, A^{e}, and A^{f} each independently represent a substituent. Examples of the substituent include groups selected from the group Z of substituents described below.

It is preferable that A^{d} represents an alkyl group, a carboxy group, or a halogen atom. k1 showing the number of A^{d}'s represents an integer of 0 to 4. In a case where A^{d} represents an alkyl group, k1 represents preferably 1 to 4, more preferably 2 to 4, and still more preferably 3 or 4. In a case where A^{d} represents a carboxy group, k1 represents preferably 1 or 2 and more preferably 1. In a case where A^{d} represents alkyl, the number of carbon atoms in alkyl groups is preferably in a range of 1 to 10, more preferably in a range of 1 to 5, and still more preferably in a range of 1 to 3. It is particularly preferable that the alkyl group is methyl, ethyl, or trifluoromethyl.

In Formula (II-a), it is preferable that both of two linking sites for being incorporated in the polyimide compound of the diamine component (that is, a phenylene group which can contain R⁴) are positioned in the meta position or the para position and more preferable that both of two linking sites are positioned in the para position.

In the present invention, the structure represented by Formula (II-a) does not include the structure represented by Formula (I).

It is preferable that A^{e} and A^{f} represent an alkyl group or a halogen atom or represent a group that forms a ring together with X⁹ by being linked to each other. Further, the form of two A^{e}'s being linked to each other to form a ring or the form of two A^{f}'s being linked to each other to form a ring is preferable. The structure formed by A^{e} and A^{f} being linked to each other is not particularly limited, but a single bond, —O—, or —S— is preferable. m1 showing the number of A^{e}'s and n1 showing the number of A^{f}'s each independently represent an integer of 0 to 4, preferably in a range of 1 to 4, more preferably in a range of 2 to 4, and still more preferably 3 or 4. In a case where A^{e} and A^{f} represent an alkyl group, the number of carbon atoms in the alkyl group is preferably in a range of 1 to 10, more preferably in a range of 1 to 5, and still more preferably in a range of 1 to 3. In addition, methyl, ethyl, or trifluoromethyl is even still more preferable.

X⁹ has the same definition as that for X¹ in Formula (I-1) and the preferable ranges are the same as each other.

In the structure of the polyimide compound used in the present invention, the content of the repeating unit represented by Formula (I) is preferably in a range of 30% to 100% by mole, more preferably in a range of 50% to 100% by mole, still more preferably in a range of 70% to 100% by mole, and particularly preferably in a range of 80% to 100% by mole.

In the structure of the polyimide compound used in the present invention, the ratio of the molar amount of the repeating unit represented by Formula (I) to the total molar amount of the repeating unit represented by Formula (I), the repeating unit represented by Formula (II-a), and the repeating unit represented by Formula (II-b) is preferably in a range of 30% to 100% by mole, more preferably in a range of 50% to 100% by mole, still more preferably in a range of 70% to 100% by mole, and even still more preferably in a range of 80% to 100% by mole. Further, the expression “the ratio of the molar amount of the repeating unit represented by Formula (I) to the total molar amount of the repeating unit represented by Formula (I), the repeating unit represented by Formula (II-a), and the repeating unit represented by Formula (II-b) is 100% by mole” means that the polyimide compound does not have any of the repeating unit represented by Formula (II-a) or the repeating unit represented by Formula (II-b).

It is preferable that the polyimide compound used in the present invention is formed of the repeating unit represented by Formula (I) or the repeating unit represented by Formula (I) and the repeating unit represented by Formula (II-a) and/or Formula (II-b). Here, the concept “formed of the repeating unit represented by Formula (II-a) and/or Formula (II-b)” includes three forms that are in the form of being formed of the repeating unit represented by Formula (II-a), the form of being formed of the repeating unit represented by Formula (II-b), and the form of being formed of the repeating unit represented by Formula (II-a) and the repeating unit represented by Formula (II-b).

Examples of the group Z of substituents include:

an alkyl group (the number of carbon atoms of the alkyl group is preferably in a range of 1 to 30, more preferably in a range of 1 to 20, and particularly preferably in a range of 1 to 10, and examples thereof include methyl, ethyl, iso-propyl, tert-butyl, n-octyl, n-decyl, and n-hexadecyl), a cycloalkyl group (the number of carbon atoms of the cycloalkyl group is preferably in a range of 3 to 30, more preferably in a range of 3 to 20, and particularly preferably in a range of 3 to 10, and examples thereof include cyclopropyl, cyclopentyl, and cyclohexyl), an alkenyl group (the number of carbon atoms of the alkenyl group is preferably in a range of 2 to 30, more preferably in a range of 2 to 20, and particularly preferably in a range of 2 to 10, and examples thereof include vinyl, allyl, 2-butenyl, and 3-pentenyl), an alkynyl group (the number of carbon atoms of the alkynyl group is preferably in a range of 2 to 30, more preferably in a range of 2 to 20, and particularly preferably in a range of 2 to 10, and examples thereof include propargyl and 3-pentynyl), an aryl group (the number of carbon atoms of the aryl group is preferably in a range of 6 to 30, more preferably in a range of 6 to 20, and particularly preferably in a range of 6 to 12, and examples thereof include phenyl, p-methylphenyl, naphthyl, and anthranyl), an amino group (such as an amino group, an alkylamino group, an arylamino group, or a heterocyclic amino group; the number of carbon atoms of the amino group is preferably in a range of 0 to 30, more preferably in a range of 0 to 20, even still more preferably in a range of 0 to 10, and particularly preferably in a range of 0 to 6 and examples thereof include amino, methylamino, dimethylamino, diethylamino, dibenzylamino, diphenylamino, and ditolylamino), an alkoxy group (the number of carbon atoms of the alkoxy group is preferably in a range of 1 to 30, more preferably in a range of 1 to 20, and particularly preferably in a range of 1 to 10, and examples thereof include methoxy, ethoxy, butoxy, and 2-ethylhexyloxy), an aryloxy group (the number of carbon atoms of the aryloxy group is preferably in a range of 6 to 30, more preferably in a range of 6 to 20, and particularly preferably in a range of 6 to 12, and examples thereof include phenyloxy, 1-naphthyloxy, and 2-naphthyloxy), a heterocyclic oxy group (the number of carbon atoms of the heterocyclic oxy group is preferably in a range of 1 to 30, more preferably in a range of 1 to 20, and particularly preferably in a range of 1 to 12, and examples thereof include pyridyloxy, pyrazyloxy, pyrimidyloxy, and quinolyloxy),

an acyl group (the number of carbon atoms of the acyl group is preferably in a range of 1 to 30, more preferably in a range of 1 to 20, still more preferably in a range of 1 to 12, and particularly preferably in a range of 2 to 8, and examples thereof include acetyl, benzoyl, formyl, and pivaloyl), an alkoxycarbonyl group (the number of carbon atoms of the alkoxycarbonyl group is preferably in a range of 2 to 30, more preferably in a range of 2 to 20, and particularly preferably in a range of 2 to 12, and examples thereof include methoxycarbonyl and ethoxycarbonyl), an aryloxycarbonyl group (the number of carbon atoms of the aryloxycarbonyl group is preferably in a range of 7 to 30, more preferably in a range of 7 to 20, and particularly preferably in a range of 7 to 12, and examples thereof include phenyloxycarbonyl), an acyloxy group (the number of carbon atoms of the acyloxy group is preferably in a range of 2 to 30, more preferably in a range of 2 to 20, and particularly preferably in a range of 2 to 10, and examples thereof include acetoxy and benzoyloxy), an acylamino group (the number of carbon atoms of the acylamino group is preferably in a range of 2 to 30, more preferably in a range of 2 to 20, still more preferably in a range of 2 to 10, and particularly preferably in a range of 2 to 5, and examples thereof include acetylamino and benzoylamino),

an alkoxycarbonylamino group (the number of carbon atoms of the alkoxycarbonylamino group is preferably in a range of 2 to 30, more preferably in a range of 2 to 20, and particularly preferably in a range of 2 to 12, and examples thereof include methoxycarbonylamino), an aryloxycarbonylamino group (the number of carbon atoms of the aryloxycarbonylamino group is preferably in a range of 7 to 30, more preferably in a range of 7 to 20, and particularly preferably in a range of 7 to 12, and examples thereof include phenyloxycarbonylamino), a sulfonylamino group (the number of carbon atoms of the sulfonylamino group is preferably in a range of 1 to 30, more preferably in a range of 1 to 20, and particularly preferably in a range of 1 to 12, and examples thereof include methanesulfonylamino and benzenesulfonylamino), a sulfamoyl group (the number of carbon atoms of the sulfamoyl group is preferably in a range of 0 to 30, more preferably in a range of 0 to 20, still more preferably in a range of 0 to 12, and particularly preferably in a range of 0 to 6, and examples thereof include sulfamoyl, methylsulfamoyl, dimethylsulfamoyl, and phenylsulfamoyl), a carbamoyl group (the number of carbon atoms of the carbamoyl group is preferably in a range of 1 to 20, more preferably in a range of 1 to 16, still more preferably in a range of 1 to 12, and particularly preferably in a range of 1 to 7, and examples thereof include a carbamoyl group, a methylcarbamoyl group, a diethylcarbamoyl group, and a phenylcarbamoyl group),

an alkylthio group (the number of carbon atoms of the alkylthio group is preferably in a range of 1 to 30, more preferably in a range of 1 to 20, and particularly preferably in a range of 1 to 12, and examples thereof include methylthio and ethylthio), an arylthio group (the number of carbon atoms of the arylthio group is preferably in a range of 6 to 30, more preferably in a range of 6 to 20, and particularly preferably in a range of 6 to 12, and examples thereof include phenylthio), a heterocyclic thio group (the number of carbon atoms of the heterocyclic thio group is preferably in a range of 1 to 30, more preferably in a range of 1 to 20, and particularly preferably in a range of 1 to 12, and examples thereof include pyridylthio, 2-benzimidazolylthio, 2-benzoxazolylthio, and 2-benzothiazolylthio),

a sulfonyl group (the number of carbon atoms of the sulfonyl group is preferably in a range of 1 to 30, more preferably in a range of 1 to 20, and particularly preferably in a range of 1 to 12, and examples thereof include mesyl and tosyl), a sulfinyl group (the number of carbon atoms of the sulfinyl group is preferably in a range of 1 to 30, more preferably in a range of 1 to 20, and particularly preferably in a range of 1 to 12, and examples thereof include methanesulfinyl and benzenesulfinyl), an ureido group (the number of carbon atoms of the ureido group is preferably in a range of 1 to 30, more preferably in a range of 1 to 20, and particularly preferably in a range of 1 to 12, and examples thereof include ureido, methylureido, and phenylureido), a phosphoric acid amide group (the number of carbon atoms of the phosphoric acid amide group is preferably in a range of 1 to 30, more preferably in a range of 1 to 20, and particularly preferably in a range of 1 to 12, and examples thereof include diethyl phosphoric acid amide and phenyl phosphoric acid amide), a hydroxy group, a mercapto group, a halogen atom (such as a fluorine atom, a chlorine atom, a bromine atom, or an iodine atom, and a fluorine atom is more preferable),

a cyano group, a carboxy group, an oxo group, a nitro group, a hydroxamic acid group, a sulfino group, a hydrazine group, an imino group, a heterocyclic group (a 3- to 7-membered ring heterocyclic group is preferable, the hetero ring may be aromatic or non-aromatic, examples of a heteroatom constituting the hetero ring include a nitrogen atom, an oxygen atom, and a sulfur atom, the number of carbon atoms of the heterocyclic group is preferably in a range of 0 to 30 and more preferably in a range of 1 to 12, and specific examples thereof include imidazolyl, pyridyl, quinolyl, furyl, thienyl, piperidyl, morpholino, benzoxazolyl, benzimidazolyl, benzothiazolyl, carbazolyl, and azepinyl), a silyl group (the number of carbon atoms of the silyl group is preferably in a range of 3 to 40, more preferably in a range of 3 to 30, and particularly preferably in a range of 3 to 24, and examples thereof include trimethylsilyl and triphenylsilyl), and a silyloxy group (the number of carbon atoms of the silyloxy group is preferably in a range of 3 to 40, more preferably in a range of 3 to 30, and particularly preferably in a range of 3 to 24, and examples thereof include trimethylsilyloxy and triphenylsilyloxy). These substituents may be substituted with any one or more substituents selected from the group Z of substituents.

Further, in the present invention, in a case where a plurality of substituents are present at one structural site, these substituents may be linked to each other to form a ring or may be condensed with some or entirety of the structural site and form an aromatic ring or an unsaturated hetero ring.

In a case where a compound or a substituent includes an alkyl group or an alkenyl group, these may be linear or branched and may be substituted or unsubstituted. In addition, in a case where a compound or a substituent includes an aryl group or a heterocyclic group, these may be a single ring or a condensed ring and may be substituted or unsubstituted.

The molecular weight of the polyimide compound used in the present invention is preferably in a range of 10,000 to 1,000,000, more preferably in a range of 15,000 to 500,000, and still more preferably in a range of 20,000 to 200,000, as the weight-average molecular weight.

The molecular weight and the dispersity in the present specification are set to values measured using a gel permeation chromatography (GPC) method unless otherwise specified and the molecular weight is set to a weight-average molecular weight in terms of polystyrene. A gel including an aromatic compound as a repeating unit is preferable as a gel filling a column used for the GPC method and examples of the gel include a gel formed of a styrene-divinylbenzene copolymer. It is preferable that two to six columns are linked to each other and used. Examples of a solvent to be used include an ether-based solvent such as tetrahydrofuran and an amide-based solvent such as N-methylpyrrolidinone. It is preferable that measurement is performed at a flow rate of the solvent of 0.1 to 2 mL/min and most preferable that the measurement is performed at a flow rate thereof of 0.5 to 1.5 mL/min. In a case where the measurement is performed in the above-described range, a load is not applied to the apparatus and the measurement can be more efficiently performed. The measurement temperature is preferably in a range of 10° C. to 50° C. and most preferably in a range of 20° C. to 40° C. In addition, the column and the carrier to be used can be appropriately selected according to the physical properties of a polymer compound which is a target for measurement.

(Synthesis of Polyimide Compound)

The polyimide compound used in the present invention can be synthesized by performing condensation and polymerization of a specific difunctional acid anhydride (tetracarboxylic dianhydride) and a specific diamine. Such methods can be performed by referring to the technique described in a general book (for example, “The Latest Polyimide ˜Fundamentals and Applications˜” edited by Toshio Imai and Rikio Yokota, NTS Inc., Aug. 25, 2010, pp. 3 to 49) as appropriate.

At least one tetracarboxylic dianhydride serving as a raw material in synthesis of the polyimide compound used in the present invention is represented by Formula (IV). It is preferable that all tetracarboxylic dianhydrides which are the raw materials are represented by Formula (IV).

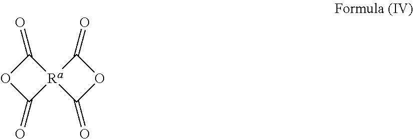

In Formula (IV), R^{a} has the same definition as that for R^{a} in Formula (I).

Specific examples of the tetracarboxylic dianhydride which can be used in the present invention are shown below.

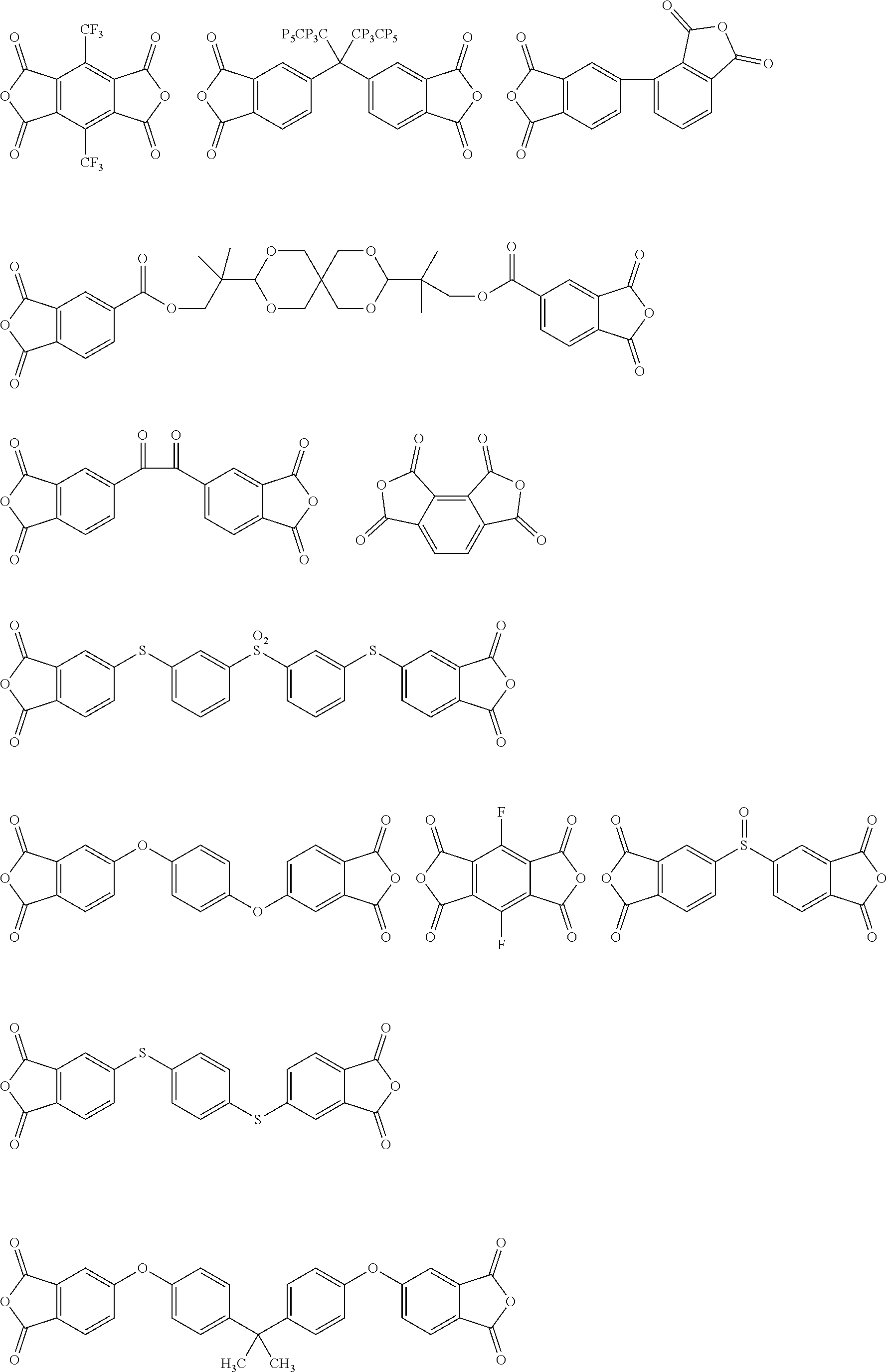

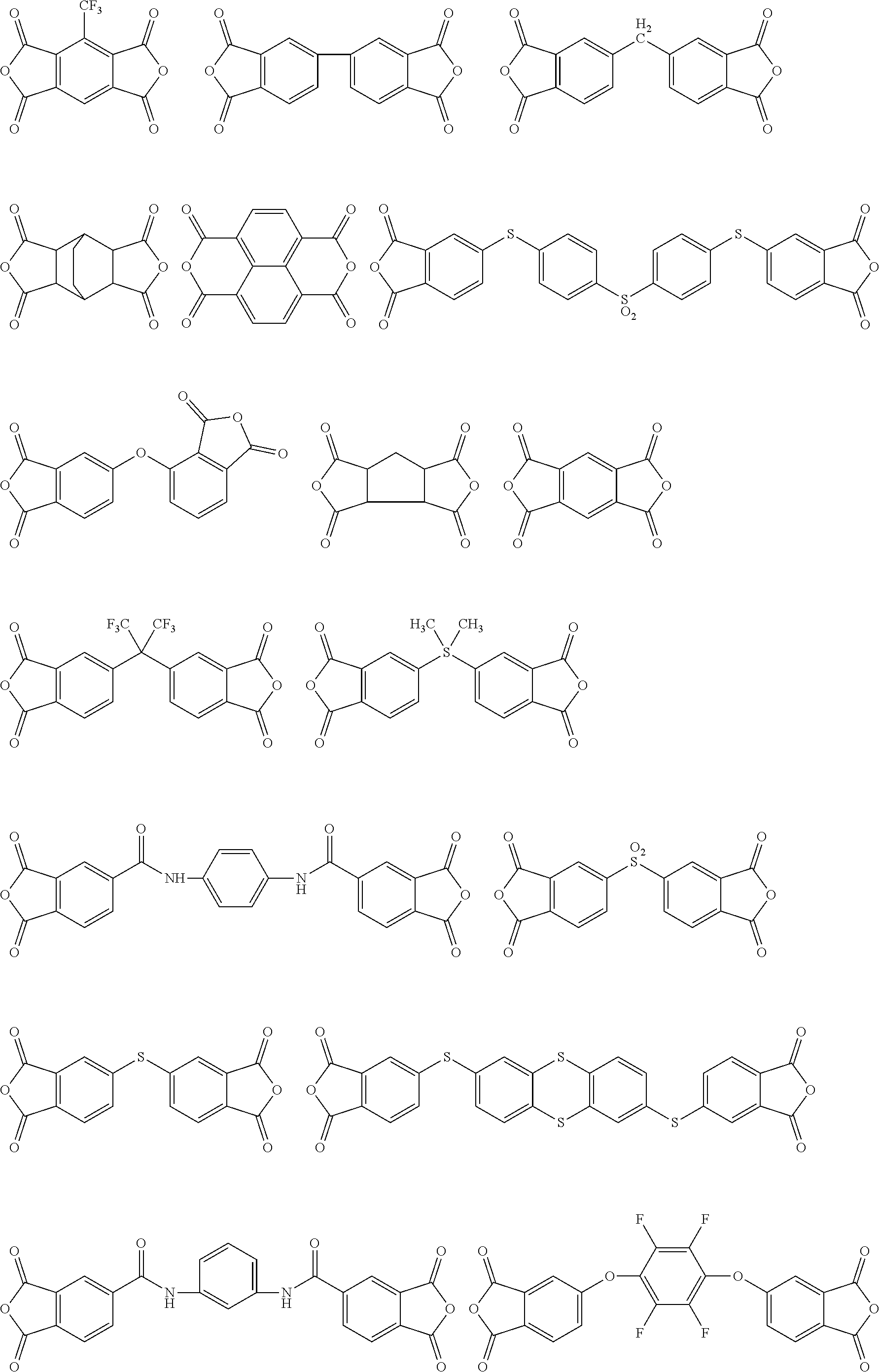

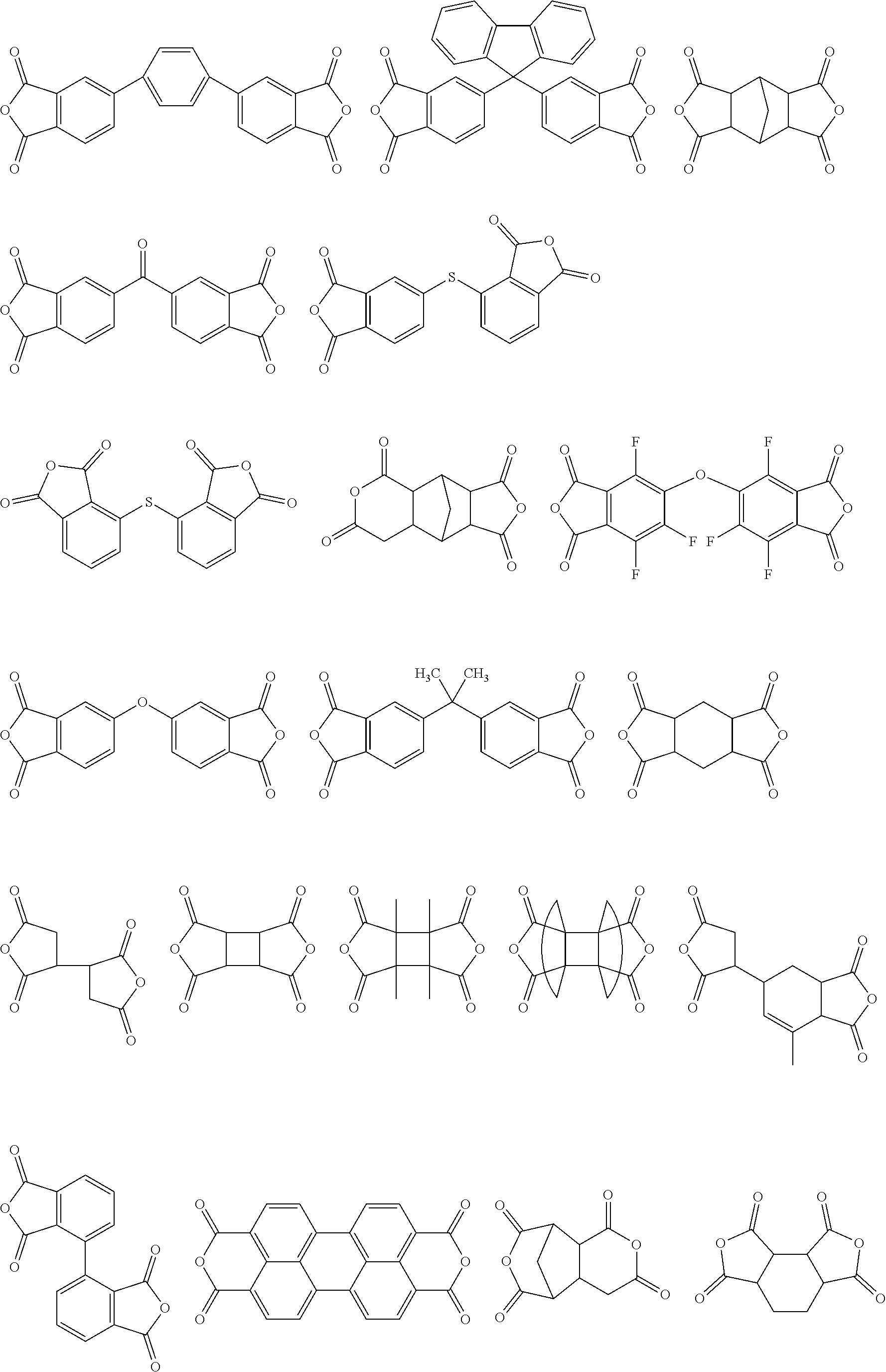

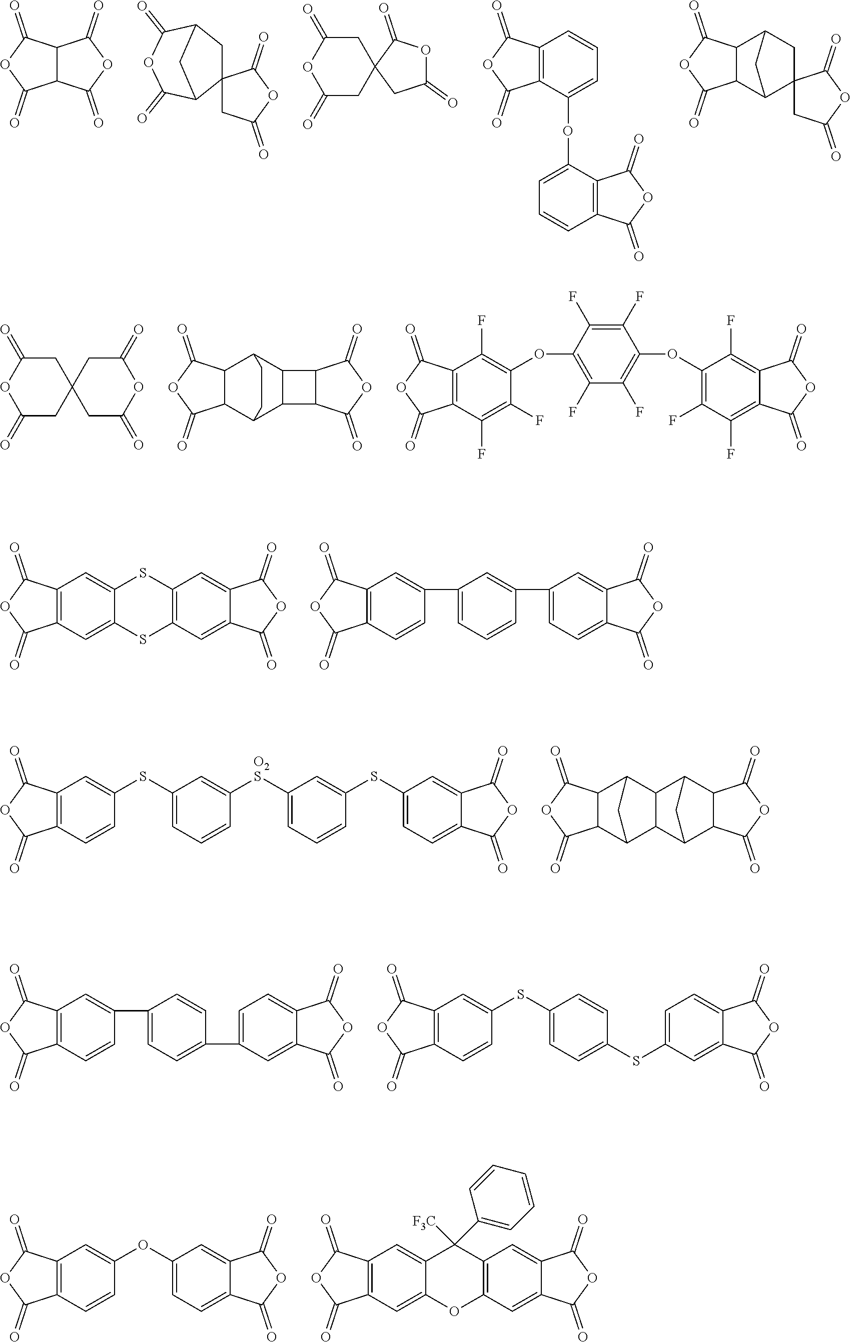

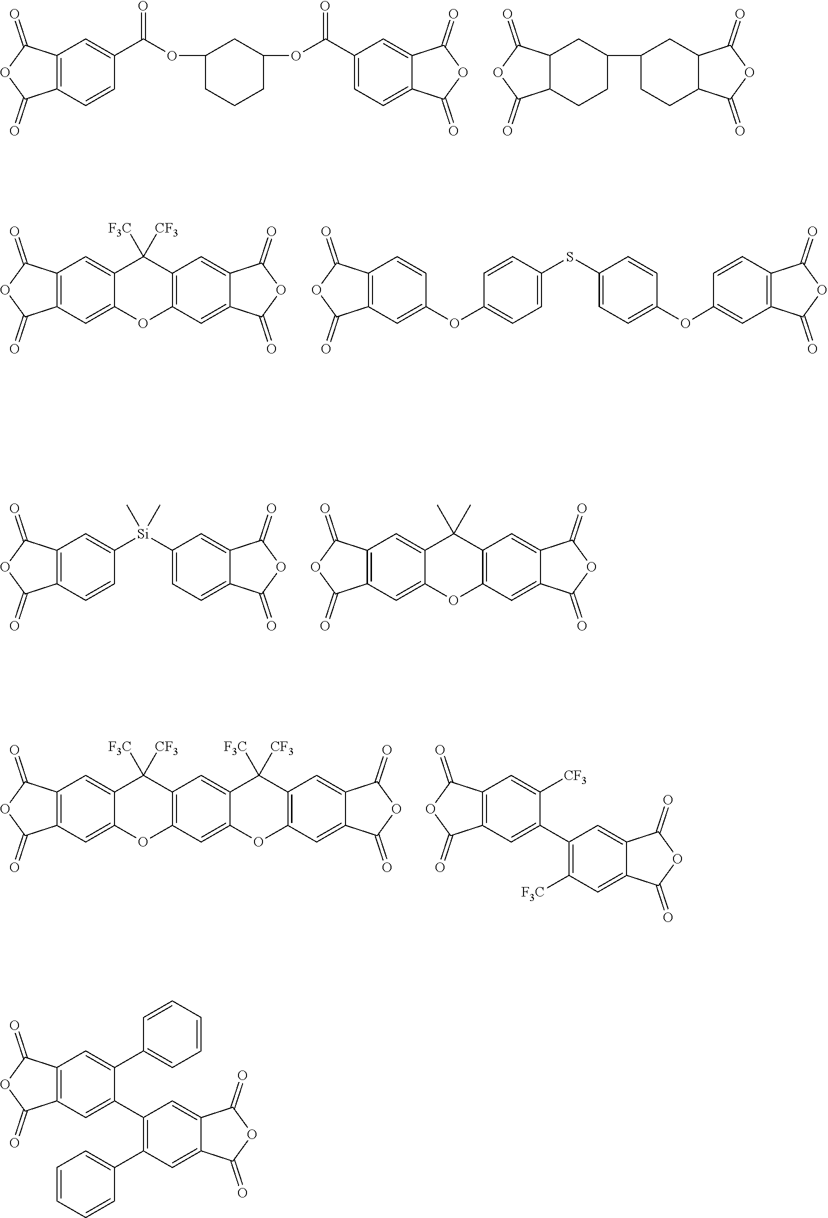

In the synthesis of the polyimide compound which can be used in the present invention, at least one of diamine compounds serving as other raw materials is represented by Formula (V).

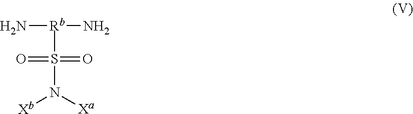

In Formula (V), R^{b}, X^{a}, and X^{b} each have the same definition as that for R^{b}, X^{a}, and X^{b} in Formula (I).

Specific examples of the diamine compound represented by Formula (V) are those shown below, but the present invention is not limited thereto.

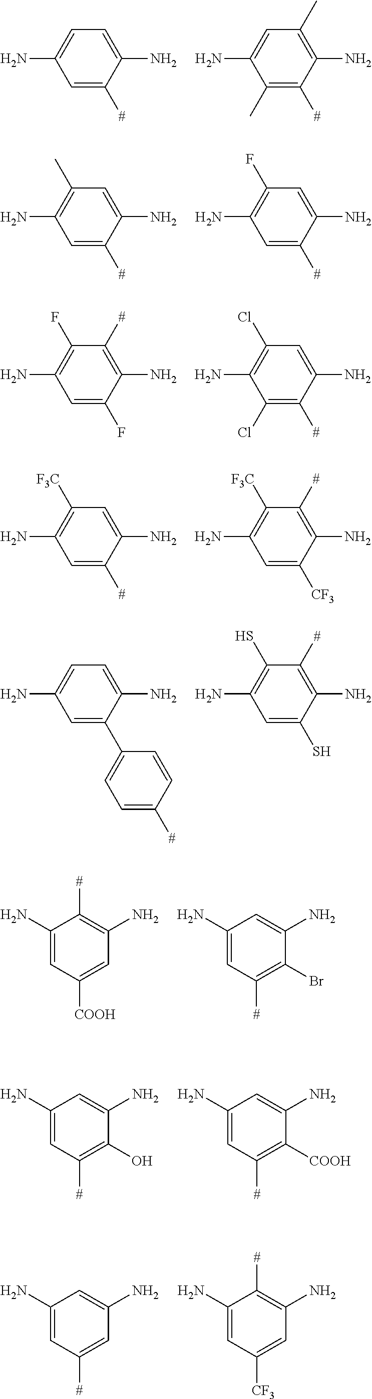

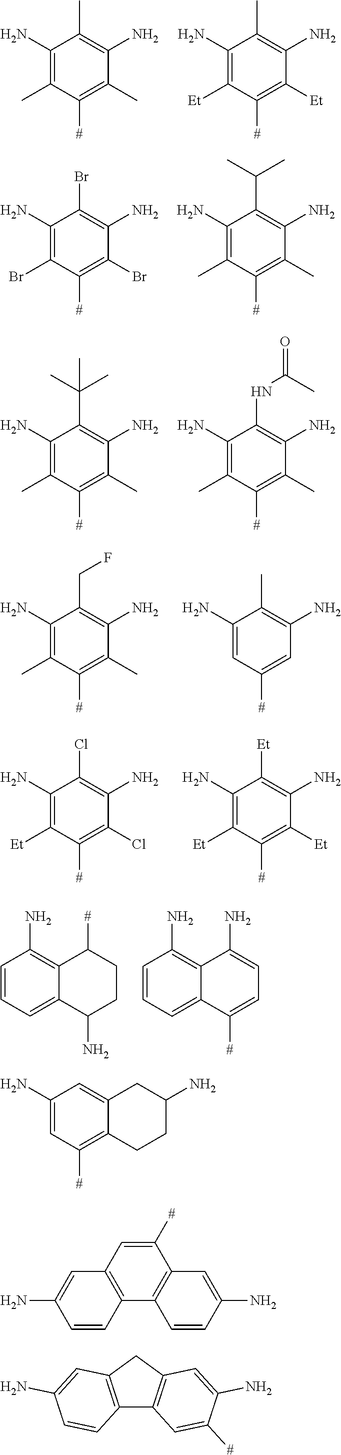

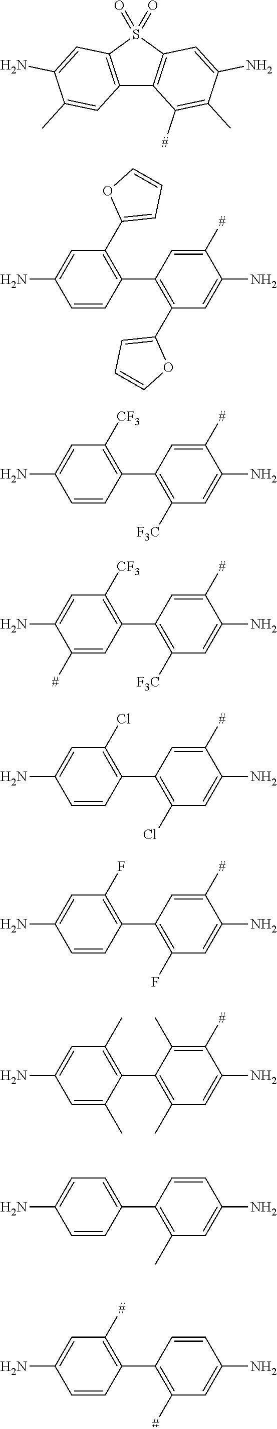

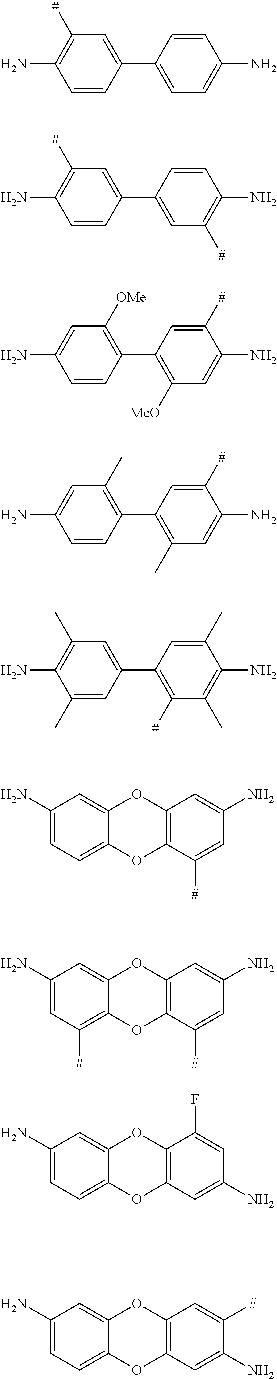

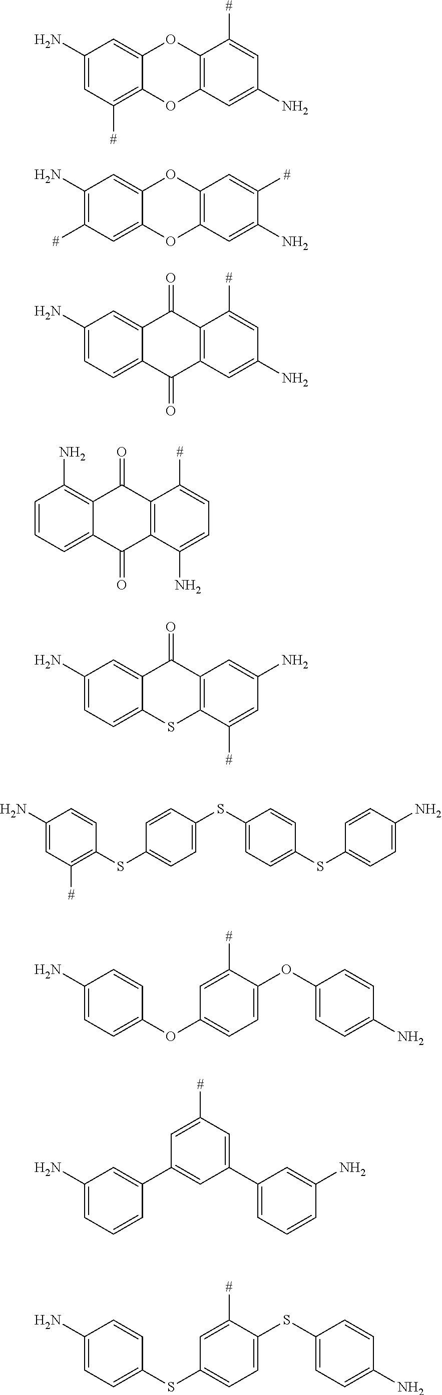

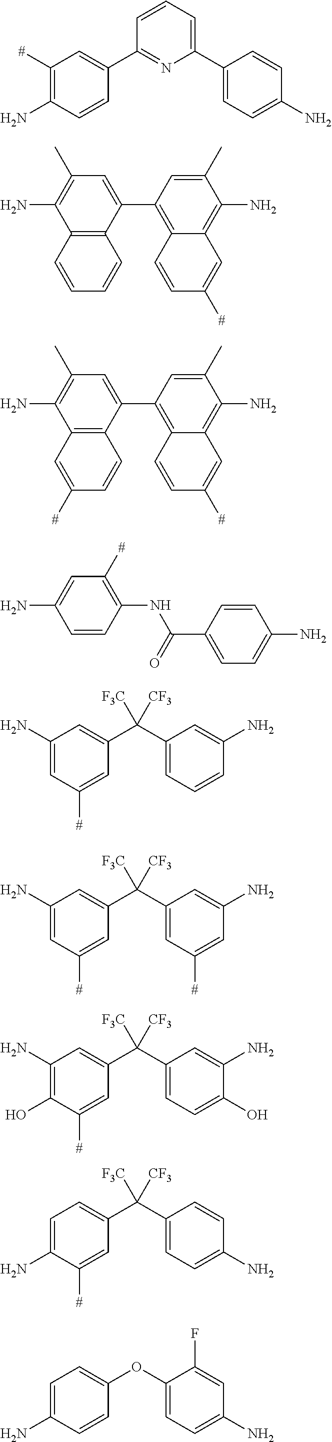

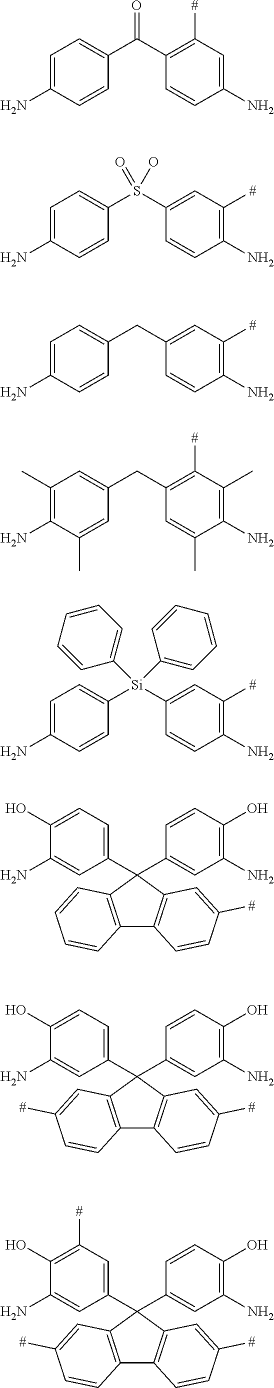

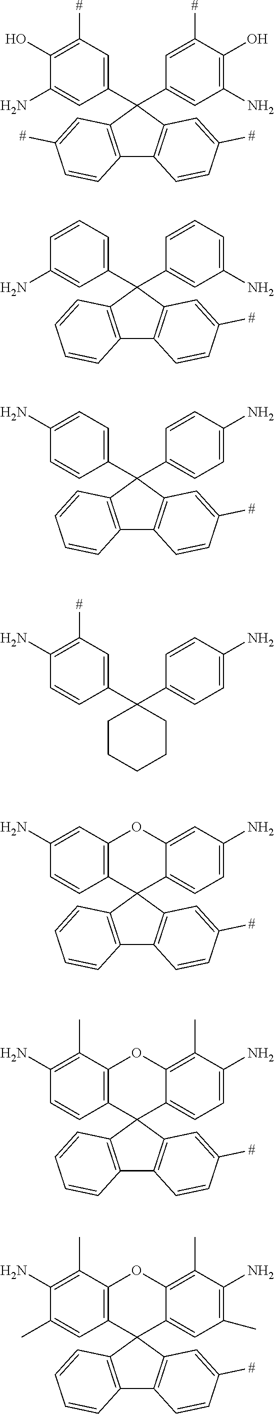

In each structural formula, the symbol “#” represents a linking site with respect to —S(═O)₂N(X^{b})X^{a} in Formula (V). Specific examples of —S(═O)₂N(X^{b})X^{a} are shown below.

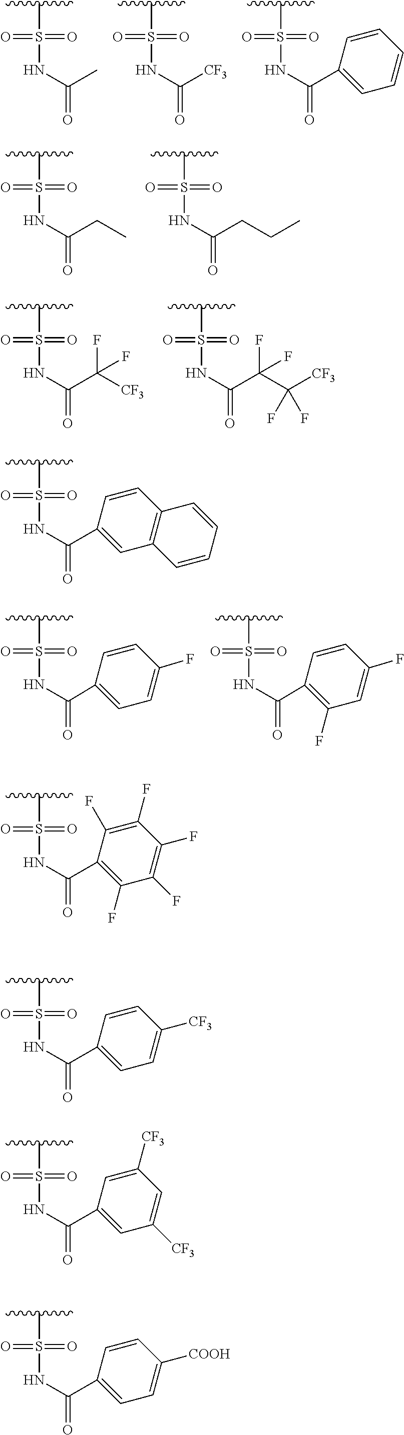

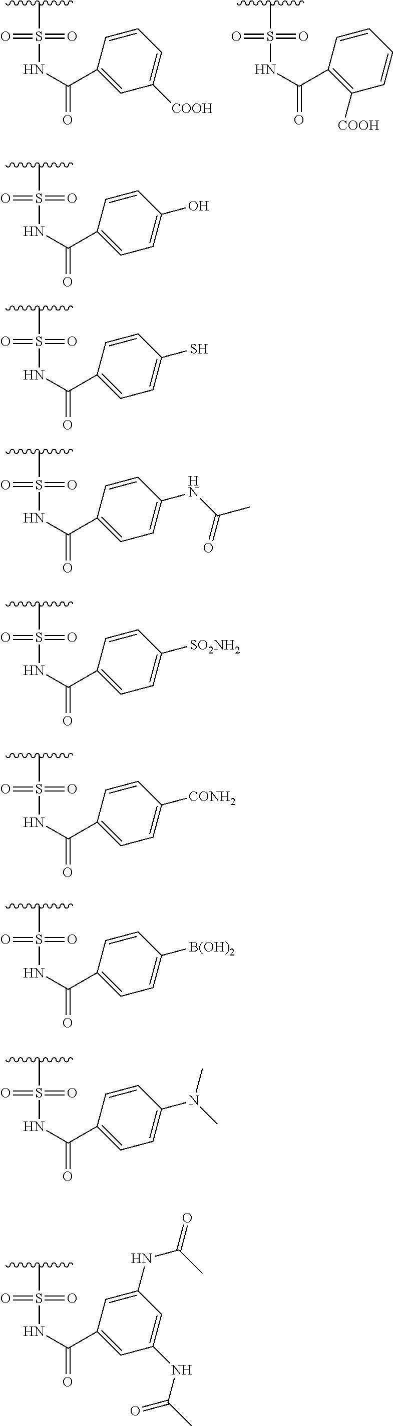

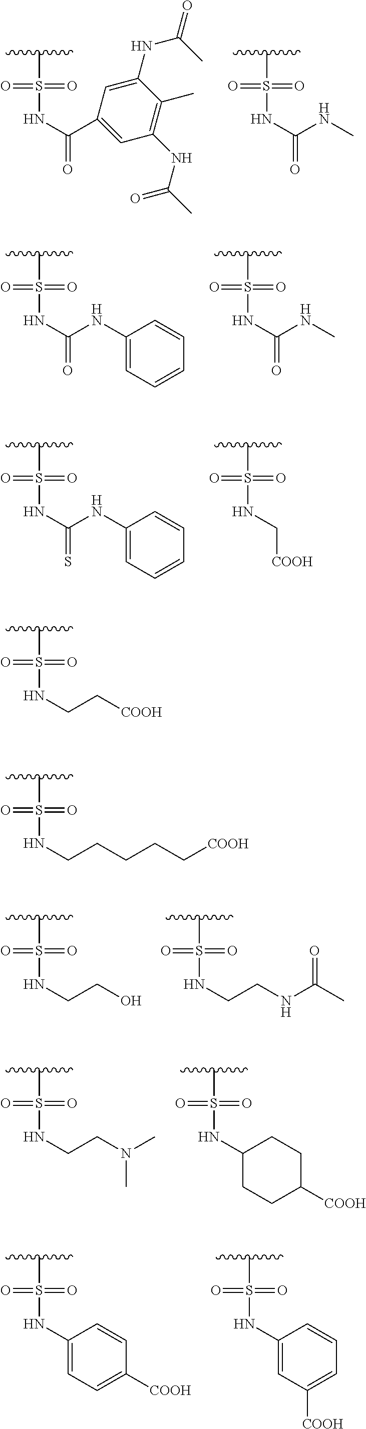

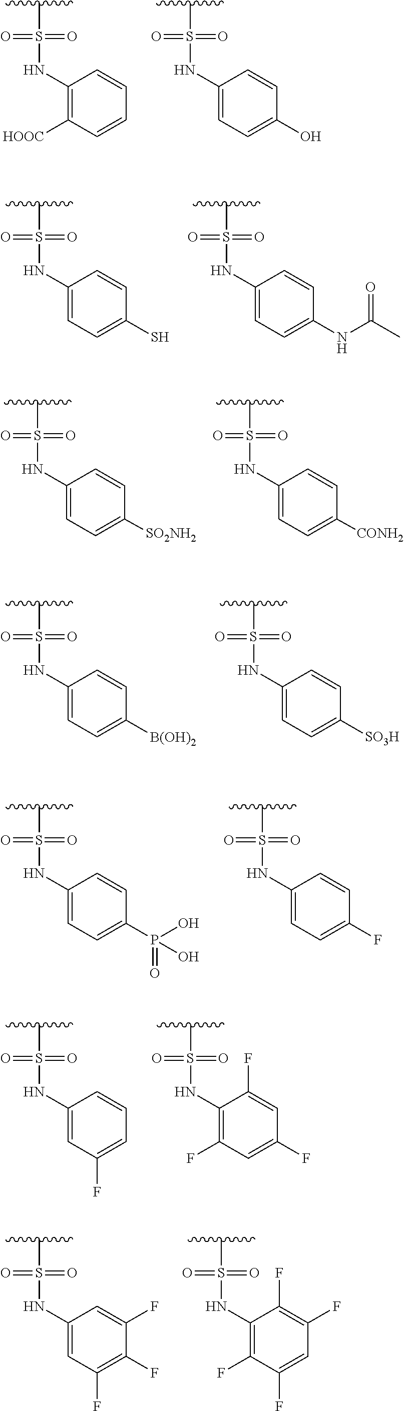

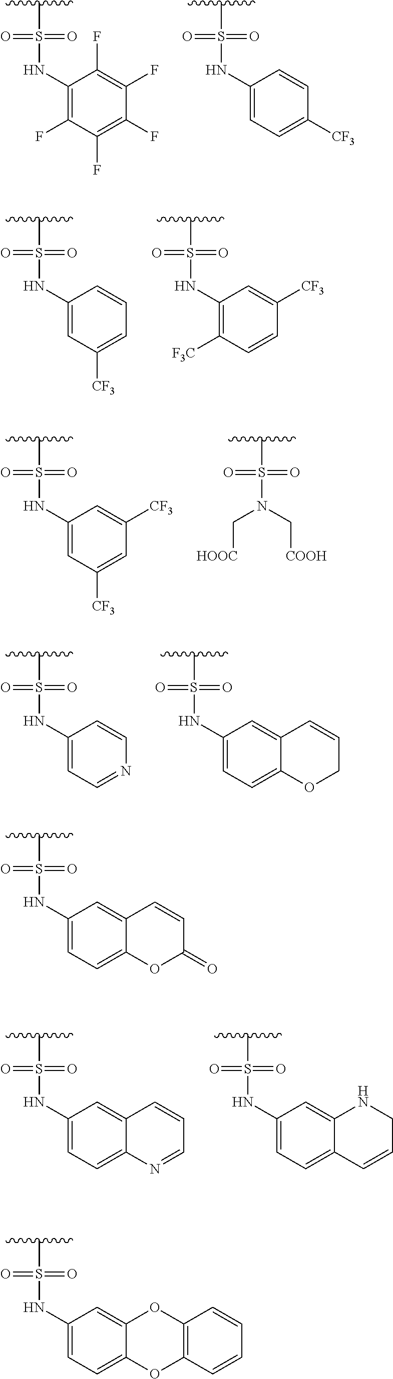

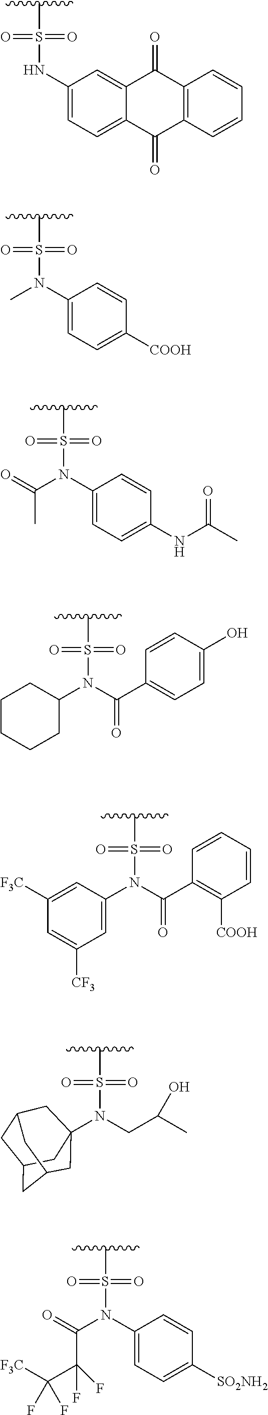

In the synthesis of the polyimide compound which can be used in the present invention, a diamine compound represented by Formula (VI-a) or (VI-b) may be used as a diamine compound serving as a raw material, in addition to the diamine compound represented by Formula (V).

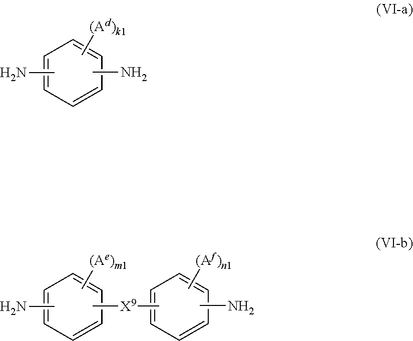

In Formula (VI-a), A^{d} and k1 each have the same definition as that for A^{d} and k1 in Formula (II-a). The diamine compound represented by Formula (VI-a) does not include the diamine compound represented by Formula (V).

In Formula (VI-b), A^{e}, A^{f}, X⁹, m1, and n1 each have the same definition as that for A^{e}, A^{f}, X⁹, m1, and n1 in Formula (II-b). The diamine compound represented by Formula (VI-b) does not include the diamine compound represented by Formula (V).

As the diamine represented by Formula (VI-a) or (VI-b), for example, the following compounds can be used.

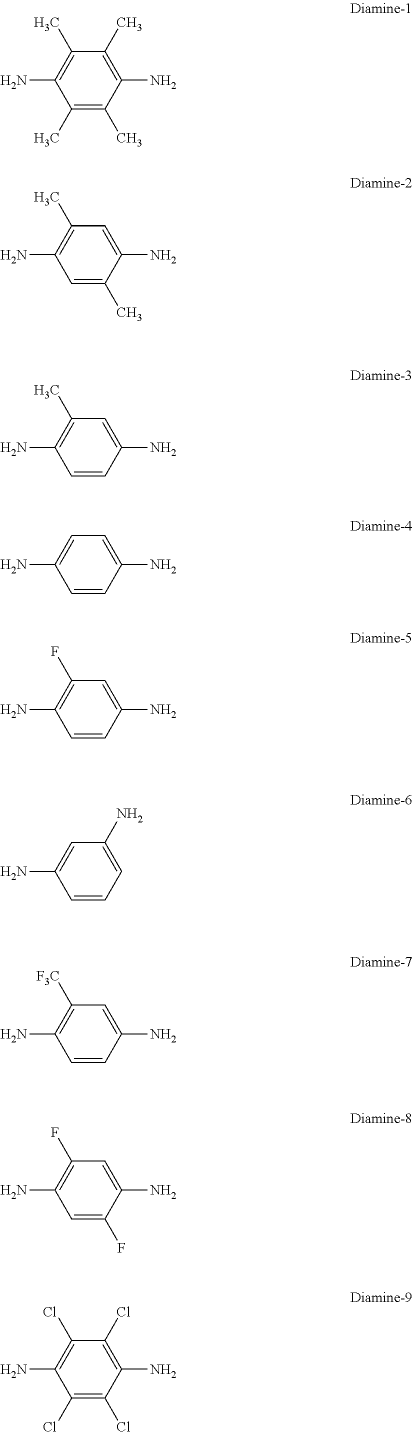

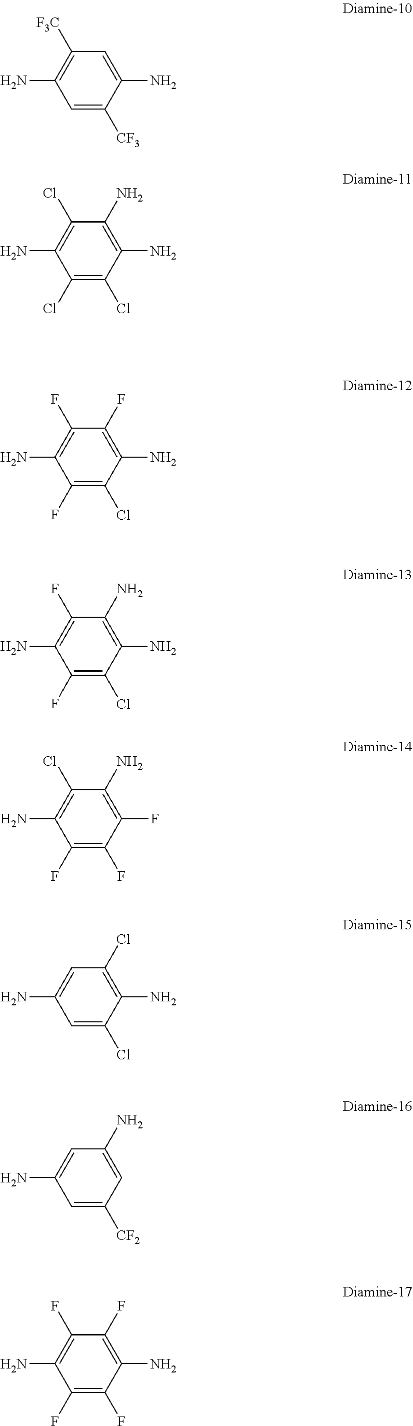

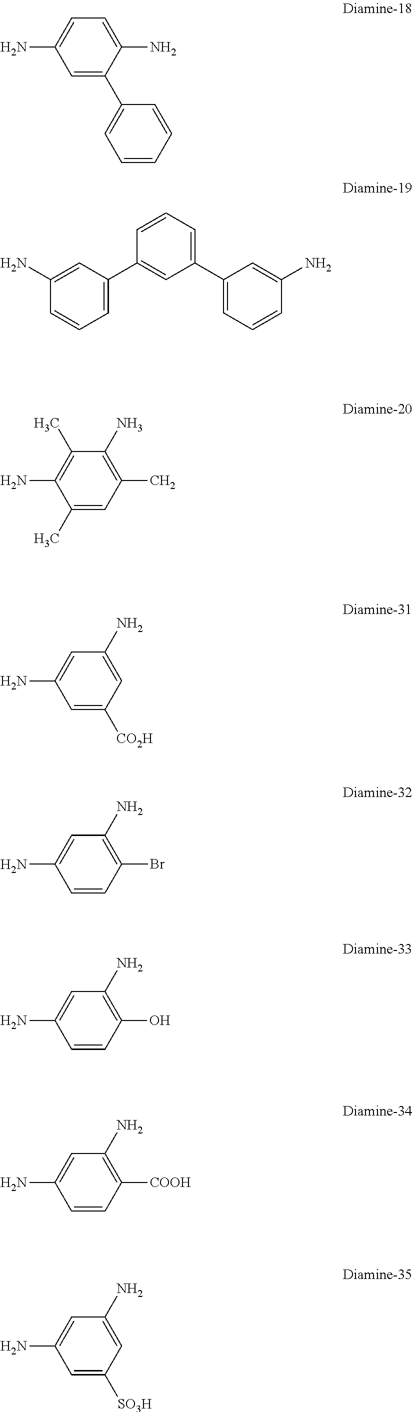

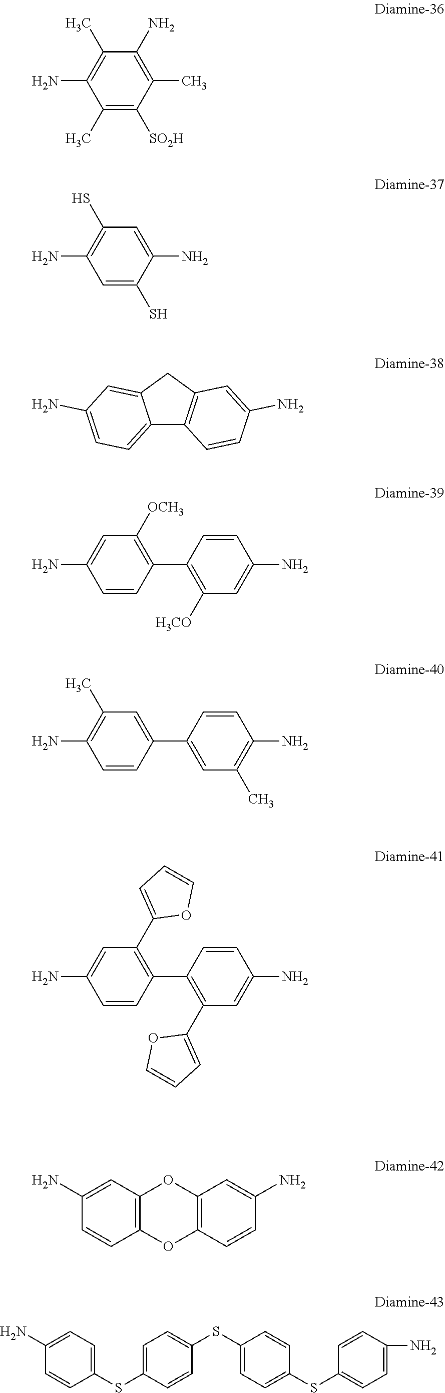

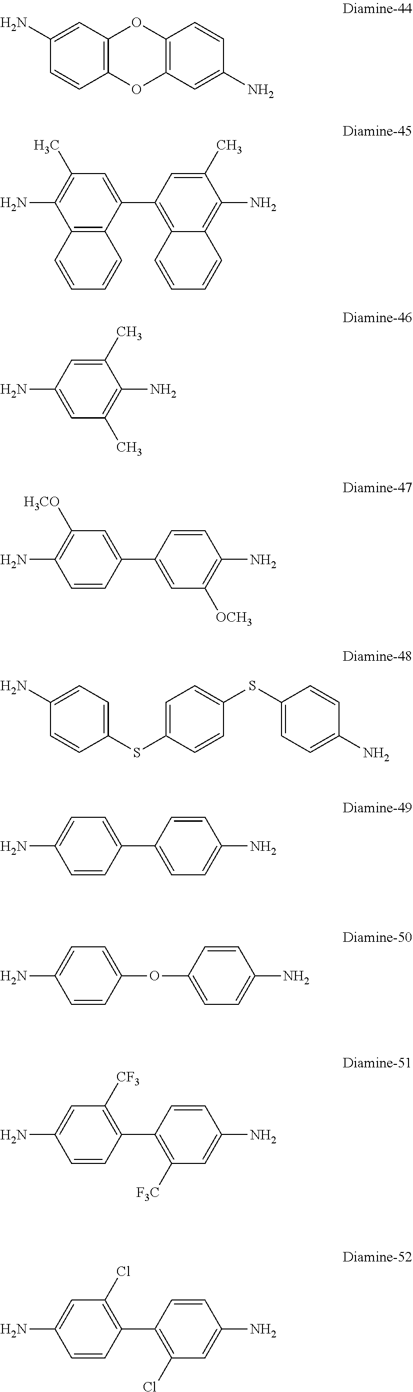

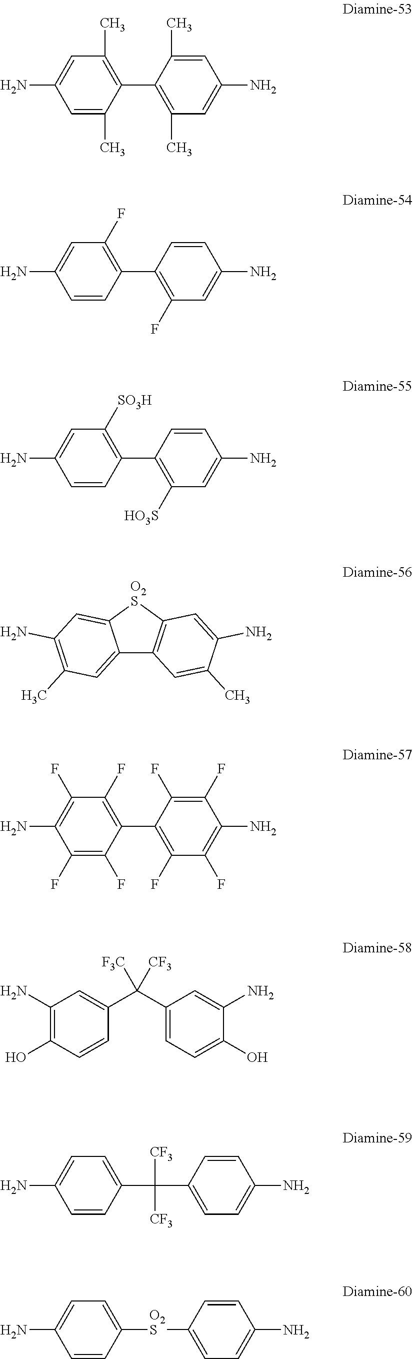

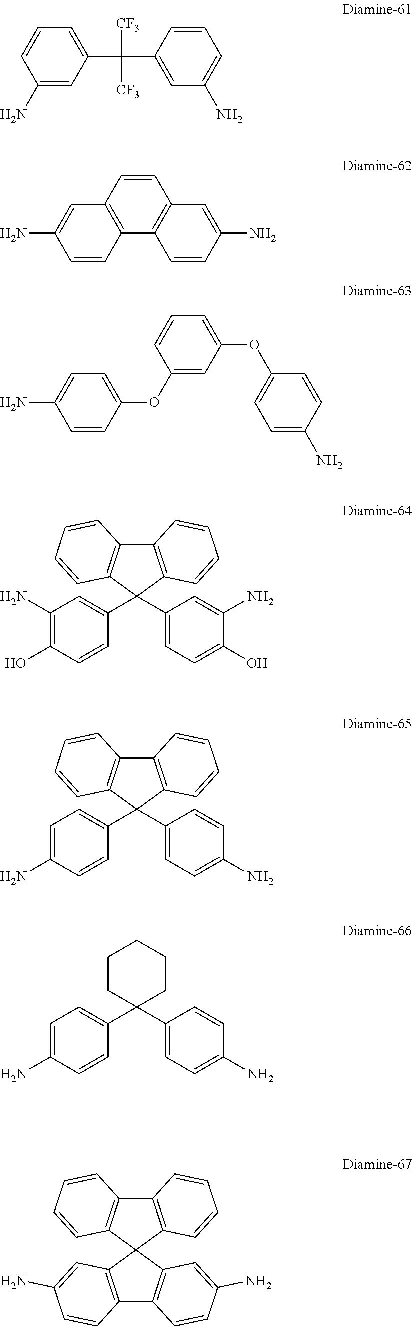

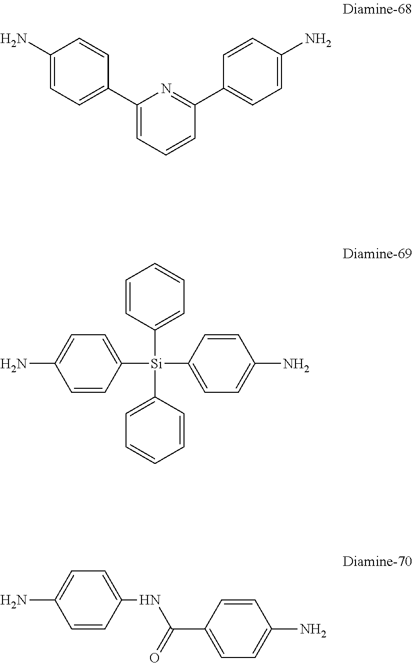 [SMILES: Nc1ccc(-c2cccc(-c3ccc(N)cc3)n2)cc1 ; Nc1ccc([Si](c2ccccc2)(c2ccccc2)c2ccc(N)cc2)cc1 ; Nc1ccc(NC(=O)c2ccc(N)cc2)cc1]

A monomer represented by Formula (IV) and a monomer represented by Formula (V), (VI-a), or (VI-b) may be used as an oligomer or a prepolymer. The polyimide compound used in the present invention may be any of a block copolymer, a random copolymer, or a graft copolymer.

The polyimide compound used in the present invention can be obtained by mixing the above-described raw materials in a solvent and condensing and polymerizing the mixture using a typical method as described above.

The solvent is not particularly limited, and examples thereof include an ester-based organic solvent such as methyl acetate, ethyl acetate, or butyl acetate; an aliphatic ketone-based organic solvent such as acetone, methyl ethyl ketone, methyl isobutyl ketone, diacetone alcohol, cyclopentanone, or cyclohexanone; an ether-based organic solvent such as ethylene glycol dimethyl ether, dibutyl butyl ether, tetrahydrofuran, methyl cyclopentyl ether, or dioxane; an amide-based organic solvent such as N-methylpyrrolidone, 2-pyrrolidone, dimethylformamide, dimethylimidazolidinone, or dimethylacetamide; and a sulfur-containing organic solvent such as dimethyl sulfoxide or sulfolane. These organic solvents can be suitably selected within the range in which a tetracarboxylic dianhydride serving as a reaction substrate, a diamine compound, polyamic acid which is a reaction intermediate, and a polyimide compound which is a final product can be dissolved. Among these, an ester-based organic solvent (preferably butyl acetate), an aliphatic ketone-based organic solvent (preferably methyl ethyl ketone, methyl isobutyl ketone, diacetone alcohol, cyclopentanone, or cyclohexanone), an ether-based organic solvent (diethylene glycol monomethyl ether or methyl cyclopentyl ether), an amide-based organic solvent (preferably N-methylpyrrolidone), or a sulfur-containing organic solvent (dimethyl sulfoxide or sulfolane) is preferable. In addition, these can be used alone or in combination of two or more kinds thereof.

The temperature of the polymerization reaction is not particularly limited and a temperature which can be typically employed for the synthesis of the polyimide compound can be employed. Specifically, the temperature is preferably in a range of −40° C. to 60° C. and more preferably in a range of −30° C. to 50° C.

The polyimide compound can be obtained by imidizing the polyamic acid, which is generated by the above-described polymerization reaction, through a dehydration ring-closure reaction in a molecule. The method of the dehydration ring-closure can be performed by referring to the method described in a general book (for example, “The Latest Polyimide ˜Fundamentals and Applications˜” edited by Toshio Imai and Rikio Yokota, NTS Inc., Aug. 25, 2010, pp. 3 to 49). A thermal imidization method of performing heating in a temperature range of 120° C. to 200° C. and removing water generated as a by-product to the outside of the system for a reaction or a so-called chemical imidization method in which a dehydration condensation agent such as an acetic anhydride, dicyclohexylcarbodiimide, or triphenyl phosphite is used in the coexistence of a basic catalyst such as pyridine, triethylamine, or DBU is suitably used.

In the present invention, the total concentration of the tetracarboxylic dianhydride and the diamine compound in the polymerization reaction solution of the polyimide compound is not particularly limited, but is preferably in a range of 5% to 70% by mass, more preferably in a range of 5% to 50% by mass, and still more preferably in a range of 5% to 30% by mass.

[Gas Separation Membrane]

(Gas Separation Composite Membrane)

The gas separation composite membrane which is a preferable form of the gas separation membrane according to the embodiment of the present invention is provided with a gas separation layer containing a specific polyimide compound as a constituent material on a gas permeating support layer. It is preferable that this composite membrane is provided with the gas separation layer by coating (doping) at least a surface of a porous support with a coating solution containing the polyimide compound. In the present specification, the concept “coating” includes the form of immersion in a coating solution.

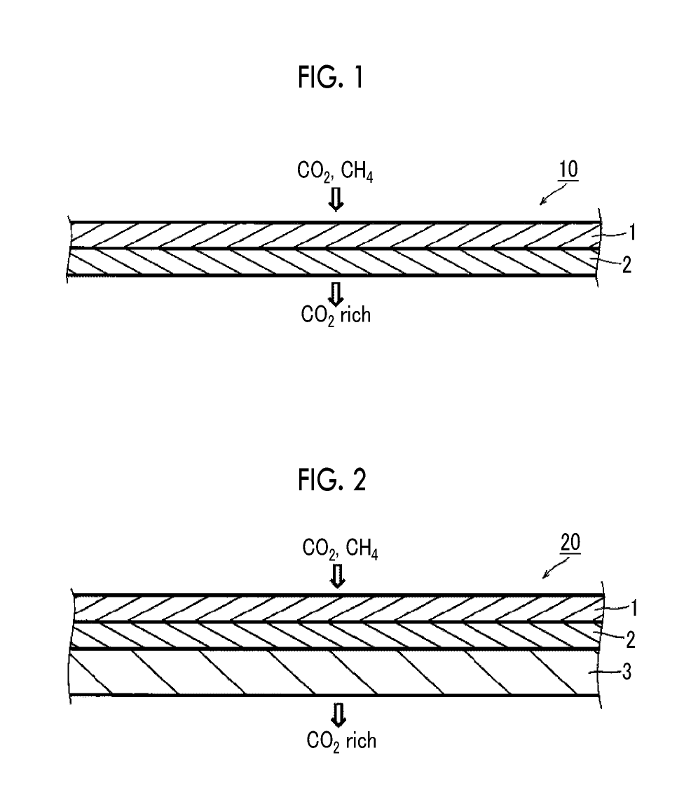

FIG. 1 is a longitudinal cross-sectional view schematically illustrating a gas separation composite membrane 10 which is a preferred embodiment of the present invention. The reference numeral 1 indicates a gas separation layer, and the reference numeral 2 indicates a support layer formed of a porous layer. FIG. 2 is a cross-sectional view schematically illustrating a gas separation composite membrane 20 which is a preferred embodiment of the present invention. In the embodiment, the support layer has a non-woven fabric layer 3 in addition to the gas separation layer 1 and the porous layer 2, and the gas separation composite membrane 20 includes the gas separation layer 1, the porous layer 2, and the non-woven fabric layer 3 in this order.

FIGS. 1 and 2 illustrate the form of making permeating gas to be rich in carbon dioxide by selective permeation of carbon dioxide from mixed gas of carbon dioxide and methane.

The expression “on the support layer” in the present specification means that another layer may be interposed between the support layer and the gas separation layer. Further, in regard to the expressions related to up and down, the side where gas of the gas separation membrane to be separated is supplied is set as “up” and the side where the separated gas is discharged is set as “down” unless otherwise specified.

The gas separation composite membrane of the present invention may be obtained by forming or disposing a gas separation layer on a surface or internal surface of the porous support (support layer) or can be obtained by simply forming a gas separation layer on at least a surface of the porous support to form a composite membrane. By forming a gas separation layer on at least a surface of the porous support, a composite membrane having excellent separation selectivity, excellent gas permeability, and mechanical strength can be obtained. From the viewpoint of the gas permeability, it is preferable that the membrane thickness of the gas separation layer is set to be as small as possible in the range where the mechanical strength and the gas separation selectivity can be maintained at desired levels.

In the gas separation composite membrane of the present invention, the thickness of the gas separation layer is not particularly limited, but is preferably in a range of 0.01 to 5.0 μm and more preferably in a range of 0.05 to 2.0 μm.

The support layer is not particularly limited as long as the mechanical strength and the gas permeability are maintained at desired levels, and either of an organic material or an inorganic material may be used. It is preferable that this support layer is a porous layer containing an organic polymer, and the thickness thereof is preferably in a range of 1 to 3000 μm, more preferably in a range of 5 to 500 μm, and still more preferably in a range of 5 to 150 μm. The pore structure of this porous layer typically has an average pore diameter of preferably 10 μm or less, more preferably 0.5 μm or less, and still more preferably 0.2 μm or less. The porosity is preferably in a range of 20% to 90% and more preferably in a range of 30% to 80%.

Here, the support layer having the “gas permeability” means that the permeation rate of carbon dioxide is 1×10⁵ cm³ (STP)/cm²·sec·cmHg (10 GPU) or greater in a case where carbon dioxide is supplied to the support layer (membrane formed of only the support layer) by setting the temperature to 40° C. and the total pressure on the side to which gas is supplied to 4 MPa. Further, in regard to the gas permeability of the support layer, the permeation rate of carbon dioxide is preferably 3×10⁵ cm³ (STP)/cm²·sec·cmHg (30 GPU) or greater, more preferably 100 GPU or greater, and still more preferably 200 GPU or greater in a case where carbon dioxide is supplied by setting the temperature to 40° C. and the total pressure on the side to which gas is supplied to 4 MPa. Examples of the material of the porous layer include conventionally known polymers, for example, a polyolefin-based resin such as polyethylene or polypropylene; a fluorine-containing resin such as polytetrafluoroethylene, polyvinyl fluoride, or polyvinylidene fluoride; and various resins such as polystyrene, cellulose acetate, polyurethane, polyacrylonitrile, polyphenylene oxide, polysulfone, polyether sulfone, polyimide, and polyaramid. As the shape of the porous layer, any shape from among a flat plate shape, a spiral shape, a tabular shape, and a hollow fiber shape can be employed.

In the gas separation composite membrane of the present invention, it is preferable that a support is formed in the lower portion of the support layer that forms the gas separation layer for imparting mechanical strength. Examples of such a support include woven fabric, non-woven fabric, and a net. Among these, from the viewpoints of membrane forming properties and the cost, non-woven fabric is suitably used. As the non-woven fabric, fibers formed of polyester, polypropylene, polyacrylonitrile, polyethylene, and polyamide may be used alone or in combination of plural kinds thereof. The non-woven fabric can be produced by papermaking main fibers and binder fibers which are uniformly dispersed in water using a circular net or a long net and then drying the fibers with a dryer. Moreover, for the purpose of removing a nap or improving mechanical properties, it is preferable that thermal pressing processing is performed on the non-woven fabric by interposing the non-woven fabric between two rolls.

<Method of Producing Gas Separation Composite Membrane>

As a method of producing the gas separation composite membrane of the present invention, a production method which includes coating a porous support with a coating solution containing the above-described polyimide compound to form a gas separation layer is preferable. The content of the polyimide compound in the coating solution is not particularly limited, but is preferably in a range of 0.1% to 30% by mass and more preferably in a range of 0.5% to 10% by mass. In a case where the content of the polyimide compound is set to be in the above-described range, since the infiltration of the coating solution into the underlayer can be suppressed at the time of formation of the gas separation layer on the porous support, defects are unlikely to occur on the gas separation layer to be formed. Further, since it is possible to prevent holes from being filled with the coating solution at a high concentration at the time of formation of the gas separation layer on the porous support, a gas separation composite membrane having excellent permeability can be obtained. The gas separation membrane according to the embodiment of the present invention can be produced by adjusting the molecular weight, the structure, and the composition of the polymer compound used for formation of the gas separation layer and the viscosity of the solution depending on the intended purpose thereof.

The organic solvent serving as a medium of the coating solution is not particularly limited, and examples thereof include a hydrocarbon-based organic solvent such as n-hexane or n-heptane; an ester-based organic solvent such as methyl acetate, ethyl acetate, or butyl acetate; an alcohol-based organic solvent such as methanol, ethanol, n-propanol, isopropanol, n-butanol, isobutanol, or tert-butanol; an aliphatic ketone such as acetone, methyl ethyl ketone, methyl isobutyl ketone, diacetone alcohol, cyclopentanone, or cyclohexanone; an ether-based organic solvent such as ethylene glycol, diethylene glycol, triethylene glycol, glycerin, propylene glycol, ethylene glycol monomethyl ether, ethylene glycol monoethyl ether, propylene glycol methyl ether, dipropylene glycol methyl ether, tripropylene glycol methyl ether, ethylene glycol phenyl ether, propylene glycol phenyl ether, diethylene glycol monomethyl ether, diethylene glycol monoethyl ether, diethylene glycol monobutyl ether, triethylene glycol monomethyl ether, triethylene glycol monoethyl ether, dibutyl butyl ether, tetrahydrofuran, methyl cyclopentyl ether, or dioxane; and N-methylpyrrolidone, 2-pyrrolidone, dimethylformamide, dimethylimidazolidinone, dimethyl sulfoxide, and dimethyl acetamide. These organic solvents are appropriately selected within the range that does not adversely affect the support through erosion or the like, and an ester-based organic solvent (preferably butyl acetate), an alcohol-based organic solvent (preferably methanol, ethanol, isopropanol, or isobutanol), an aliphatic ketone-based organic solvent (preferably methyl ethyl ketone, methyl isobutyl ketone, diacetone alcohol, cyclopentanone, or cyclohexanone), and an ether-based organic solvent (ethylene glycol, diethylene glycol monomethyl ether, or methyl cyclopentyl ether) are preferable and an aliphatic ketone-based organic solvent, an alcohol-based organic solvent, and an ether-based organic solvent are more preferable. Further, these may be used alone or in combination of two or more kinds thereof.

<Another Layer Between Support Layer and Gas Separation Layer>

In the gas separation composite membrane of the present invention, another layer may be present between the support layer and the gas separation layer. Preferred examples of another layer include a siloxane compound layer. By providing a siloxane compound layer, unevenness of the outermost surface of the support can be made to be smooth and the thickness of the gas separation layer is easily reduced. Examples of a siloxane compound that forms the siloxane compound layer include a compound in which the main chain is formed of polysiloxane and a compound having a siloxane structure and a non-siloxane structure in the main chain.

The “siloxane compound” in the present specification indicates an organopolysiloxane compound unless otherwise noted.

—Siloxane Compound Whose Main Chain is Formed of Polysiloxane—

As the siloxane compound which can be used for the siloxane compound layer and whose main chain is formed of polysiloxane, one or two or more kinds of organopolysiloxanes represented by Formula (1) or (2) may be exemplified. Further, these organopolysiloxanes may form a crosslinking reactant. As the crosslinking reactant, a compound in the form of the compound represented by Formula (1) being cross-linked by a polysiloxane compound having groups linked to each other by reacting with a reactive group X^{S} of Formula (1) at both terminals is exemplified.

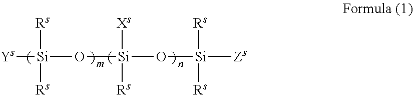

In Formula (1), R^{S} represents a non-reactive group. Specifically, it is preferable that R^{S} represents an alkyl group (an alkyl group having preferably 1 to 18 carbon atoms and more preferably 1 to 12 carbon atoms) or an aryl group (an aryl group having preferably 6 to 15 carbon atoms and more preferably 6 to 12 carbon atoms; and more preferably phenyl).

X^{S} represents a reactive group, and it is preferable that X^{S} represents a group selected from a hydrogen atom, a halogen atom, a vinyl group, a hydroxyl group, and a substituted alkyl group (an alkyl group having preferably 1 to 18 carbon atoms and more preferably 1 to 12 carbon atoms).

Y^{S} and Z^{S} are the same as R^{S} or X^{S} described above.

m represents a number of 1 or greater and preferably 1 to 100000.

n represents a number of 0 or greater and preferably 0 to 100000.

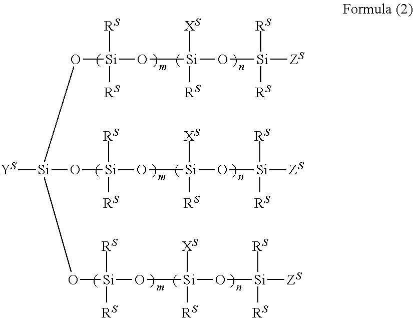

In Formula (2), X^{S}, Y^{S}, Z^{S}, R^{S}, m, and n each have the same definition as that for X^{S}, Y^{S}, Z^{S}, R^{S}, m, and n in Formula (1).

In Formulae (1) and (2), in a case where the non-reactive group R^{S} represents an alkyl group, examples of the alkyl group include methyl, ethyl, hexyl, octyl, decyl, and octadecyl. Further, in a case where the non-reactive group R^{S} represents a fluoroalkyl group, examples of the fluoroalkyl group include —CH₂CH₂CF₃, and —CH₂CH₂C₆F1₃.

In Formulae (1) and (2), in a case where the reactive group X^{S} represents a substituted alkyl group, examples of the alkyl group include a hydroxyalkyl group having 1 to 18 carbon atoms, an aminoalkyl group having 1 to 18 carbon atoms, a carboxyalkyl group having 1 to 18 carbon atoms, a cycloalkyl group having 1 to 18 carbon atoms, a glycidoxyalkyl group having 4 to 18 carbon atoms, a glycidyl group, an epoxycyclohexylalkyl group having 7 to 16 carbon atoms, a (1-oxacyclobutane-3-yl)alkyl group having 1 to 18 carbon atoms, a methacryloxyalkyl group, and a mercaptoalkyl group.

The number of carbon atoms of the alkyl group constituting the hydroxyalkyl group is preferably an integer of 1 to 10, and examples of the hydroxyalkyl group include —CH₂CH₂CH₂OH.

The number of carbon atoms of the alkyl group constituting the aminoalkyl group is preferably an integer of 1 to 10, and examples of the aminoalkyl group include —CH₂CH₂CH₂NH₂.

The number of carbon atoms of the alkyl group constituting the carboxyalkyl group is preferably an integer of 1 to 10, and examples of the carboxyalkyl group include —CH₂CH₂CH₂COOH.

The number of carbon atoms of the alkyl group constituting the chloroalkyl group is preferably an integer of 1 to 10, and preferred examples of the chloroalkyl group include —CH₂Cl.

The number of carbon atoms of the alkyl group constituting the glycidoxyalkyl group is preferably an integer of 1 to 10, and preferred examples of the glycidoxyalkyl group include 3-glycidyloxypropyl.

The number of carbon atoms of the epoxycyclohexylalkyl group having 7 to 16 carbon atoms is preferably an integer of 8 to 12.

The number of carbon atoms of the (1-oxacyclobutane-3-yl)alkyl group having 4 to 18 carbon atoms is preferably an integer of 4 to 10.

The number of carbon atoms of the alkyl group constituting the methacryloxyalkyl group is preferably an integer of 1 to 10, and examples of the methacryloxyalkyl group include —CH₂CH₂CH₂—OOC—C(CH₃)═CH₂.

The number of carbon atoms of the alkyl group constituting the mercaptoalkyl group is preferably an integer of 1 to 10, and examples of the mercaptoalkyl group include —CH₂CH₂CH₂SH.

It is preferable that m and n represent a number in which the molecular weight of the compound is in a range of 5000 to 1000000.

In Formulae (1) and (2), distribution of a reactive group-containing siloxane unit (in the formulae, a constitutional unit whose number is represented by n) and a siloxane unit (in the formulae, a constitutional unit whose number is represented by m) which does not have a reactive group is not particularly limited. That is, in Formulae (1) and (2), the (Si(R^{S})(R^{S})—O) unit and the (Si(R^{S})(X^{S})—O) unit may be randomly distributed.

—Compound Having Siloxane Structure and Non-Siloxane Structure in Main Chain—

Examples of the compound which can be used for the siloxane compound layer and has a siloxane structure and a non-siloxane structure in the main chain include compounds represented by Formulae (3) to (7).

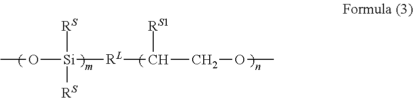

In Formula (3), R^{S}, m, and n each have the same definition as that for R^{S}, m, and n in Formula (1). R^{L} represents —O— or —CH₂— and R^{S1} represents a hydrogen atom or methyl. It is preferable that both terminals of Formula (3) are formed of an amino group, a hydroxyl group, a carboxy group, a trimethylsilyl group, an epoxy group, a vinyl group, a hydrogen atom, or a substituted alkyl group.

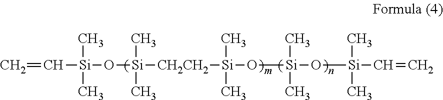

In Formula (4), m and n each have the same definition as that for m and n in Formula (1).

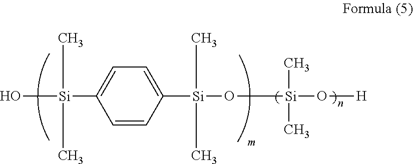

In Formula (5), m and n each have the same definition as that for m and n in Formula (1).

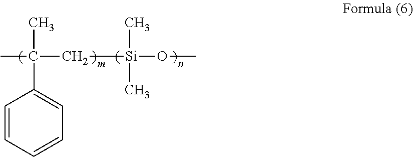

In Formula (6), m and n each have the same definition as that for m and n in Formula (1). It is preferable that both terminals of Formula (6) are bonded to an amino group, a hydroxyl group, a carboxy group, a trimethylsilyl group, an epoxy group, a vinyl group, a hydrogen atom, or a substituted alkyl group.

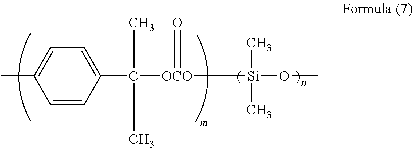

In Formula (7), m and n each have the same definition as that for m and n in Formula (1). It is preferable that both terminals of Formula (7) are bonded to an amino group, a hydroxyl group, a carboxy group, a trimethylsilyl group, an epoxy group, a vinyl group, a hydrogen atom, or a substituted alkyl group.

In Formulae (3) to (7), distribution of a siloxane structural unit and a non-siloxane structural unit may be randomly distributed.

It is preferable that the compound having a siloxane structure and a non-siloxane structure in the main chain contains 50% by mole or greater of the siloxane structural unit and more preferable that the compound contains 70% by mole or greater of the siloxane structural unit with respect to the total molar amount of all repeating structural units.

From the viewpoint of achieving the balance between durability and reduction in membrane thickness, the weight-average molecular weight of the siloxane compound used for the siloxane compound layer is preferably in a range of 5000 to 1000000. The method of measuring the weight-average molecular weight is as described above.

Further, preferred examples of the siloxane compound constituting the siloxane compound layer are as follows.

Preferred examples thereof include one or two or more selected from polydimethylsiloxane, polymethylphenylsiloxane, polydiphenylsiloxane, a polysulfone-polyhydroxystyrene-polydimethyl siloxane copolymer, a dimethylsiloxane-methylvinylsiloxane copolymer, a dimethylsiloxane-diphenylsiloxane-methylvinylsiloxane copolymer, a methyl-3,3,3-trifluoropropylsiloxane-methylvinylsiloxane copolymer, a dimethylsiloxane-methylphenylsiloxane-methylvinylsiloxane copolymer, a vinyl terminated diphenylsiloxane-dimethylsiloxane copolymer, vinyl terminated polydimethylsiloxane, H terminated polydimethylsiloxane, and a dimethylsiloxane-methylhydroxysiloxane copolymer. Further, these compounds include the forms of forming crosslinking reactants.

In the gas separation composite membrane of the present invention, from the viewpoints of smoothness and gas permeability, the thickness of the siloxane compound layer is preferably in a range of 0.01 to 5 μm and more preferably in a range of 0.05 to 1 μm.

Further, the gas permeability of the siloxane compound layer at 40° C. and 4 MPa is preferably 100 GPU or greater, more preferably 300 GPU or greater, and still more preferably 1000 GPU or greater in terms of the permeation rate of carbon dioxide.

(Gas Separation Asymmetric Membrane)

The gas separation membrane according to the embodiment of the present invention may be an asymmetric membrane. The asymmetric membrane can be formed according to a phase inversion method using a solution containing a polyimide compound. The phase inversion method is a known method of allowing a polymer solution to be brought into contact with a coagulating liquid for phase inversion to form a membrane, and a so-called dry-wet method is suitably used in the present invention. The dry-wet method is a method of forming a porous layer by evaporating a solution on the surface of a polymer solution which is made to have a membrane shape to form a thin compact layer, immersing the compact layer in a coagulating liquid, and forming fine pores using a phase separation phenomenon that occurs at this time, and this method is suggested by Loeb and Sourirajan (for example, the specification of U.S. Pat. No. 3,133,132A). Further, the coagulating liquid is a solvent which is compatible with a solvent of a polymer solution and in which a polymer is insoluble.

In the gas separation asymmetric membrane of the present invention, the thickness of the surface layer contributing to gas separation, which is referred to as a compact layer or a skin layer, is not particularly limited, but is preferably in a range of 0.01 to 5.0 μm and more preferably in a range of 0.05 to 1.0 μm from the viewpoint of imparting practical gas permeability. In addition, the porous layer positioned in the lower portion of the compact layer plays a role of decreasing gas permeability resistance and imparting the mechanical strength at the same time, and the thickness thereof is not particularly limited as long as self-supporting properties as an asymmetric membrane are imparted. The thickness of the lower portion porous layer in the asymmetric membrane is preferably in a range of 5 to 500 μm, more preferably in a range of 5 to 200 μm, and still more preferably in a range of 5 to 100 μm.

The gas separation asymmetric membrane of the present invention may be a flat membrane or a hollow fiber membrane. An asymmetric hollow fiber membrane can be produced by a dry-wet spinning method. The dry-wet spinning method is a method of producing an asymmetric hollow fiber membrane by applying a dry-wet method to a polymer solution which is discharged from a spinning nozzle in a target shape which is a hollow fiber shape. More specifically, a polymer solution is discharged from a nozzle in a target shape which is a hollow fiber shape, and passes through air or a nitrogen gas atmosphere immediately after the discharge. Thereafter, an asymmetric structure is formed through immersion in a coagulating liquid which does not substantially dissolve a polymer and has compatibility with a solvent of a polymer solution. Next, a separation membrane is produced by performing drying and carrying out a heat treatment as necessary.

The solution viscosity of the solution containing a polyimide compound which is discharged from a nozzle is preferable in a range of 2 to 17000 Pa·s, more preferably 10 to 1500 Pa·s, and particularly preferably in a range of 20 to 1000 Pa·s at the discharge temperature (for example, 10° C.) from a viewpoint of stably obtaining the shape after the discharge such as a hollow fiber shape or the like. It is preferable that immersion of a membrane in a coagulating liquid is carried out by immersing the membrane in a primary coagulating liquid to be solidified to the extent that the shape of a membrane such as a hollow fiber shape can be maintained, winding the membrane around a guide roll, immersing the membrane in a secondary coagulating liquid, and sufficiently solidifying the whole membrane. It is effective that the solidified membrane is dried after the coagulating liquid is substituted with a solvent such as hydrocarbon. It is preferable that the heat treatment for drying the membrane is performed at a temperature lower than the softening point or the secondary transition point of the used polyimide compound.

<Protective Layer>

The gas separation membrane according to the embodiment of the present invention may be provided with a siloxane compound layer on the gas separation layer as a protective layer.

It is preferable that the Si ratio of the siloxane compound layer used as a protective layer before and after being immersed in chloroform represented by Equation (I) is in a range of 0.6 to 1.0.

Si ratio=(Si-Kα X-ray intensity after immersion in chloroform)/(Si-Kα X-ray intensity before immersion in chloroform) Equation (I)

The Si ratio is calculated by immersing the siloxane compound layer in chloroform at 25° C. for 12 hours, irradiating the surface of the siloxane compound layer with X-rays before and after the immersion, and measuring the intensity of a peak (2 θ=144.6 deg) of the Si-Kα X-ray (1.74 keV). The method of measuring the Si-Kα X-ray intensity is described in JP1994-088792A (JP-H06-088792A). In a case where the Si-Kα X-ray intensity is decreased due to the immersion of the siloxane compound layer in chloroform compared to the Si-Kα X-ray intensity before the immersion, this means that low-molecular weight components are present and these low-molecular weight components are eluted. Therefore, this means that a polymer constituting the siloxane compound layer is more polymerized and thus unlikely to be eluted in chloroform as the degree of a decrease in Si-Kα X-ray intensity is smaller after the immersion of the siloxane compound layer in chloroform.

In a case where the Si ratio of the siloxane compound layer is in a range of 0.6 to 1.0, the siloxane compound can be allowed to be homogeneously present in the layer with a high density, membrane defects can be effectively prevented, and the gas separation performance can be more improved. Further, the gas separation layer can be used under conditions of a high temperature, a high pressure, and a high humidity and the plasticization of the gas separation layer due to the impurity components such as toluene can be suppressed.

The Si ratio of the siloxane compound layer constituting a protective layer is preferably in a range of 0.7 to 1.0, more preferably in a range of 0.75 to 1.0, still more preferably in a range of 0.8 to 1.0, and even still more preferably in a range of 0.85 to 1.0.

It is preferable that the siloxane compound layer constituting a protective layer has a structure formed by siloxane compounds being linked to each other through a linking group selected from *—O-M-O—*, *—S-M-S—*, *—NR^{a1}C(═O)—*,*—NR^{b1}C(═O)NR^{b1}—*, *—O—CH₂—O—*, *—S—CH₂CH₂—*, *—OC(═O)O—*, *—CH(OH)CH₂CO—*, *—CH(OH)CH₂O—*, *—CH(OH)CH₂S—*, *—CH(OH)CH₂NR^{c1}—*, *—CH(CH₂OH)CH₂OCO—*, *—CH(CH₂OH)CH₂O—*, *—CH(CH₂OH)CH₂S—*, *—CH(CH₂OH)CH₂N(R^{c1})₂—, *—CH₂CH₂—, *—C(═O)O⁻N⁺(R^{d1})₃—*, *—SO₃N+(R^{e1})₃—*, and *—PO₃⁻N⁺(R^{f1})₃—*

In the formulae, M represents a divalent to tetravalent metal atom. R^{a1}, R^{b1}, R^{c1}, R^{d1}, R^{e1}, and R^{f1} each independently represent a hydrogen atom or an alkyl group. The symbol * represents a linking site.

As the metal atom M, metal atoms selected from aluminum (Al), iron (Fe), beryllium (Be), gallium (Ga), vanadium (V), indium (In), titanium (Ti), zirconium (Zr), copper (Cu), cobalt (Co), nickel (Ni), zinc (Zn), calcium (Ca), magnesium (Mg), yttrium (Y), scandium (Sc), chromium (Cr), manganese (Mn), molybdenum (Mo), and boron (B) may be exemplified. Among these, metal atoms selected from Ti, In, Zr, Fe, Zn, Al, Ga, and B are preferable, metal atoms selected from Ti, In, and Al are more preferable, and Al is still more preferable.

The number of carbon atoms of the alkyl group which can be employed as R^{a1}, R^{b1}, R^{c1}, R^{d1}, R^{e1}, and R^{f1} is preferably in a range of 1 to 20, more preferably in a range of 1 to 10, still more preferably in a range of 1 to 7, and even still more preferably in a range of 1 to 4. The alkyl group may be linear or branched, but is more preferably linear. Specific preferred examples of the alkyl group include methyl, ethyl, isopropyl, n-butyl, t-butyl, pentyl, hexyl, heptyl, octyl, and 1-ethylpentyl.

In a case where the siloxane compound layer has the structure in which siloxane compounds are linked to each other through the linking group, the Si ratio of the siloxane compound layer is easily increased so as to be in the range defined by the present invention.

The reaction of linking the siloxane compounds to each other through the linking group is described below.

<*—O-M-O—*>

The linking group *—O-M-O—* can be formed by a ligand exchange reaction between a siloxane compound having a —OH group (active hydrogen-containing group) such as a hydroxy group, a carboxy group, or a sulfo group and a metal complex (crosslinking agent) represented by Formula (B).

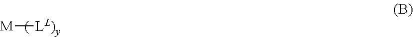

In the formula, M has the same definition as that for the metal atom M and the preferable forms are the same as each other. L^{L}'s each independently represent an alkoxy group, an aryloxy group, an acetylacetonate group, an acyloxy group, a hydroxy group, or a halogen atom. y represents an integer of 2 to 4.

The number of carbon atoms of the alkoxy group as L^{L} is preferably in a range of 1 to 10, more preferably in a range of 1 to 4, and still more preferably in a range of 1 to 3. Specific examples of the alkoxy group as L^{L} include methoxy, ethoxy, tert-butoxy, and isopropoxy.

The number of carbon atoms of the aryloxy group as L^{L} is preferably in a range of 6 to 10, more preferably in a range of 6 to 8, and still more preferably 6 to 7. Specific examples of the aryloxy group as L^{L} include phenoxy, 4-methoxyphenoxy, and naphthoxy.

The number of carbon atoms of the acyloxy group as L^{L} is preferably in a range of 2 to 10, more preferably in a range of 2 to 6, and still more preferably in a range of 2 to 4. Specific examples of the acyloxy group as L^{L} include acetoxy, propanoyloxy, pivaloyloxy, and acetyloxy.

The halogen atom as L^{L} is not particularly limited and examples thereof include a fluorine atom, a chlorine atom, a bromine atom, and an iodine atom. Among these, a chlorine atom is preferable.

It is preferable that the metal complex represented by Formula (B) is soluble in the organic solvent used for the coating solution in a case where the siloxane compound layer is formed. More specifically, the solubility of the metal complex represented by Formula (B) in 100 g of tetrahydrofuran at 25° C. is preferably 0.01 to 10 g and more preferably 0.1 to 1.0 g. In a case where the metal complex represented by Formula (B) is soluble in the organic solvent, a more homogeneous metal crosslinked siloxane compound layer can be formed.

Specific preferred examples of the metal complex represented by Formula (B) include metal complexes selected from aluminum acetylacetonate, gallium acetylacetonate, indium acetylacetonate, zirconium acetylacetonate, cobalt acetylacetonate, calcium acetylacetonate, nickel acetylacetonate, zinc acetylacetonate, magnesium acetylacetonate, ferric chloride, copper (II) acetate, aluminum isopropoxide, titanium isopropoxide, boric acid, and a boron trifluoride-diethyl ether complex.

An example of the ligand exchange reaction is shown as follows. Further, the following example shows a case where a siloxane compound contains a hydroxy group, but the same ligand exchange reaction proceeds and a linking group represented by *—O-M-O—* is formed in a case where a siloxane compound contains an active hydrogen-containing group such as a carboxy group or a sulfo group.

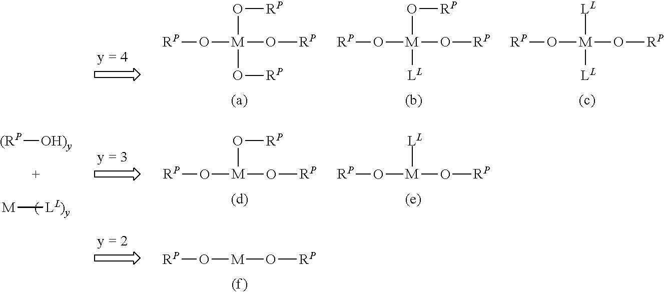

In the formulae, R^{P} represents a siloxane compound residue (that is, R^{P}—OH represents a siloxane compound having a hydroxy group).

In a case where M represents a tetravalent metal atom (y=4), up to 4 (R^{P}—OH)'s can be usually coordinated with respect to one M (the form of (a) shown above). In the present invention, in a case where M represents a tetravalent metal atom, all of a form in which 2 (R^{P}—OH)'s are coordinated (the form of (c) shown above), a form in which 3 (R^{P}—OH)'s are coordinated (the form of (b) shown above), and a form in which 4 (R^{P}—OH)'s are coordinated (the form of (a) shown above) are included in the form having a linking group represented by *—O-M-O—*.

Further, although not shown in the formulae above, in a case where the siloxane compound R^{P}—OH is represented by R^{P1}—(OH)ₕ (in a case where R^{P1} represents a siloxane compound residue and h represents an integer of 2 or greater, that is, two or more hydroxy groups are included in one molecule), two or more OH's which are present in one molecule of R^{P1}—(OH)ₕ may be coordinated with one M. This form is also included in the form having a linking group represented by *—O-M-O—*.

In a case where M represents a trivalent metal atom (y=3), up to 3 (R^{P}—OH)'s can be usually coordinated with respect to one M (the form of (d) shown above). In the present invention, in a case where M represents a trivalent metal atom, all of a form in which 2 (R^{P}—OH)'s are coordinated (the form of (e) shown above) and a form in which 3 (R^{P}—OH)'s are coordinated (the form of (d) shown above) are set to be included in the form having a linking group represented by *—O-M-O—*.

Further, although not shown in the formulae above, in a case where the siloxane compound R^{P}—OH is represented by R^{P1}—(OH)ₕ (in a case where R^{P1} represents a siloxane compound residue and h represents an integer of 2 or greater, that is, two or more hydroxy groups are included in one molecule), two or more OH's which are present in one molecule of R^{P1}—(OH)ₕ may be coordinated with one M. This form is also set to be included in the form having a linking group represented by *—O-M-O—*.

In a case where M represents a divalent metal atom (y=2), the form of (f) shown above is the form having a linking group represented by *—O-M-O—* which is defined by the present invention.

Further, although not shown in the formulae above, in a case where the siloxane compound R^{P}—OH is represented by R^{P1}—(OH)ₕ (in a case where R^{P1} represents a siloxane compound residue and h represents an integer of 2 or greater, that is, two or more hydroxy groups are included in one molecule), two or more OH's which are present in one molecule of R^{P1}—(OH)ₕ may be coordinated with one M. This form is also included in the form having a linking group represented by *—O-M-O—*.

<*—S-M-S—*>

The linked structure “*—S-M-S—* can be formed by a ligand exchange reaction between a siloxane compound having a thiol group and a metal complex represented by Formula (B). This reaction is obtained by replacing R^{P}—OH with R^{P}—SH in the reaction for forming *—O-M-O—* described above. Since —SH is an active hydrogen-containing group, a ligand exchange reaction can be performed as described above.

<*—NR^{a}C(═O)—*>

The linking group *—NR^{a}C(═O)—* can be formed by reacting a siloxane compound containing a carboxy group with a siloxane compound containing an amino group in the presence of a dehydration condensation agent (for example, a carbodiimide compound). This reaction can be represented by the following formula.

R^{P}—COOH+R^{P}—N(R^{a})₂

=>R^{P}—C(═O)—NR^{a}—R^{P}+H₂O

In the formula, R^{P} represents a siloxane compound residue. One of two R^{a}'s linked to one N atom on the left side represents a hydrogen atom and the rest represents a hydrogen atom or an alkyl group. In other words, R^{a} on the right side represents a hydrogen atom or an alkyl group.

Further, the linking group can be formed by reacting a siloxane compound containing a carboxy group with a compound containing two or more amino groups serving as a crosslinking agent. Further, the linking group can be formed even by reacting a siloxane compound containing an amino group with a compound containing two or more carboxy groups serving as a crosslinking agent.

<*—NR^{b1}C(═O)NR^{b1}—*

The linking group *—NR^{b1}C(═O)NR^{b1}—* can be formed by reacting, for example, a siloxane compound containing an amino group with chloroformate serving as a crosslinking agent. The reaction can be represented by the following formula.

2R^{P}—N(R^{b1})₂+Cl-C(═O)—O—R^{C1}

=>R^{P}—R^{b1}N—C(═O)—NR^{b1}—R^{P}+HCl+HO—R^{C1}

In the formula, R^{P} represents a siloxane compound residue and R^{C1} represents an alcohol residue of chloroformate. One of two R^{b1}'s linked to one N atom on the left side represents a hydrogen atom and the rest represents a hydrogen atom or an alkyl group (that is, R^{b1} on the right side represents a hydrogen atom or an alkyl group).

<*—O—CH₂—O—*>

The linking group *—O—CH₂—O—* can be formed by reacting, for example, a siloxane compound containing a hydroxy group with formaldehyde serving as a crosslinking agent. The reaction can be represented by the following formula.

2R^{P}—OH+H—C(═O)—H

=>R^{P}—O—CH(O—R^{P})—H+H₂O

In the formula, R^{P} represents a siloxane compound residue.

<*—S—CH₂CH₂—*>

The linking group *—S—CH₂CH₂—* can be formed by reacting, for example, a siloxane compound containing a thiol group with a siloxane compound containing a vinyl group. The reaction can be represented by the following formula.

R^{P}—SH+R^{P}—CH═CH₂

=>R^{P}—S—CH₂—CH₂—R^{P}

In the formula, R^{P} represents a siloxane compound residue.

Further, the linking group can be formed even by reacting a siloxane compound containing a thiol group with a compound containing two or more vinyl groups serving as a crosslinking agent. Further, the linking group can be formed even by reacting a siloxane compound containing a vinyl group with a compound containing two or more thiol groups serving as a crosslinking agent.

<*—OC(═O)O—*>

The linking group *—OC(═O)O—* can be formed by reacting, for example, a siloxane compound containing a hydroxy group with chloroformate serving as a crosslinking agent. The reaction can be represented by the following formula.

2R^{P}—OH+Cl-C(═O)—O—R^{C1}

=>R^{P}—O—C(═O)—O—R^{P}+HCl+HO—R^{C1}

In the formula, R^{P} represents a siloxane compound residue and R^{C1} represents an alcohol residue of chloroformate.

<*—C(═O)O⁻N⁺(R^{d1})₃—*>

The linking group *—C(═O)O⁻N⁺(R^{d1})₃—* can be formed by reacting, for example, a siloxane compound containing a carboxy group with a siloxane compound containing an amino group. The reaction can be represented by the following formula.

R^{P}—COOH+R^{P}—N(R^{d1})₂

=>R^{P}—CO—O⁻—N⁺H(R^{d1})₂—R^{P}

In the formula, R^{P} represents a siloxane compound residue. R^{d1} represents a hydrogen atom or an alkyl group.

Further, the linked structure can be formed even by reacting a siloxane compound containing a carboxy group with a compound containing two or more amino groups serving as a crosslinking agent. Further, the linking group can be formed even by reacting a siloxane compound containing an amino group with a compound containing two or more carboxy groups serving as a crosslinking agent.

<*—SO₃N+(R^{e1})₃—*>

The linking group *—SO₃N+(R^{e1})₃—* can be formed by reacting, for example, a siloxane compound containing a sulfo group with a siloxane compound containing an amino group. The reaction can be represented by the following formula.

R^{P}—SO₃H+R^{P}—N(R^{e1})₂

=>R^{P}—SO₂—O⁻—N⁺H(R^{e1})₂—R^{P}

In the formula, R^{P} represents a siloxane compound residue. R^{e1} represents a hydrogen atom or an alkyl group.

Further, the linking group can be formed even by reacting a siloxane compound containing a sulfo group with a compound containing two or more amino groups serving as a crosslinking agent. Further, the linking group can be formed even by reacting a siloxane compound containing an amino group with a compound containing two or more sulfo groups serving as a crosslinking agent.

<*—PO₃H⁻N⁺(R^{f1})₃—*>

The linked structure *—PO₃H⁻N+(R^{f1})₃—* can be formed by reacting, for example, a cellulose resin containing a phosphonic acid group with a siloxane compound containing an amino group. The reaction can be represented by the following formula.

R^{P}—PO₃H₂+R^{P}—N(R^{f1})₂

=>R^{P}—P(═O)(OH)—O⁻—N⁺H(R^{f1})₂—R^{P}

In the formula, R^{P} represents a siloxane residue. R^{f1} represents a hydrogen atom or an alkyl group.

Further, the linking group can be formed even by reacting a siloxane compound containing a phosphonic acid group with a compound containing two or more amino groups serving as a crosslinking agent. Further, the linking group can be formed even by reacting a siloxane compound containing an amino group with a compound containing two or more sulfonic acid groups serving as a crosslinking agent.

<*—CH(OH)CH₂OCO—*>

The linking group *—CH(OH)CH₂CO—* can be formed by reacting, for example, a siloxane compound containing an epoxy group with a siloxane compound containing a carboxy group.

Further, the linking group can be formed even by reacting a siloxane compound containing an epoxy group with a compound containing two or more carboxy groups serving as a crosslinking agent or by reacting a siloxane compound containing a carboxy group with a compound containing two or more epoxy groups serving as a crosslinking agent.

<*—CH(OH)CH₂O—*>

The linking group *—CH(OH)CH₂O—* can be formed by reacting, for example, a siloxane compound containing an epoxy group with a siloxane compound containing a hydroxy group.

Further, the linking group can be formed even by reacting a siloxane compound containing an epoxy group with a compound containing two or more hydroxy groups serving as a crosslinking agent or by reacting a siloxane compound containing a hydroxy group with a compound containing two or more epoxy groups serving as a crosslinking agent.

<*—CH(OH)CH₂S—*>

The linking group *—CH(OH)CH₂S—* can be formed by reacting, for example, a siloxane compound containing an epoxy group with a siloxane compound containing a thiol group.

Further, the linking group can be formed even by reacting a siloxane compound containing an epoxy group with a compound containing two or more thiol groups serving as a crosslinking agent or by reacting a siloxane compound containing a thiol group with a compound containing two or more epoxy groups serving as a crosslinking agent.

<*—CH(OH)CH₂NR^{c1}—*

The linking group *—CH(OH)CH₂NR^{c1}—* can be formed by reacting, for example, a siloxane compound containing an epoxy group with a siloxane compound containing an amino group.

Further, the linking group can be formed even by reacting a siloxane compound containing an epoxy group with a compound containing two or more amino groups serving as a crosslinking agent or by reacting a siloxane compound containing an amino group with a compound containing two or more epoxy groups serving as a crosslinking agent.

<*—CH(CH₂OH)CH₂OCO—*>

The linking group *—CH(CH₂OH)CH₂CO—* can be formed by replacing an epoxy group with an oxetanyl group in the formation of *—CH(OH)CH₂CO—* described above.

<*—CH(CH₂OH)CH₂O—*>

The linking group *—CH(CH₂OH)CH₂O—* can be formed by replacing an epoxy group with an oxetanyl group in the formation of *—CH(OH)CH₂O—* described above.

<*—CH(CH₂OH)CH₂S—*>

The linking group *—CH(CH₂OH)CH₂S—* can be formed by replacing an epoxy group with an oxetanyl group in the formation of *—CH(OH)CH₂S—* described above.

<*—CH(CH₂OH)CH₂NR^{c1}*>

The linking group *—CH(CH₂OH)CH₂NR^{c1}—* can be formed by replacing an epoxy group with an oxetanyl group in the formation of *—CH(OH)CH₂NR^{c}—* described above.

<*—CH₂CH₂—*

The linking group *—CH₂CH₂—* can be formed by, for example, performing a polymerization reaction on siloxane compounds containing a vinyl group (a (meth)acryloyl group or the like). The linking group can also be formed by reacting a vinyl group of a siloxane compound containing a vinyl group with a hydrosilyl group of a siloxane compound containing a hydrosilyl group.

In the present invention, structures linked through *—CH₂CH₂—* do not include structures linked through *—S—CH₂CH₂—*.

The siloxane compound layer constituting a protective layer may include one or two or more linked structures.

As the linked structure of siloxane compounds in the siloxane compound layer constituting a protective layer, from the viewpoints of the reactivity for forming the linked structure and chemical stability of the linked structure, one or two or more structures linked through a linking group selected from *—O-M-O—*, *—S-M-S—*, *—O—CH₂—O—*, *—S—CH₂CH₂—*, *—OC(═O)O—*, *—CH₂CH₂—, and *—C(═O)O—N+(R^{d1})₃—* are preferable, one or two or more structures linked through a linking group selected from *—O-M-O—*, *—S-M-S—*, *—O—CH₂—O—*, *—S—CH₂CH₂—*, and *—CH₂CH₂—* are more preferable, and one or two structures linked through a linking group selected from *—O-M-O—* and *—CH₂CH₂—* are still more preferable.

The siloxane compound (the siloxane compound before a linked structure is formed through the linking group) that is used as a raw material of the siloxane compound layer is not particularly limited as long as the siloxane compound has a functional group imparting the linked structure. Preferred examples of this siloxane compound include one or two or more compounds selected from methacrylate-modified polydialkylsiloxane, methacrylate-modified polydiarylsiloxane, methacrylate-modified polyalkylarylsiloxane, thiol-modified polydialkylsiloxane, thiol-modified polydiarylsiloxane, thiol-modified polyalkylarylsiloxane, hydroxy-modified polydialkylsiloxane, hydroxy-modified polydiarylsiloxane, hydroxy-modified polyalkylarylsiloxane, amine-modified polydialkylsiloxane, amine-modified polydiarylsiloxane, amine-modified polyalkylarylsiloxane, vinyl-modified polydialkylsiloxane, vinyl-modified polydiarylsiloxane, vinyl-modified polyalkylarylsiloxane, carboxy-modified polydialkylsiloxane, carboxy-modified polydiarylsiloxane, carboxy-modified polyalkylarylsiloxane, hydrosilyl-modified polydialkylsiloxane, hydrosilyl-modified polydiarylsiloxane, hydrosilyl-modified polyalkylarylsiloxane, epoxy-modified polydialkylsiloxane, epoxy-modified polydiarylsiloxane, epoxy-modified polyalkylarylsiloxane, oxetanyl-modified polydialkylsiloxane, oxetanyl-modified polydiarylsiloxane, and oxetanyl-modified polyalkylarylsiloxane.

Further, in the polysiloxane compound exemplified above, the modified site due to each functional group may be a terminal or a side chain. In addition, it is preferable that two or more modified sites are present in one molecule. Further, each functional group introduced due to the modification may further include a substituent.

The ratio between the amount of the alkyl group and the amount of the aryl group in the above-described “polyalkylarylsiloxane” is not particularly limited. In other words, the structure of the “polyalkylarylsiloxane” may have a dialkylsiloxane structure or a diarylsiloxane structure.

In the siloxane compound exemplified above, the number of carbon atoms of the alkyl group is preferably in a range of 1 to 10, more preferably in a range of 1 to 5, and still more preferably in a range of 1 to 3. In addition, methyl is even still more preferable. Further, in the siloxane compound exemplified above, the number of carbon atoms of the aryl group is preferably in a range of 6 to 20, more preferably in a range of 6 to 15, and still more preferably in a range of 6 to 12. In addition, phenyl is even still more preferable.

It is preferable that the siloxane compound layer constituting a protective layer has at least one structure selected from (a) and (b) described below.

(a) A structure which has a structure represented by Formula (1a) and a structure represented by Formula (2a) or (3a)

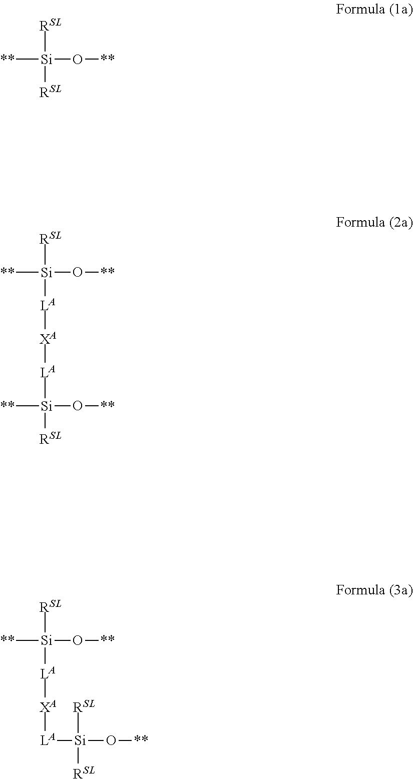

(b) A structure represented by Formula (4a)

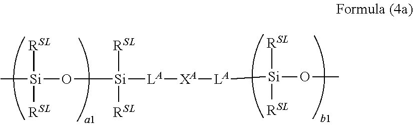

In the formulae, R^{SL}'s each independently represent an alkyl group or an aryl group. L^{A}'s each independently represent a single bond or a divalent linking group. X^{A} represents a linking group selected from *—O-M¹-O—*, *—S-M¹-S—*, *—O—CH₂—O—*, *—S—CH₂CH₂—*, *—OC(═O)O—*, *—CH₂CH₂—*, and *—C(═O)O⁻N⁺(R^{d})₃—*. M¹ represents Zr, Fe, Zn, B, Al, or Ga, R^{d} represents a hydrogen atom or an alkyl group. a1 and b1 represent an integer of 2 or greater (preferably an integer of 5 or greater). The symbol * represents a linking site. The symbol ** represents a linking site in a siloxane bond (that is, in Formulae (1a) to (3a), the symbol ** represents a linking site with respect to a Si atom in a case where an O atom is present next to the symbol ** and the symbol ** represents a linking site with respect to an O atom in a case where a Si atom is present next to the symbol **).

In addition, it is preferable that the terminal structure of Formula (4a) is a group selected from a hydrogen atom, a mercapto group, an amino group, a vinyl group, a carboxy group, an oxetanyl group, a sulfo group, and a phosphonic acid group.

In a case where R^{SL} and R^{d} represent an alkyl group, the number of carbon atoms thereof is preferably in a range of 1 to 10, more preferably in a range of 1 to 5, and still more preferably in a range of 1 to 3, and methyl is even still more preferable.

In a case where R^{SL} represents an aryl group, the number of carbon atoms thereof is preferably in a range of 6 to 20, more preferably in a range of 6 to 15, and still more preferably in a range of 6 to 12, and a phenyl group is particularly preferable.

In a case where L^{A} represents a divalent linking group, an alkylene group (an alkylene group having preferably 1 to 10 carbon atoms and more preferably 1 to 5 carbon atoms), an arylene group (an arylene group having preferably 6 to 20 carbon atoms and more preferably 6 to 15 carbon atoms, and still more preferably a phenylene group), or —Si(R^{SL})₂—O— is preferable (R^{SL} has the same definition as that for R^{SL} of Formula (2a) and the preferable forms are the same as each other, and “O” in —Si(R^{SL})₂—O— is linked to Si shown in the formula above).

It is preferable that the structure of (a) described above has a repeating unit represented by Formula (5a) in addition to the structure represented by any of Formulae (1a) to (3a).

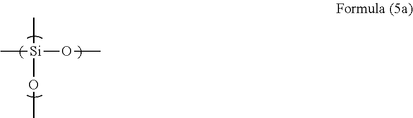

It is also preferable that the repeating unit represented by Formula (5a) has a structure in which repeating units represented by Formula (5a) are linked to each other through a siloxane bond in the siloxane compound layer.

In the siloxane compound layer constituting a protective layer, the content of the repeating unit represented by Formula (5a) is preferably in a range of 0.01 to 0.55, more preferably in a range of 0.03 to 0.40, and still more preferably in a range of 0.05 to 0.25.

The content of the repeating unit represented by Formula (5a) is acquired by setting a siloxane compound layer cut to have a size of 2.5 cm2 as a sample for measurement, measuring the Si2p (around 98 to 104 eV) of this sample for measurement under conditions of Al-Kα rays (1490 eV, 25 W, 100 umϕ) as an X-ray source, a measurement region of 300 μm×300 μm, Pass Energy 55 eV, and Step 0.05 eV using X-ray photoelectron spectroscopy (device: Quantra SXM, manufactured by Ulvac-PHI, Inc.), separating and quantifying the peaks of the T component (103 eV) and the Q component (104 eV), and comparing the results. In other words, “[SA]/([SA]+[ST])” is calculated based on the total value [ST] of the fluorescent X-ray intensity [SA] of the Si—O bond energy peak of the repeating unit (Q component) represented by Formula (5a) and the intensity of the Si—O bond energy peak of the structure (T component) other than the repeating unit represented by Formula (5a) and the calculated value is set as the content of the repeating unit represented by Formula (5a).

In the present invention, the thickness of the siloxane compound layer serving as a protective layer is preferably in a range of 10 to 3000 nm and more preferably in a range of 100 to 1500 nm.

(Use and Properties of Gas Separation Membrane)

The gas separation membrane (the composite membrane and the asymmetric membrane) according to the embodiment of the present invention can be suitably used according to a gas separation recovery method and a gas separation purification method. For example, a gas separation membrane which is capable of efficiently separating specific gas from a gas mixture containing gas, for example, hydrocarbon such as hydrogen, helium, carbon monoxide, carbon dioxide, hydrogen sulfide, oxygen, nitrogen, ammonia, a sulfur oxide, a nitrogen oxide, methane, ethane, or butane; unsaturated hydrocarbon such as propylene; or a perfluoro compound such as tetrafluoroethane can be obtained. Particularly, it is preferable that a gas separation membrane causing carbon dioxide to selectively permeate and separating the carbon dioxide from a gas mixture containing carbon dioxide and hydrocarbon (methane) is obtained.

In addition, in a case where gas subjected to a separation treatment is mixed gas of carbon dioxide and methane, the permeation rate of the carbon dioxide at 40° C. and 5 MPa is preferably 20 GPU or greater, more preferably 30 GPU or greater, and still more preferably in a range of 35 GPU to 500 GPU. The ratio R_{CO2}/R_{CH4} of the permeation rate of carbon dioxide with respect to a permeation rate of methane is preferably 15 or greater, more preferably 20 or greater, still more preferably 23 or greater, and particularly preferably in a range of 25 to 50. R_{CO2} represents the permeation rate of carbon dioxide and R_{CH4} represents the permeation rate of methane.

Further, 1 GPU is 1×10⁻⁶ cm³ (STP)/cm²·cm·sec·cmHg, STP stands for Standard Temperature and Pressure, and GPU stands for Gas Permeation Unit.

(Other Components and the Like)

Various polymer compounds can also be added to the gas separation layer of the gas separation membrane according to the embodiment of the present invention in order to adjust the physical properties of the membrane. As the polymer compounds, an acrylic polymer, a polyurethane resin, a polyamide resin, a polyester resin, an epoxy resin, a phenol resin, a polycarbonate resin, a polyvinyl butyral resin, a polyvinyl formal resin, shellac, a vinyl-based resin, an acrylic resin, a rubber-based resin, waxes, and other natural resins can be used. Further, these may be used in combination of two or more kinds thereof.

Further, a non-ionic surfactant, a cationic surfactant, or an organic fluoro compound can be added to the gas separation membrane of the present invention in order to adjust the physical properties of the liquid.

Specific examples of the surfactant include anionic surfactants such as alkyl benzene sulfonate, alkyl naphthalene sulfonate, higher fatty acid salts, sulfonate of higher fatty acid ester, sulfuric ester salts of higher alcohol ether, sulfonate of higher alcohol ether, alkyl carboxylate of higher alkyl sulfonamide, and alkyl phosphate; non-ionic surfactants such as polyoxyethylene alkyl ether, polyoxyethylene alkyl phenyl ether, polyoxyethylene fatty acid ester, sorbitan fatty acid ester, an ethylene oxide adduct of acetylene glycol, an ethylene oxide adduct of glycerin, and polyoxyethylene sorbitan fatty acid ester; and amphoteric surfactants such as alkyl betaine and amide betaine; a silicon-based surfactant; and a fluorine-based surfactant, and the surfactant can be suitably selected from known surfactants and derivatives thereof in the related art.

Further, a polymer dispersant may be included, and specific examples of the polymer dispersant include polyvinyl pyrrolidone, polyvinyl alcohol, polyvinyl methyl ether, polyethylene oxide, polyethylene glycol, polypropylene glycol, and polyacrylamide. Among these, polyvinyl pyrrolidone is preferably used.

The conditions of forming the gas separation membrane according to the embodiment of the present invention are not particularly limited. The temperature thereof is preferably in a range of −30° C. to 100° C., more preferably in a range of −10° C. to 80° C., and particularly preferably in a range of 5° C. to 50° C.

In the present invention, gas such as air or oxygen may be allowed to coexist during membrane formation, but it is desired that the membrane is formed under an inert gas atmosphere.

In the gas separation membrane according to the embodiment of the present invention, the content of the polyimide compound in the gas separation layer is not particularly limited as long as desired gas separation performance can be obtained. From the viewpoint of further improving gas separation performance, the content of the polyimide compound in the gas separation layer is preferably 20% by mass or greater, more preferably 40% by mass or greater, still more preferably 60% by mass or greater, and even still more preferably 70% by mass or greater. Further, the content of the polyimide compound in the gas separation layer may be 100% by mass, but is typically 99% by mass or less.

[Method of Separating Gas Mixture]

The gas separation method according to the embodiment of the present invention is a method that includes causing carbon dioxide to selectively permeate from mixed gas containing carbon dioxide and methane. The gas pressure at the time of gas separation is preferably in a range of 0.5 MPa to 10 MPa, more preferably in a range of 1 MPa to 10 MPa, and still more preferably in a range of 2 MPa to 7 MPa. Further, the temperature for separating gas is preferably in a range of −30° C. to 90° C. and more preferably in a range of 15° C. to 70° C. In the mixed gas containing carbon dioxide and methane, the mixing ratio of carbon dioxide to methane is not particularly limited. The mixing ratio thereof (carbon dioxide:methane) is preferably in a range of 1:99 to 99:1 (volume ratio) and more preferably in a range of 5:95 to 90:10.

[Gas Separation Module and Gas Separation Device]

A gas separation module can be prepared using the gas separation membrane according to the embodiment of the present invention. Examples of the module include a spiral type module, a hollow fiber type module, a pleated module, a tubular module, and a plate & frame type module.

Moreover, it is possible to obtain a gas separation device having means for performing separation and recovery of gas or performing separation and purification of gas by using the gas separation composite membrane or the gas separation module of the present invention. The gas separation composite membrane of the present invention may be applied to a gas separation and recovery device which is used together with an absorption liquid described in JP2007-297605A according to a membrane/absorption hybrid method.

### EXAMPLES

Hereinafter, the present invention will be described in detail with reference to examples, but the present invention is not limited to these examples. In the following examples, Me in each structural formula indicates methyl.

### Synthesis Example

<Synthesis of Polyimide (P-1)>

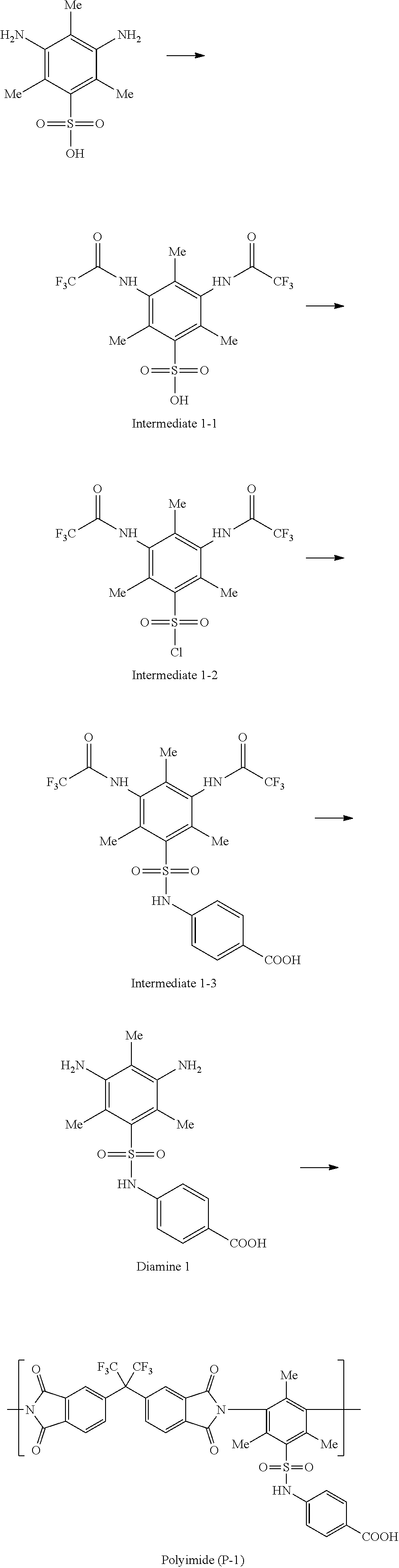

(Synthesis of Intermediate 1-1)

Diaminomesitylenesulfonic acid (manufactured by Wako Pure Chemical Industries, Ltd.) (60 g), acetonitrile (manufactured by Wako Pure Chemical Industries, Ltd.) (380 g), and pyridine (manufactured by Wako Pure Chemical Industries, Ltd.) (23 g) were put into a 1 L flask. Next, a trifluoroacetic anhydride (manufactured by Wako Pure Chemical Industries, Ltd.) (115 g) was carefully added dropwise to the flask under an ice-cooling condition and then the mixture was allowed to react at 70° C. for 2 hours. The reaction solution was cooled, methanol (manufactured by Wako Pure Chemical Industries, Ltd.) (30 g) was added thereto, and then the solution was stirred for 1 hour. The obtained solution was concentrated under reduced pressure and purified using hydrochloric acid, thereby obtaining an intermediate 1-1 (110 g).

(Synthesis of Intermediate 1-2)

Acetonitrile (manufactured by Wako Pure Chemical Industries, Ltd.) (440 mL) and the intermediate 1-1 (68 g) were put into a 1 L flask. Next, thionyl chloride (manufactured by Wako Pure Chemical Industries, Ltd.) (115 g) and dimethylformamide (manufactured by Wako Pure Chemical Industries, Ltd.) (0.9 g) were carefully added to the flask, and the internal temperature was increased to 70° C. while paying attention to heat generation and foaming. The obtained reaction mixture was distilled off under reduced pressure, poured into ice, and purified, thereby obtaining an intermediate 1-2 (65 g).

(Synthesis of Intermediate 1-3)

4-aminobenzoic acid (manufactured by Sigma-Aldrich Co., LLC.) (19 g), pyridine (manufactured by Wako Pure Chemical Industries, Ltd.) (29 mL), and acetonitrile (manufactured by Wako Pure Chemical Industries, Ltd.) (120 mL) were put into a 500 mL flask. Next, the intermediate 1-2 (53 g) was carefully added to the flask under an ice-cooling condition. The solution was stirred at 60° C. for 6 hours, hydrochloric acid (manufactured by Wako Pure Chemical Industries, Ltd.) and ethyl acetate (manufactured by Wako Pure Chemical Industries, Ltd.) were added to the solution after being stirred for liquid separation, and the organic layer was concentrated under reduced pressure and purified, thereby obtaining an intermediate 1-3 (84 g).

(Synthesis of Diamine 1)

The intermediate 1-3 (60 g) and methanol (manufactured by Wako Pure Chemical Industries, Ltd.) (200 g) were put into a 500 mL flask. Next, methanesulfonic acid (manufactured by Wako Pure Chemical Industries, Ltd.) (60 g) was carefully added to the flask, the temperature was increased while paying attention to heat generation, and then the solution was stirred at 120° C. for 30 minutes. The obtained reaction solution was cooled, poured into a potassium carbonate solution, and purified by column chromatography (developing solvent: methanol), thereby obtaining a diamine 1 (25 g).

(Synthesis of Polyimide (P-1))

1-methyl-2-pyrrolidone (manufactured by Wako Pure Chemical Industries, Ltd.) (60 g), the diamine 1 (8.80 g), and 4,4′-(hexafluoroisopropylidene)diphthalic anhydride (6FDA, manufactured by Tokyo Chemical Industry Co., Ltd.) (12.44 g) were put into a 200 mL flask. Next, toluene (manufactured by Wako Pure Chemical Industries, Ltd.) (10 g) was added to the flask, and the solution was heated to 180° C. and allowed to react for 6 hours. The reaction solution was cooled and diluted with acetone (manufactured by Wako Pure Chemical Industries, Ltd.), and isopropyl alcohol (manufactured by Wako Pure Chemical Industries, Ltd.) was added to the reaction solution to obtain a polymer as a solid. An operation of dissolving the obtained polymer in acetone and performing reprecipitation using isopropyl alcohol was repeated two times, and the resultant was dried at 80° C., thereby obtaining a polyimide (P-1) (18 g).

¹H NMR (400 MHz, DMSO-d⁶): δ=12.79 (brs, 1H), 11.17 (brs, 1H), 8.19 (d, 2H), 7.92 (brs, 4H), 7.82 (d, 2H), 7.06 (d, 2H), 2.50 (s, 6H), 1.99 (s, 3H)

<Synthesis of Polyimide (P-2)>

A polyimide (P-2) formed of the following repeating unit was obtained in the same manner as that for the synthesis of the polyimide (P-1) except that 4-trifluoromethylaniline was used in place of the 4-aminobenzoic acid in the synthesis of the polyimide (P-1).

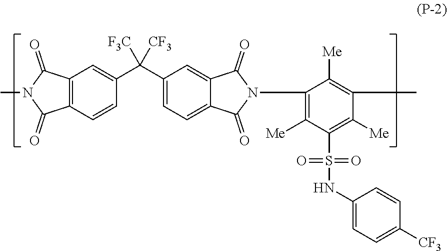

<Synthesis of Polyimide (P-3)>

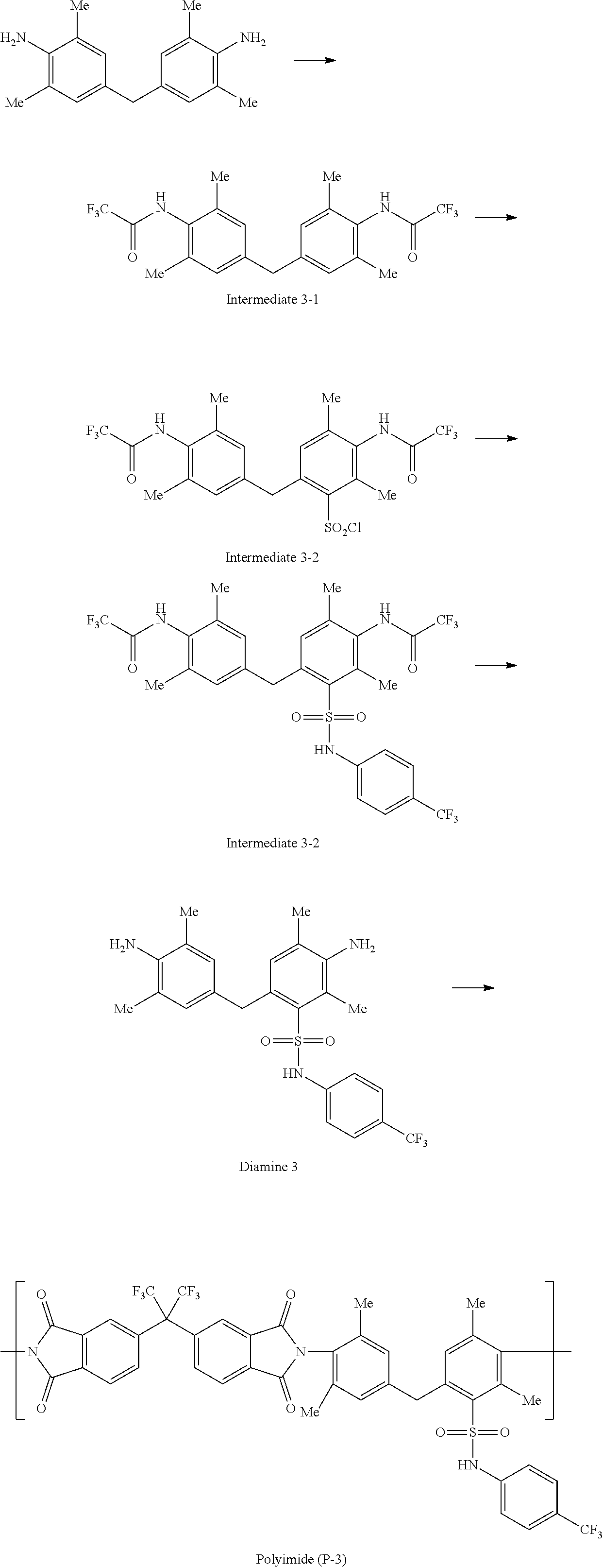

(Synthesis of Intermediate 3-1)

An intermediate 3-1 was obtained in the same manner as that for the synthesis of the intermediate 1-1 except that 4,4′-methylenebis(2-ethyl-6-methylaniline) was used in place of the diaminomesitylenesulfonic acid in the synthesis of the intermediate 1-1.

(Synthesis of Intermediate 3-2)

Chloroform (manufactured by Wako Pure Chemical Industries, Ltd.) (300 mL) and the intermediate 3-1 (67 g) were put into a 1 L flask. Next, chlorosulfonic acid (manufactured by Wako Pure Chemical Industries, Ltd.) (79 g) was carefully added dropwise to the flask under an ice-cooling condition and then the internal temperature thereof was increased to 50° C. while paying attention to heat generation and foaming. The obtained reaction mixture was cooled, poured into ice, suctioned, filtered, and washed with water, thereby obtaining an intermediate 3-2 (59 g).

(Synthesis of Polyimide P-3 from Intermediate 3-2 Via Intermediate 3-3)

A polyimide (P-3) was obtained in the same manner as that for the synthesis of the polyimide (P-1) except that the intermediate 3-2 was used.

<Synthesis of Polyimide (P-4)>

A polyimide (P-4) was obtained in the same manner as that for the synthesis of the polyimide (P-2) except that a pyromellitic anhydride was used in place of the 6FDA in the synthesis of the polyimide (P-2).

Polyimide (P-4)

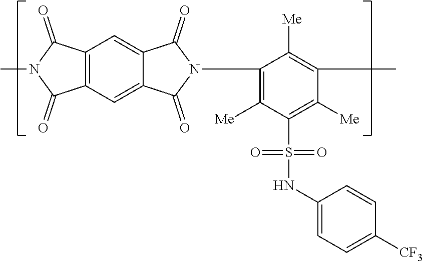

<Synthesis of Polyimide (P-5)>

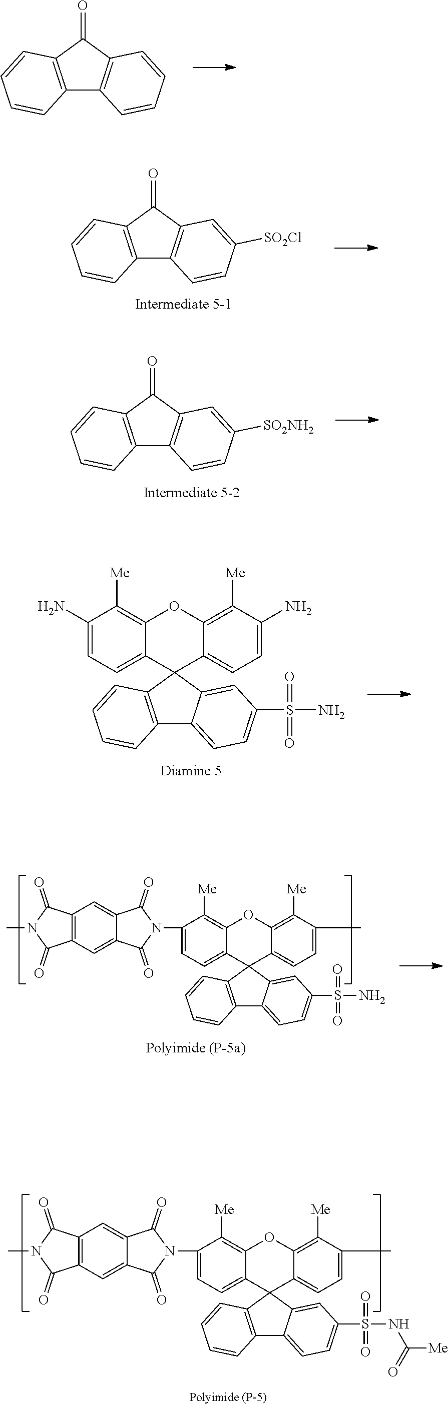

(Synthesis of Intermediate 5-1)

An intermediate 5-1 was obtained in the same manner as that for the synthesis of the intermediate 3-2 except that 9-fluorenone was used in place of the intermediate 3-1 in the synthesis of the intermediate 3-2.

(Synthesis of Intermediate 5-2)

Ammonia water (manufactured by Wako Pure Chemical Industries, Ltd.) (90 g) was put into a 500 mL flask. Next, a liquid obtained by suspending the intermediate 5-1 (27 g) in tetrahydrofuran (manufactured by Wako Pure Chemical Industries, Ltd.) (130 g) was carefully added to the flask under an ice-cooling condition. The obtained mixed solution was stirred at 40° C. for 2 hours, concentrated under reduced pressure, suctioned, filtered, and washed with water, thereby obtaining an intermediate 5-2 (21 g).

(Synthesis of Diamine 5)

The intermediate 5-2 (19.4 g), 3-amino-o-cresol (manufactured by Tokyo Chemical Industry Co., Ltd.) (9.2 g), 3-mercaptopropionic acid (manufactured by Wako Pure Chemical Industries, Ltd.) (318.4 mg), and toluene (75 mL) were put into a 500 mL flask. Next, methanesulfonic acid (manufactured by Wako Pure Chemical Industries, Ltd.) (108.1 g) was carefully added dropwise to the flask at room temperature and the solution was allowed to react at 120° C. for 3 hours. The reaction solution was cooled and then poured into a beaker into which water (375 mL) and NaHCO₃ (95 g) had been poured, and ethyl acetate (600 mL) was added thereto. The organic layer was subjected to liquid separation and concentrated under reduced pressure, and the obtained solid was washed with hexane to obtain a yellow solid (28.2 g). The solid was purified by column chromatography (hexane/ethyl acetate=50/50 (v/v)), thereby obtaining a diamine (16.5 g).

(Synthesis of Polyimide (P-5a))

A polyimide (P-5a) was obtained in the same manner as that for the synthesis of the polyimide (P-1) except that the diamine 5 was used in place of the diamine 1 and a pyromellitic anhydride was used in place of the 6FDA in the synthesis of the polyimide (P-1).

(Synthesis of Polyimide (P-5))

The polyimide (P-5a) (2.0 g), zinc chloride (manufactured by Wako Pure Chemical Industries, Ltd.) (40.9 mg), and acetic anhydride (manufactured by Wako Pure Chemical Industries, Ltd.) (15.0 mL) were put into a 50 mL flask. Next, the solution was heated at 50° C. and allowed to react for 4 hours. The reaction solution was cooled and diluted with acetone (manufactured by Wako Pure Chemical Industries, Ltd.), and isopropyl alcohol (manufactured by Wako Pure Chemical Industries, Ltd.) was added to the reaction solution to obtain a polymer as a solid. An operation of dissolving the obtained polymer in acetone and performing reprecipitation using isopropyl alcohol was repeated two times, and the resultant was dried at 80° C., thereby obtaining a polyimide (P-5) (2.1 g).

¹H NMR (400 MHz, DMSO-d⁶): δ=12.56 (brs, 1H), 8.54 (brs, 2H), 8.24 (d, 1H), 8.15 (m, 1H), 7.62 (s, 1H), 7.52 (brs, 1H), 7.40 (m, 2H), 7.28 (d, 1H), 6.97 (d, 2H), 6.28 (d, 2H), 2.37 (s, 6H), 2.02 (s, 3H)

<Synthesis of Polyimide (P-6)>

A polyimide (P-6) was obtained in the same manner as that for the synthesis of the polyimide (P-5) except that a 4,4′-biphthalic anhydride was used in place of the pyromellitic anhydride in the synthesis of the polyimide (P-5).

Polyimide (P-6)

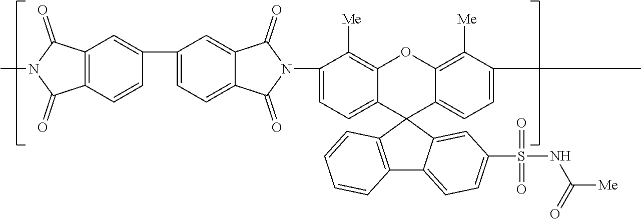

¹H NMR (400 MHz, DMSO-d⁶): δ=12.55 (brs, 1H), 8.49 (s, 1H), 8.41 (brs, 1H), 8.19 (m, 3H), 7.63 (s, 1H), 7.52 (brs, 1H), 7.40 (m, 2H), 7.29 (d, 1H), 6.97 (d, 2H), 6.28 (d, 2H), 2.37 (s, 6H), 2.03 (s, 3H)

<Synthesis of Polyimide (P-7)>

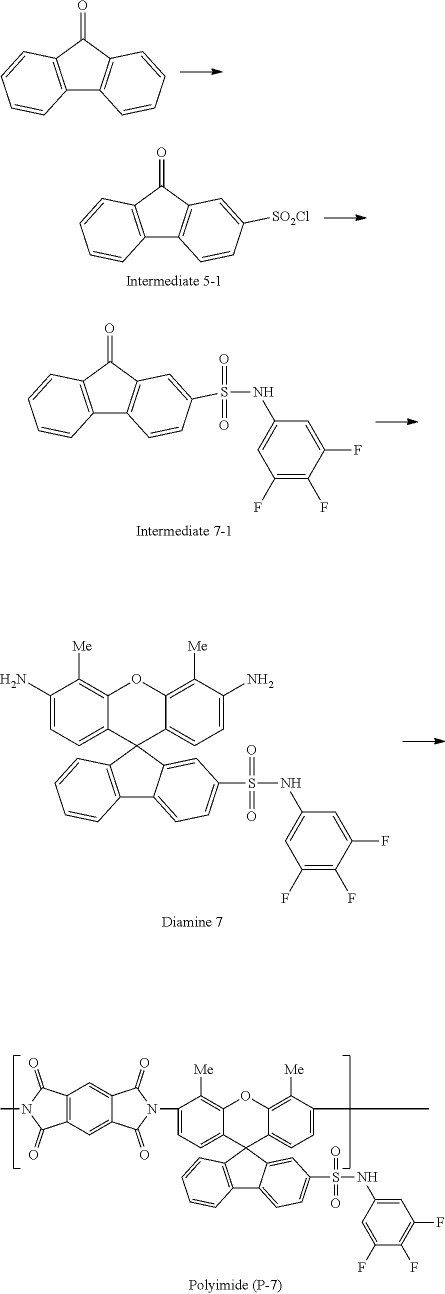

A polyimide (P-7) was obtained in the same manner as that for the synthesis of the polyimide (P-5) after the reaction between the intermediate 5-1 and 3,4,5-trifluoroaniline to obtain an intermediate 7-1 in the same manner as that for the synthesis of the intermediate 1-3.

<Synthesis of Polyimides (P-8), (P-9), and (P-10)>

Polyimides (P-8), (P-9), and (P-10) were obtained in the same manner as that for the synthesis of the polyimide (P-1) except that the raw material which had been used was changed into materials corresponding to the structures of the following polyimides.

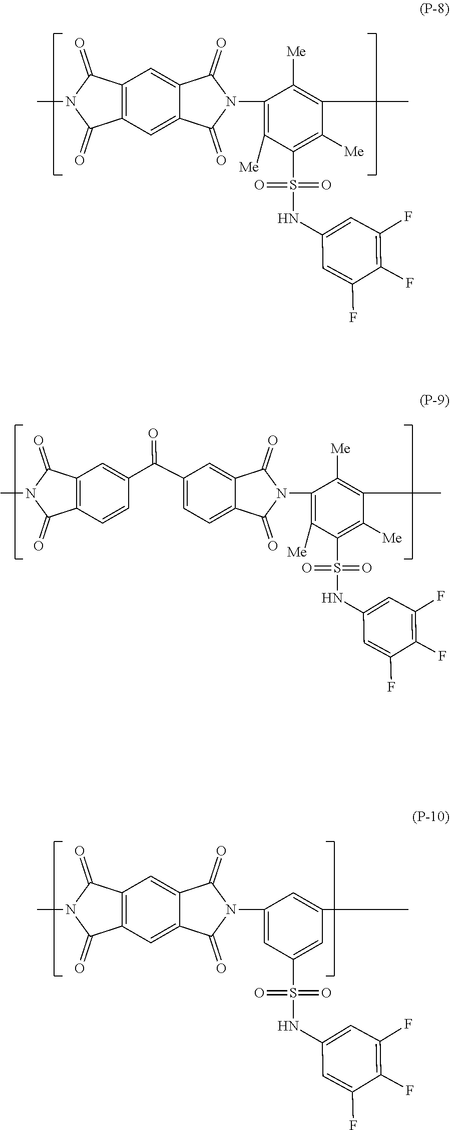

<Synthesis of Polyimide (P-11)>

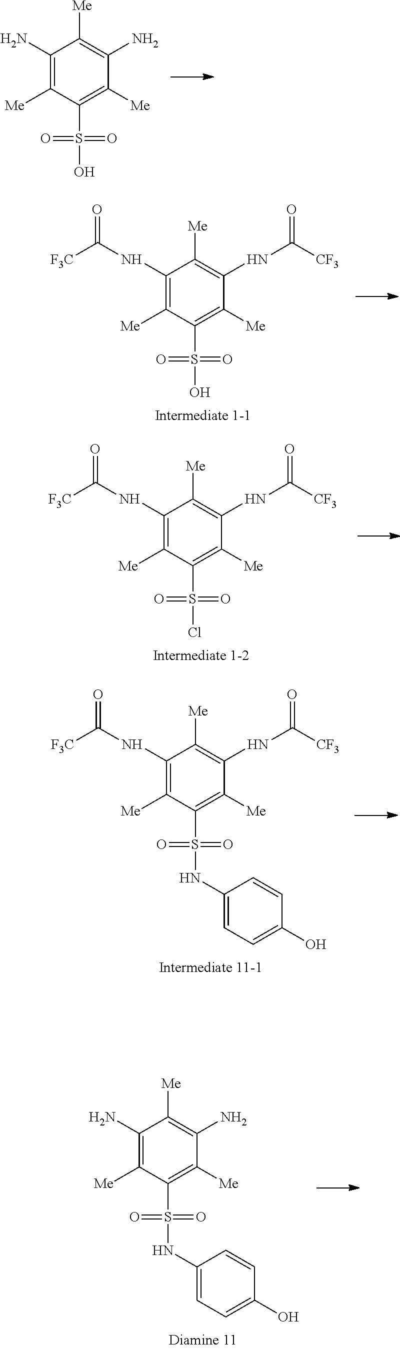

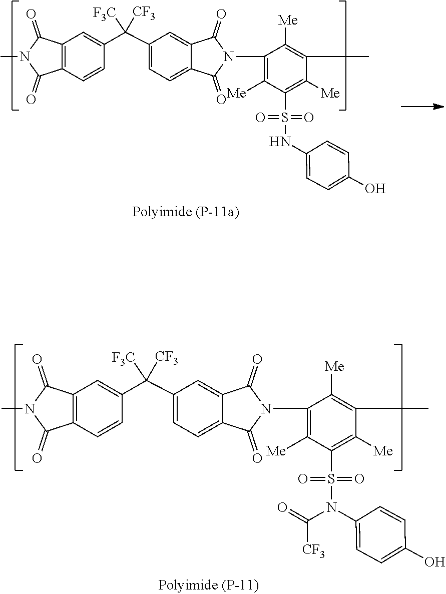

(Synthesis of Polyimide (P-11a))

(Synthesis of Polyimide (P-11))

Tetrahydrofuran (manufactured by Wako Pure Chemical Industries, Ltd.) (144 mL), and the polyimide (P-11a) (13.7 g) were put into a 300 mL flask. Next, a trifluoroacetic anhydride (manufactured by Wako Pure Chemical Industries, Ltd.) (12.7 mL) and triethylamine (manufactured by Wako Pure Chemical Industries, Ltd.) (9.1 g) were added to the flask, and the solution was allowed to react at room temperature for 6 hours. The reaction solution was diluted with acetone (manufactured by Wako Pure Chemical Industries, Ltd.), and methanol (manufactured by Wako Pure Chemical Industries, Ltd.) was added to the reaction solution to obtain a polymer as a solid. An operation of dissolving the obtained polymer in acetone and performing reprecipitation using isopropyl alcohol was repeated two times, and the resultant was dried at 80° C., thereby obtaining a polyimide (P-11) (6.8 g).

¹H NMR (400 MHz, DMSO-d⁶): δ=9.43 (brs, 1H), 8.17 (d, 2H), 7.89 (brs, 4H), 7.14 (d, 2H), 6.80 (d, 2H), 2.50 (s, 6H), 1.99 (s, 3H)

<Synthesis of Polyimide (P-12) (x:y=31:69 (Molar Ratio))>

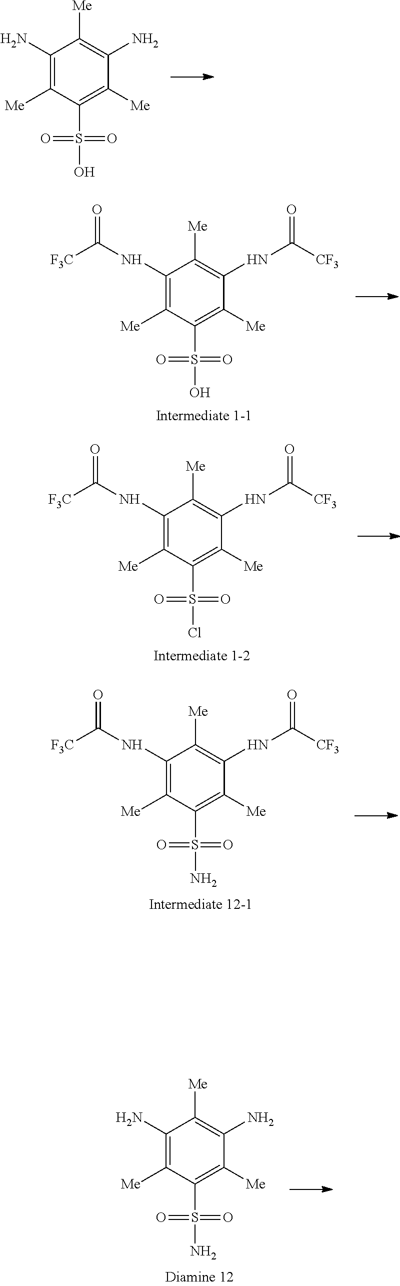

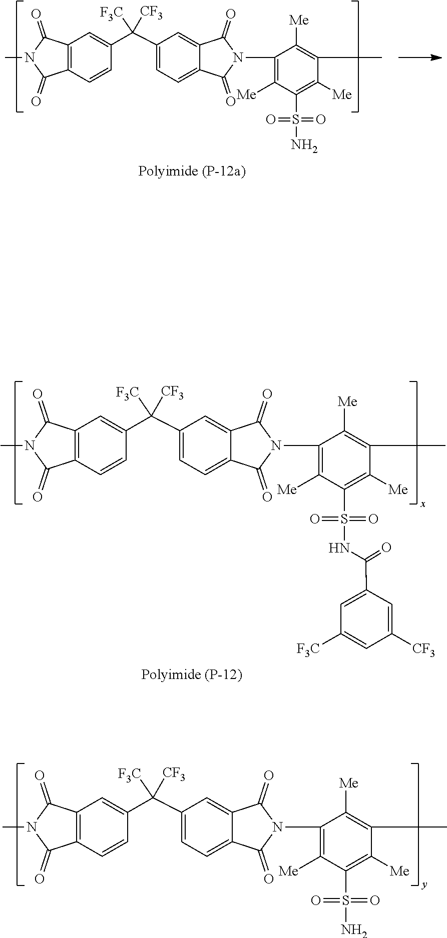

(Synthesis of Polyimide (P-12a))

A polyimide (P-12a) was obtained in the same manner as that for the synthesis of the polyimide (P-1) after the reaction with the intermediate 1-2 using ammonia water to obtain an intermediate 12-1 in the same manner as that for the synthesis of the intermediate 5-2 in the synthesis of the polyimide (P-1).

(Synthesis of Polyimide (P-12) (x:y=31:69 (Molar Ratio)))

1-Methyl-2-pyrrolidone (manufactured by Wako Pure Chemical Industries, Ltd.) (20 mL), and the polyimide (P-12a) (3.2 g) were put into a 100 mL flask. Next, 3,5-bis(trifluoromethyl)benzoyl chloride (manufactured by Tokyo Chemical Industry Co., Ltd.) (1.8 mL) and triethylamine (manufactured by Wako Pure Chemical Industries, Ltd.) (1.0 g) were added to the flask, and the solution was allowed to react at 80° C. for 6 hours. The reaction solution was diluted with acetone (manufactured by Wako Pure Chemical Industries, Ltd.), and methanol (manufactured by Wako Pure Chemical Industries, Ltd.) was added to the reaction solution to obtain a polymer as a solid. An operation of dissolving the obtained polymer in acetone and performing reprecipitation using isopropyl alcohol was repeated two times, and the resultant was dried at 80° C., thereby obtaining a polyimide (P-12) (2.8 g).

¹H NMR (400 MHz, DMSO-d⁶): δ=8.51 (brs, 2H*0.31), 8.19 (brs, 2H+1H*0.31), 7.95 (brs, 4H), 7.75 (brs, 2H*0.69), 2.50 (s, 6H), 1.99 (s, 3H)

<Synthesis of Polyimide (P-13)>

A polyimide (P-13) was obtained in the same manner as that for the synthesis of the polyimide (P-1) except that iminodiacetic acid was used in place of the 4-aminobenzoic acid in the synthesis of the polyimide (P-1).

Polyimide (P-13)

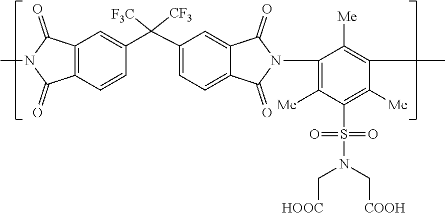

¹H NMR (400 MHz, DMSO-d⁶): δ=8.19 (brs, 2H), 7.95 (brs, 4H), 2.90 (s, 4H), 2.44 (s, 6H), 1.99 (s, 3H)

<Comparative Polyimide (C-1)>

A comparative polyimide (C-1) (13 g) was synthesized in the same manner as that for the synthesis of the polyimide (P-1) except that diaminomesitylenesulfonic acid (manufactured by Wako Pure Chemical Industries, Ltd.) having the same molar amount as that of the diamine 1 was used in place of the diamine 1, triethylamine (4.41 g) was added, and hydrochloric acid was used at the time of the purification of the polymer in the synthesis of the polyimide (P-1).

Comparative Polyimide (C-1)

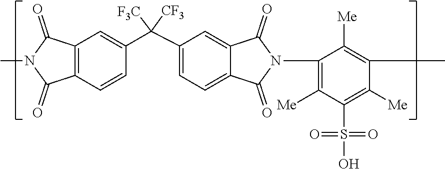

<Comparative Polyimide (C-2)>

2,3,5,6-tetramethyl-1,4-phenylenediamine (2.97 g) and N-methylpyrrolidone (50 mL) were put into a 300 mL flask. Next, 4,4′-carbonyldiphthalic anhydride (manufactured by Tokyo Chemical Industry Co., Ltd.) (5.83 g) was added to the flak under an ice-cooling condition, and the mixture was washed with N-methylpyrrolidone (6 mL). The mixture was stirred at 40° C. for 5 hours, pyridine (manufactured by Wako Pure Chemical Industries, Ltd.) (0.43 g) and acetic anhydride (manufactured by Wako Pure Chemical Industries, Ltd.) (6.10 g) were added to the mixture, and the reaction solution was heated to 80° C. and stirred for 3 hours. The stirred solution was cooled, acetone was added to the solution, methanol was added to the solution, and the comparative polyimide (C-2) was allowed to be deposited as powder. The resultant was repeatedly washed with methanol two times and dried at 40° C., thereby obtaining a comparative polyimide (C-2) (8.09 g).

Comparative Polyimide (C-2)

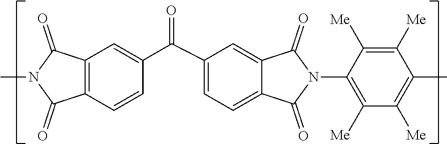

### [Example 1] Preparation of Gas Separation Composite Membrane

<Preparation of Polyacrylonitrile (PAN) Porous Layer Provided with Smooth Layer>

(Preparation of Radiation-Curable Polymer Containing Dialkylsiloxane Group)

39 g of UV9300 (manufactured by Momentive Performance Materials Inc.), 10 g of X-22-162C (manufactured by Shin-Etsu Chemical Co, Ltd.), and 0.007 g of DBU (1,8-diazabicyclo[5.4.0]undeca-7-ene) were added to a 150 mL three-neck flask and dissolved in 50 g of n-heptane. The state of the solution was maintained at 950 for 168 hours, thereby obtaining a radiation-curable polymer solution (viscosity at 25° C. was 22.8 mPa·s) containing a poly(siloxane) group.

(Preparation of Polymerizable Radiation-Curable Composition)

5 g of the obtained radiation-curable polymer solution was cooled to 20° C. and diluted with 95 g of n-heptane. 0.5 g of UV9380C (manufactured by Momentive Performance Materials Inc.) and 0.1 g of ORGATIX TA-10 (manufactured by Matsumoto Fine Chemical Co., Ltd.) serving as photopolymerization initiators were added to the obtained solution, thereby preparing a polymerizable radiation-curable composition.

(Formation of Smooth Layer)

The PAN porous layer (a support having a polyacrylonitrile porous layer on non-woven fabric and having non-woven fabric with a thickness of 180 μm) was spin-coated with the polymerizable radiation-curable composition, subjected to a UV treatment (Light Hammer 10, D-valve, manufactured by Fusion UV System, Inc.) under UV treatment conditions of a UV intensity of 24 kW/m for a treatment time of 10 seconds, and then dried. In this manner, a smooth layer containing a dialkylsiloxane group and having a thickness of 1 μm was formed on the porous support.

<Preparation of Composite Membrane>

A gas separation composite membrane illustrated in FIG. 2 was prepared (a smooth layer is not illustrated in FIG. 2). 0.08 g of the polyimide (P-1) and 7.92 g of tetrahydrofuran were mixed in a 30 ml brown vial bottle and then stirred for 30 minutes, and the porous support on which the smooth layer was formed was spin-coated with the obtained mixed solution to form a gas separation layer, thereby obtaining a composite membrane. The thickness of the polyimide (P-1) layer was approximately 100 nm.

Further, the molecular weight cutoff of the used polyacrylonitrile porous layer was 100000 or less. Further, the carbon dioxide permeability of the porous layer at 40° C. and 5 MPa was 25000 GPU.

A protective layer was provided on the surface of the gas separation layer of the composite membrane prepared above according to the following procedures.

In other words, the surface of the gas separation layer of the composite membrane prepared above was spin-coated with a mixed solution obtained by mixing a vinyl Q resin (manufactured by Gelest Inc., product number: VQM-135) (10 g), hydrosilyl PDMS (manufactured by Gelest Inc., product number: HMS-301) (1 g), a Karstedt catalyst (manufactured by Sigma-Aldrich Co., LLC., product number of 479527) (5 mg), and heptane (90 g). The mixed solution was dried at 80° C. for 5 hours, and then cured. In this manner, a gas separation composite membrane (protective layer) including a siloxane compound layer with a thickness of 500 nm was provided on the gas separation layer.

### [Examples 2 to 13] Preparation of Composite Membranes

Gas separation composite membranes respectively having a protective layer in Examples 2 to 13 were prepared in the same manner as in Example 1 except that the polyimide (P-1) was changed into the polyimides (P-2) to (P-13) in Example 1.

### [Comparative Examples 1 and 2] Preparation of Gas Separation Composite Membranes

Gas separation composite membranes respectively having a protective layer in Comparative Examples 1 and 2 were prepared in the same manner as in Example 1 except that the polyimide (P-1) was changed into the comparative polyimides (C-1) and (C-2) in Example 1. Further, since the comparative polyimide (C-1) was not dissolved in methyl ethyl ketone, methanol was used as a solvent in place of methyl ethyl ketone.

### [Test Example 1] Evaluation of CO₂ Permeation Rate and Gas Separation Selectivity of Gas Separation Membrane—Permeation Test 1

The gas separation performance was evaluated in the following manner using the gas separation membranes (composite membranes) of each of the examples and comparative examples.

Permeation test samples were prepared by cutting the gas separation membranes together with the porous supports (support layers) such that the diameter of each membrane became 5 cm. The gas permeation rates of permeation test samples were measured using a gas permeability measurement device manufactured by GTR Tec Corporation. The measurement was performed under conditions that the total pressure of mixed gas, in which the volume ratio of carbon dioxide (CO₂) to methane (CH₄) was 13:87, on a gas supply side was adjusted to 5 MPa (partial pressure of CO₂: 0.3 MPa), the flow rate thereof was adjusted to 500 mL/min, and the temperature thereof was adjusted to 40° C. The permeating gas was analyzed using gas chromatography. The gas permeabilities of the gas separation membranes were compared to each other by calculating gas permeation rates as gas permeability (Permeance). The unit of gas permeability (gas permeation rate) was expressed by the unit of GPU [1 GPU=1×10^{0.6} cm³ (STP)/cm²·sec·cmHg]. The gas separation selectivity was calculated as the ratio (R_{CO2}/R_{CH4}) of the permeation rate R_{CH4} of CH₄ to the permeation rate R_{CO2} of CO₂ of the membrane.

The measurement results were evaluated based on the following evaluation standards.

—Evaluation Standard of Gas Permeation Rate—

A: 60 GPU or greater

B: 40 GPU or greater and less than 60 GPU

C: 20 GPU or greater and less than 40 GPU

D: 10 GPU or greater and less than 20 GPU

E: less than 10 GPU

—Evaluation Standard of Gas Separation Selectivity—

A: R_{CO2}/R_{CH4} was 30 or greater

B: R_{CO2}/R_{CH4} was 25 or greater and less than 30

C: R_{CO2}/R_{CH4} was 20 or greater and less than 25

D: R_{CO2}/R_{CH4} was 15 or greater and less than 20

E: R_{CO2}/R_{CH4} was less than 15

### [Test Example 2] Plasticization Resistance Test (Toluene Exposure Test)

Each gas separation membrane prepared in each of the examples and comparative examples was put into a stainless steel container in which a Petri dish having a toluene solvent was placed to have a closed system. Thereafter, the closed container was stored under a temperature condition of 25° C. for 10 minutes, the gas separation membranes was cut into a size of 5 cm in the same manner as in [Test Example 1] described above to prepare resistance test samples. The gas separation selectivity y(R_{CO2}/R_{CH4}) was investigated in the same manner as in [Test Example 1] described above using the obtained resistance test samples, and the change in gas separation selectivity before and after exposure to toluene was used as an index of the plasticization resistance. Specifically, the plasticization resistance was evaluated by calculating [gas separation selectivity after exposure to toluene]/[gas separation selectivity before exposure to toluene] and applying the obtained values (selectivity maintenance rates) to the following evaluation standard.

—Evaluation Standard of Plasticization Resistance—

A: The selectivity maintenance rate was 0.5 or greater

B: The selectivity maintenance rate was 0.4 or greater and less than 0.5

C: The selectivity maintenance rate was 0.3 or greater and less than 0.4

D: The selectivity maintenance rate was 0.15 or greater and less than 0.3

E: The selectivity maintenance rate was less than 0.15

The results are listed in Table 1.

TABLE 1

| | | | Gas separation performance | | |
|---|---|---|---|---|---|
| | | | (Test Example 1) | | |
| | Polyimide compound | | Gas | Gas | Plasticization |
| | | Weight-average | permeation | separation | resistance |
| | Type | molecular weight | rate | selectivity | (Test Example 2) |
| Example 1 | P-1 | 116000 | C | A | A |
| Example 2 | P-2 | 145000 | B | B | B |
| Example 3 | P-3 | 124000 | B | C | C |
| Example 4 | P-4 | 110000 | B | B | B |
| Example 5 | P-5 | 332000 | C | B | A |
| Example 6 | P-6 | 298000 | C | B | A |
| Example 7 | P-7 | 102000 | B | C | C |
| Example 8 | P-8 | 133000 | B | B | B |
| Example 9 | P-9 | 167000 | C | A | B |
| Example 10 | P-10 | 149000 | B | B | B |
| Example 11 | p-11 | 260000 | B | A | A |
| Example 12 | P-12 | 224000 | A | B | A |
| Example 13 | P-13 | 134000 | B | A | A |
| Comparative | C-1 | 80000 | — | — | — |
| Example 1 | | | | | |
| Comparative | C-2 | 113000 | E | E | E |
| Example 2 | | | | | |

In the gas separation membrane on which a gas separation layer was formed using the comparative polyimide (C-1), membrane defects significantly occurred on the gas separation layer. Therefore, the gas separation membrane did not function as the gas separation membrane. Further, in the gas separation membrane on which a gas separation layer was formed using the comparative polyimide (C-2), both characteristics of the gas permeability and the gas separation selectivity were degraded, plasticization easily occurred due to toluene exposure, and the durability was poor.

On the contrary, it was found that the gas permeation rate was high and the gas separation selectivity was excellent in the case of the gas separation membrane on which a gas separation layer was formed using the polyimide compound defined in the present invention. Further, it was also found that the gas separation performance was unlikely to be degraded even in a case of being exposed to toluene and the plasticization resistance was also excellent in each of these gas separation membranes (Examples 1 to 13).

From the results described above, it was found that an excellent gas separation method, an excellent gas separation module, and a gas separation device comprising this gas separation module can be provided by applying the gas separation membrane according to the embodiment of the present invention.

### EXPLANATION OF REFERENCES

1: gas separation layer
2: porous layer
3: non-woven fabric layer
10, 20: gas separation composite membrane

What is claimed is:

1. A gas separation membrane comprising:
a gas separation layer which contains a polyimide compound as a constituent material,
wherein the polyimide compound has a repeating unit represented by Formula (I), 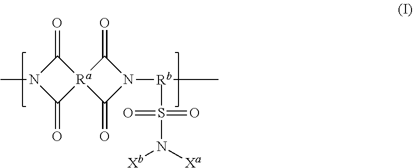
in Formula (I), X^{a} represents a group having an oxygen atom, a nitrogen atom, and/or a sulfur atom or an aryl group including a substituent having a fluorine atom, X^{b} represents a hydrogen atom or a substituent, and in a case where a structure represented by —N(X^{b})— in Formula (I) does not have a structural portion selected from the group consisting of OH, NH, and SH, X^{a} has at least one structural portion selected from the group consisting of OH, NH, and SH, and
R^{a} represents a group represented by any of Formulae (I-1) to (I-28), where X¹ to X³ represent a single bond or a divalent group, L's each independently represent —CH═CH— or —CH₂—, R¹ and R² represent a hydrogen atom or a substituent, and the symbol “*” represents a binding site with respect to a carbonyl group represented in Formula (I), 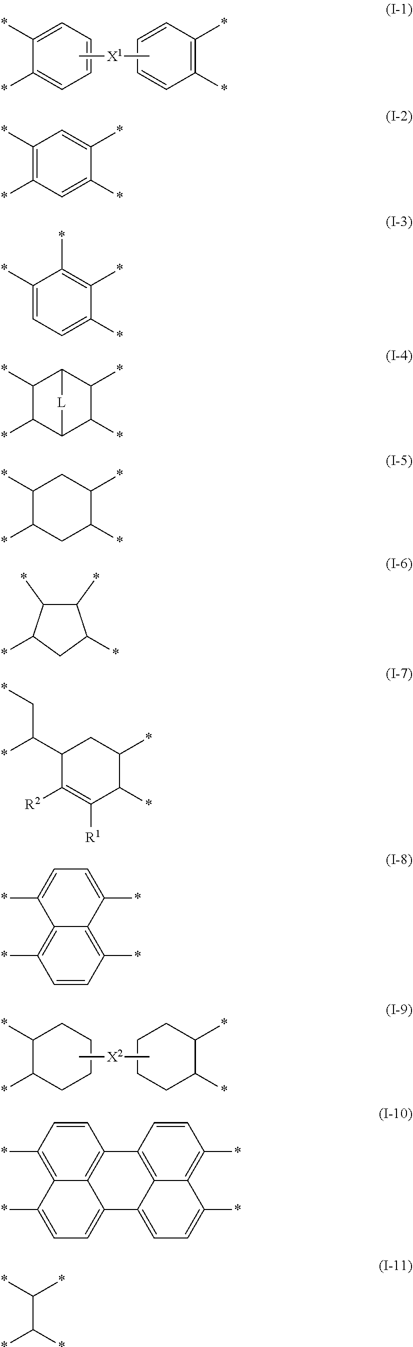 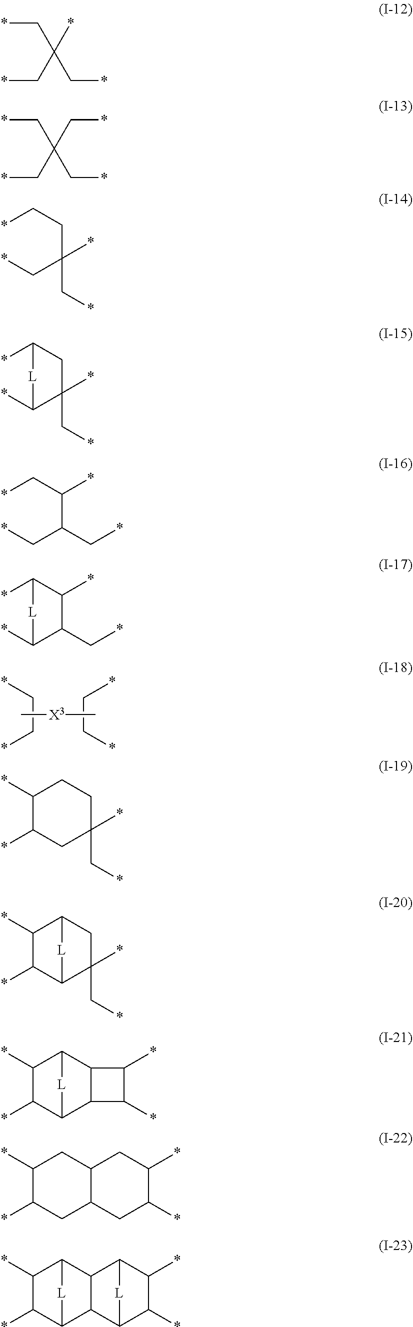 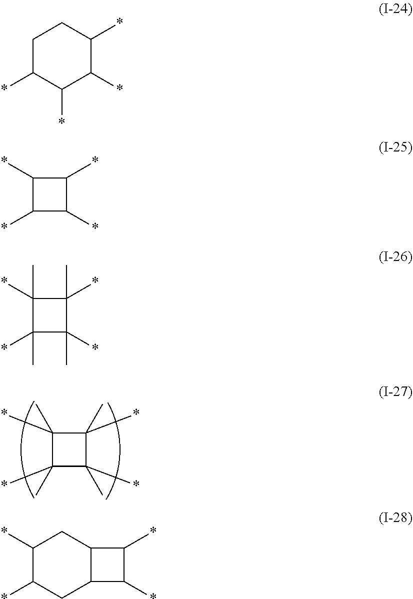
R^{b} represents a group represented by any of Formulae (I-29) to (I-42), where X⁴ to X⁸ represent a single bond or a divalent group, L represents —CH═CH— or —CH₂—, R^{Z}'s each independently represent a substituent, the symbol “*” represents a binding site with respect to an imide group represented in Formula (I), the symbol “#” represents a binding site with respect to a sulfamoyl group represented in Formula (I), d's each independently represent an integer of 0 to 3, e's each independently represent an integer of 0 to 4, f's each independently represent an integer of 0 to 5, g represents an integer of 0 to 6, h's each independently represent an integer of 0 to 7, j's each independently represent an integer of 0 to 9, k represents an integer of 0 to 10, and q's each independently represent 0 or 1.

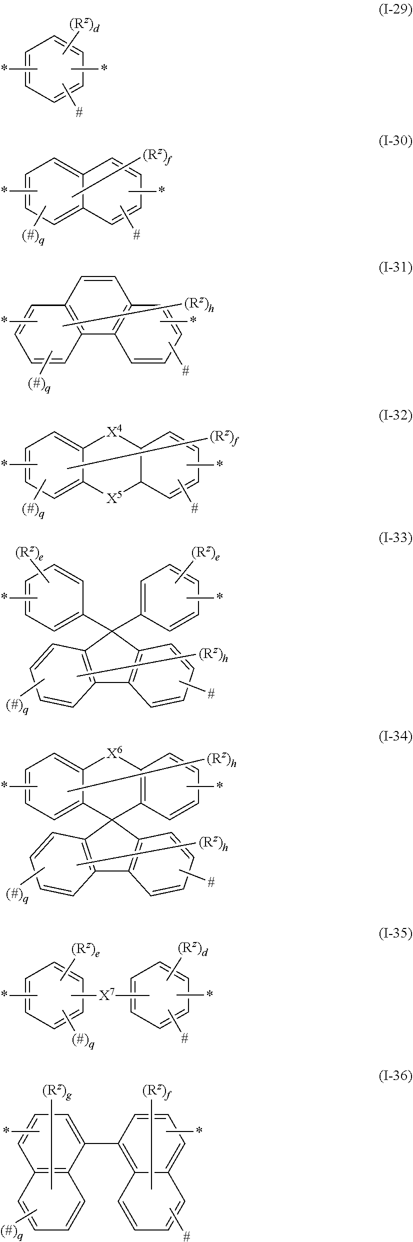

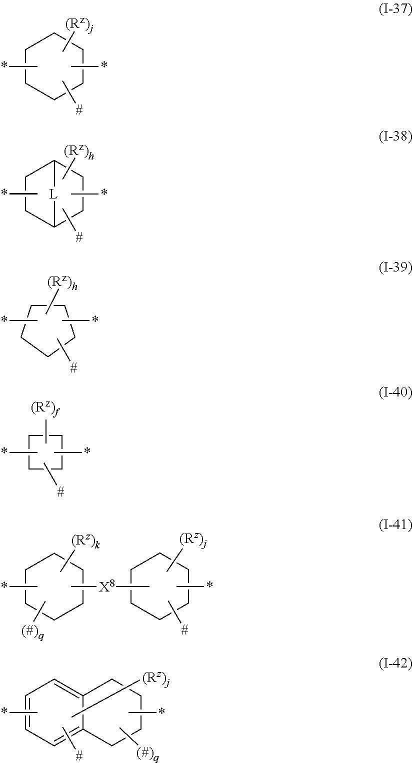

2. The gas separation membrane according to claim 1,
wherein R^{b} represents a group represented by Formula (I-29) or (I-34).

3. The gas separation membrane according to claim 1,
wherein the repeating unit represented by Formula (I) is a repeating unit represented by Formula (I-a), 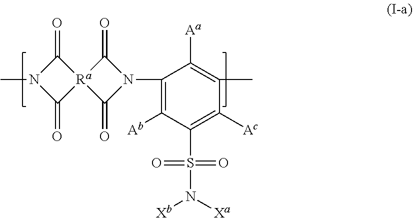
in Formula (I-a), R^{a}, X^{a}, and X^{b} each have the same definition as that for R^{a}, X^{a}, and X^{b} in Formula (I), and A^{a}, A^{b}, and A^{c} represent a hydrogen atom or a substituent.

4. The gas separation membrane according to claim 3,
wherein the repeating unit represented by Formula (I-a) is a repeating unit represented by Formula (I-b), 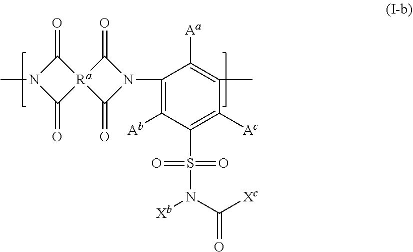
in Formula (I-b), R^{a}, X^{b}, A^{a}, A^{b}, and A^{c} each have the same definition as that for R^{a}, X^{b}, A^{a}, A^{b}, and A^{c} in Formula (I-a), X^{c} represents a substituent, and in a case where a structure represented by —N(X^{b})— in Formula (I-b) does not have a structural portion selected from the group consisting of OH, NH, and SH, X^{c} has at least one structural portion selected from the group consisting of OH, NH, and SH.

5. The gas separation membrane according to claim 4,
wherein X^{c} represents a substituent having at least one fluorine atom.

6. The gas separation membrane according to claim 3,
wherein the repeating unit represented by Formula (I-a) is a repeating unit represented by Formula (I-c), 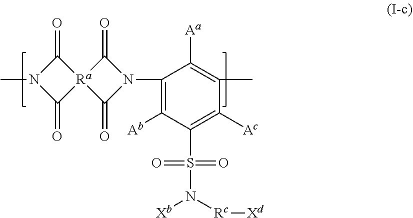
in Formula (I-c), R^{a}, X^{b}, A^{a}, A^{b}, and A^{c} each have the same definition as that for R^{a}, X^{b}, A^{a}, A^{b}, and A^{c} in Formula (I-a), R^{c} represents an alkylene group, a cycloalkylene group, or an arylene group, and X^{d} represents a group having 0 to 2 carbon atoms and having a structural portion selected from the group consisting of OH, NH, and SH.

7. The gas separation membrane according to claim 6,
wherein the repeating unit represented by Formula (I-c) is a repeating unit represented by Formula (I-d), 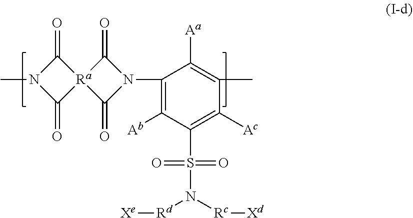
in Formula (I-d), R^{a}, R^{c}, X^{d}, A^{a}, A^{b}, and A^{c} each have the same definition as that for R^{a}, R^{c}, X^{d}, A^{a}, A^{b}, and A^{c} in Formula (I-c), R^{d} represents an alkylene group, a cycloalkylene group, or an arylene group, and X^{e} represents a group having 0 to 2 carbon atoms and having a structural portion selected from the group consisting of OH, NH, and SH.

8. The gas separation membrane according to claim 3,
wherein at least one of A^{a}, A^{b}, or A^{c} represents an alkyl group.

9. The gas separation membrane according to claim 1,
wherein the content of the repeating unit represented by Formula (I) in the polyimide compound is in a range of 30% to 100% by mole.

10. The gas separation membrane according to claim 1, further comprising:
a gas permeating support layer,
wherein the gas separation membrane is a gas separation composite membrane in which the gas separation layer is provided on the gas permeating support layer.

11. The gas separation membrane according to claim 10,
wherein the support layer is formed of a porous layer and a non-woven fabric layer, and
the non-woven fabric layer, the porous layer, and the gas separation layer are provided in this order.

12. The gas separation membrane according to claim 1,
wherein, in a case where gas to be subjected to a separation treatment is mixed gas of carbon dioxide and methane, a permeation rate of carbon dioxide at 40° C. and 5 MPa is 20 GPU or greater and a ratio R_{CO2}/R_{CH4} of a permeation rate of carbon dioxide with respect to a permeation rate of methane is 15 or greater.

13. The gas separation membrane according to claim 1, which is used for selective permeation of carbon dioxide from gas containing the carbon dioxide and methane.

14. A gas separation module comprising:
the gas separation membrane according to claim 1.

15. A gas separation device comprising:
the gas separation module according to claim 14.

16. A gas separation method comprising:
causing carbon dioxide to selectively permeate from gas containing the carbon dioxide and methane using the gas separation membrane according to claim 1.

17. A polyimide compound having a repeating unit represented by Formula (I-b), 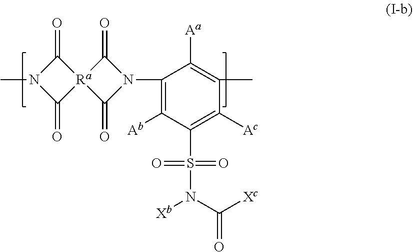
in Formula (I-b), R^{a} represents a group represented by any of Formulae (I-1) to (I-28), where X¹ to X³ represent a single bond or a divalent group, L's each independently represent —CH═CH— or —CH₂—, R¹ and R² represent a hydrogen atom or a substituent, and the symbol “*” represents a binding site with respect to a carbonyl group represented in Formula (I-b), 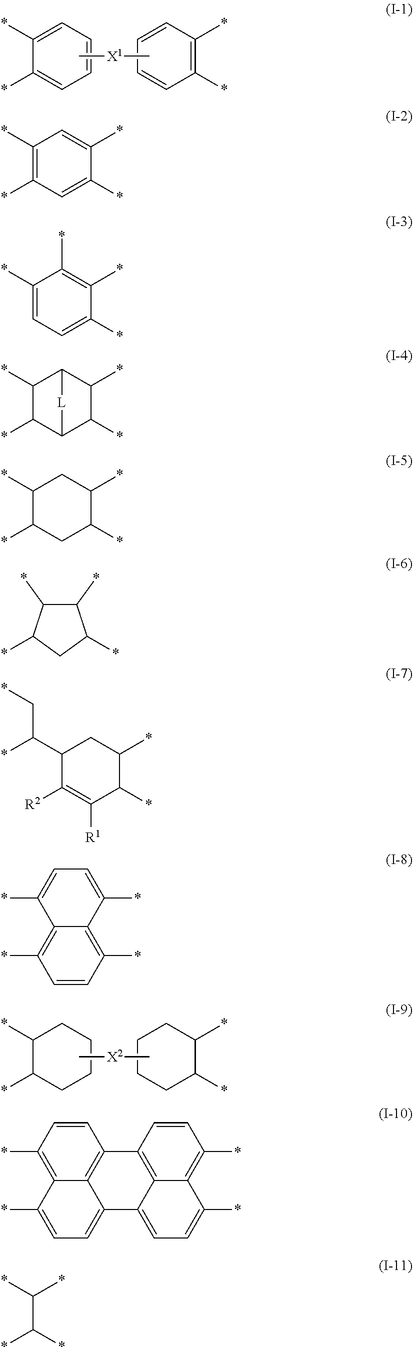 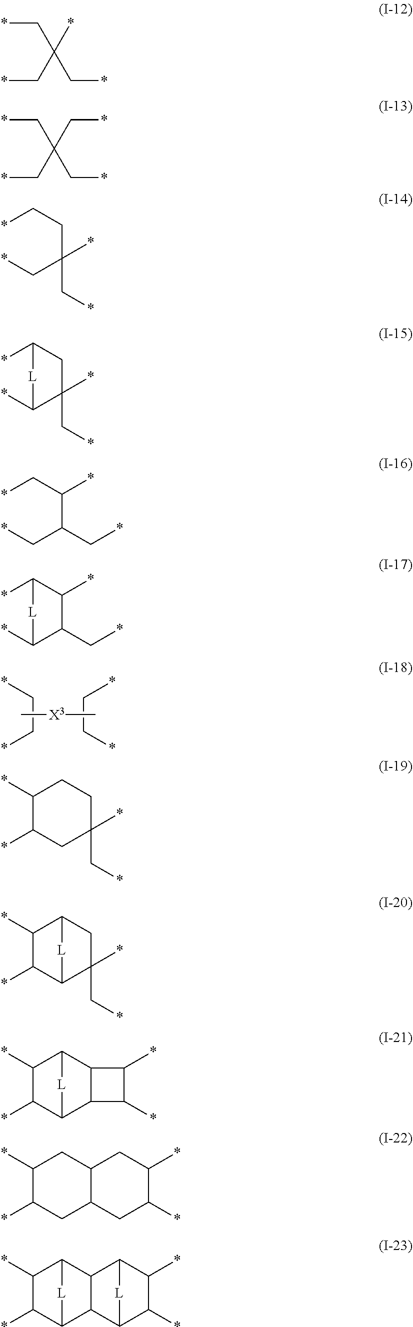 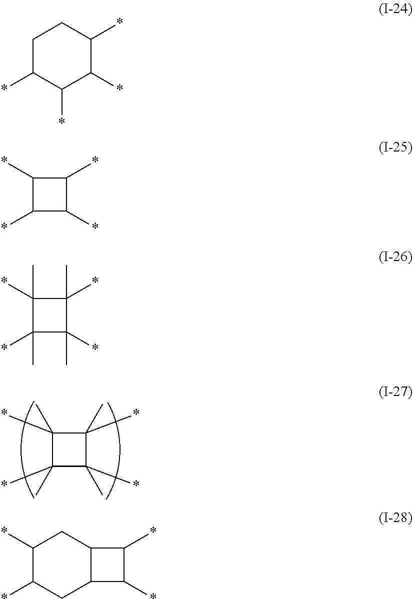
A^{a}, A^{b}, and A^{c} represent a hydrogen atom or a substituent, X^{b} represents a hydrogen atom or a substituent, X^{c} represents a substituent, and in a case where a structure represented by —N(X^{b})— in Formula (I-b) does not have a structural portion selected from the group consisting of OH, NH, and SH, X^{c} has at least one structural portion selected from the group consisting of OH, NH, and SH.

18. A polyimide compound having a repeating unit represented by Formula (I-c), 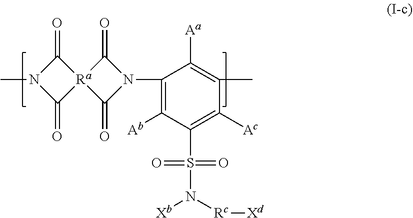
in Formula (I-c), R^{a} represents a group represented by any of Formulae (I-1) to (I-28), where X¹ to X³ represent a single bond or a divalent group, L's each independently represent —CH═CH— or —CH₂—, R¹ and R² represent a hydrogen atom or a substituent, and the symbol “*” represents a binding site with respect to a carbonyl group represented in Formula (I-c), 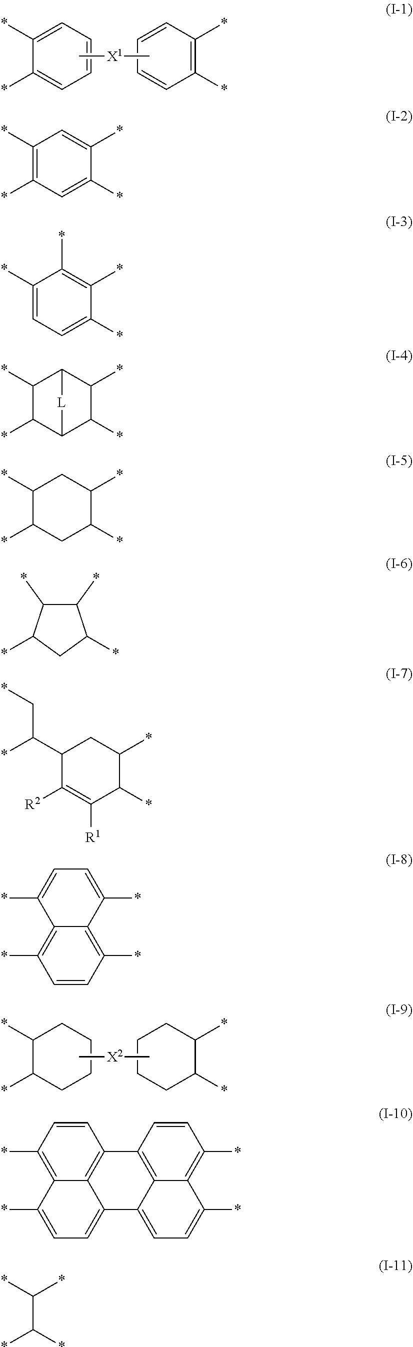 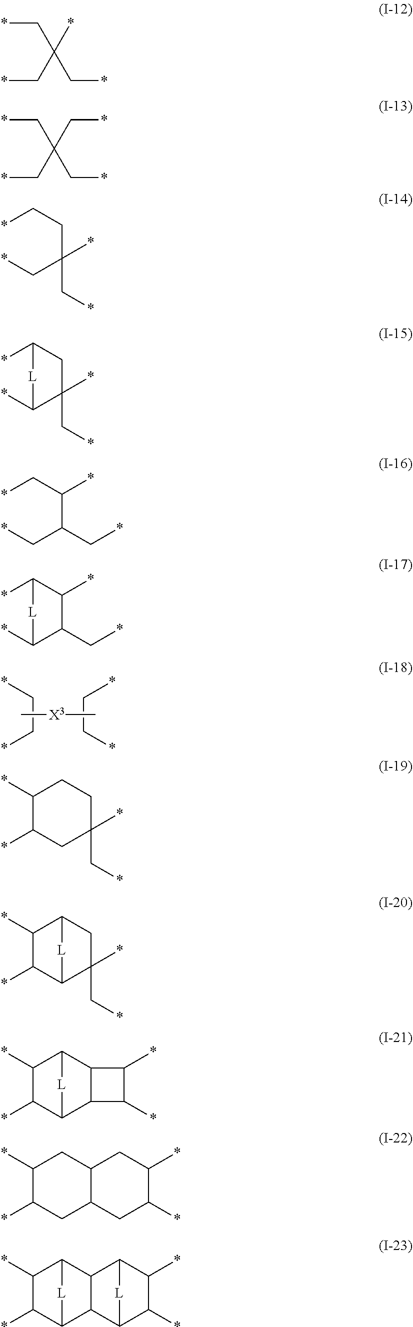 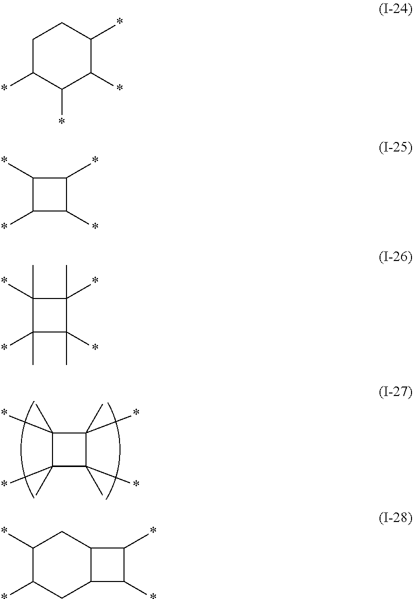
A^{a}, A^{b}, and A^{c} represent a hydrogen atom or a substituent, X^{b} represents a hydrogen atom or a substituent, R^{c} represents an alkylene group, a cycloalkylene group, or an arylene group, and X^{d} represents a group having 0 to 2 carbon atoms and having a structural portion elected from the group consisting of OH, NH, and SH.
